(19) United States
(12) Patent Application Publication
(10) Pub. No.: US 2025/0258081 A1
(43) Pub. Date: Aug. 14, 2025

(54) APPARATUS WITH DYNAMIC LIGHT SCATTERING ASSEMBLY

(71) Applicant: Nutcracker Therapeutics, Inc., Emeryville, CA (US)

(72) Inventors: Benjamin Eldridge, Danville, CA (US); Ximiao Wen, Hayward, CA (US); Eric Chu, San Francisco, CA (US); Tamas Czimmerman, Hayward, CA (US); Kenneth Jordan, Danville, CA (US); Jodi Loo, Agoura Hills, CA (US); Babak Sanii, San Francisco, CA (US)

(21) Appl. No.: 19/177,288

(22) Filed: Apr. 11, 2025

Related U.S. Application Data
(63) Continuation of application No. PCT/US2023/034875, filed on Oct. 11, 2023.
Application No. PCT/US2023/034875 is a continuation of application No. 17/964,185, filed on Oct. 12, 2022.

(51) Int. Cl. G01N 15/0205; G01N 11/00

(52) U.S. Cl. CPC G01N 15/0211; G01N 2011/0046; G01N 2011/008; G01N 2015/0222

(57) ABSTRACT

An apparatus includes a process chip and a dynamic light scattering assembly. The process chip includes a fluid chamber including and an optically transmissive material adjacent to the fluid chamber. The process chip is to be removably positioned in relation to the dynamic light scattering assembly. The dynamic light scattering assembly is to direct the light through the optically transmissive material and into the fluid chamber. The dynamic light scattering assembly is further to receive light scattered by particles in fluid in the fluid chamber in response to the first optical fiber emitting light into the fluid chamber and thereby capture light scattering data. A processor determines viscosity of fluid in the fluid chamber based on the captured light scattering data. The processor also determines one or both of size or size distribution of particles in the fluid based the captured light scattering data.

### PRIORITY

This application claims priority to U.S. patent application Ser. No. 17/964,185, entitled “Apparatus with Dynamic Light Scattering Assembly,” filed Oct. 12, 2022, published as U.S. Pub. No. 2023/0035784 on Feb. 2, 2023, the disclosure of which is incorporated by reference herein, in its entirety.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

Some currently available technologies for manufacturing and formulating polynucleotide therapeutics (e.g., mRNA therapeutics, etc.) may expose the products to contamination and degradation. Some available centralized production may be too costly, too slow, or susceptible to contamination for use in therapeutic formulations possibly including multiple polynucleotide species.

### SUMMARY

Development of scalable polynucleotide manufacturing, production of single patient dosages, elimination of touchpoints to limit contamination, input and process tracking for meeting clinical manufacturing requirements, and use in point-of-care operations may advance the use of these therapeutic modalities. Microfluidic instrumentation and processes may provide advantages in achieving these goals. It may be desirable to measure particle sizes and/or size distributions within a microfluidic system. Described herein are devices, systems, and methods for measuring particle sizes and/or size distributions within a microfluidic system, to overcome the pre-existing challenges and achieve the benefits as described herein. Such microfluidic systems may be used for the manufacture and formulation of biomolecule-containing products, such as therapeutics for individualized care.

It should be appreciated that all combinations of the foregoing concepts and additional concepts discussed in greater detail below (provided such concepts are not mutually inconsistent) are contemplated as being part of the inventive subject matter disclosed herein and to achieve the benefits/advantages as described herein. In particular, all combinations of claimed subject matter appearing at the end of this disclosure are contemplated as being part of the inventive subject matter disclosed herein.

### BRIEF DESCRIPTION OF THE DRAWINGS

The details of one or more implementations are set forth in the accompanying drawings and the description below. Other features, aspects, and advantages will become apparent from the description, the drawings, and the claims, in which:

FIG. 1 depicts a schematic view of an example of a system including a microfluidic process chip;

FIG. 2 depicts an exploded perspective view of examples of components of the system of FIG. 1;

FIG. 3 depicts a top plan view of an example of a process chip that may be incorporated into the system of FIG. 1;

FIG. 4A depicts a cross-sectional side view of the process chip of FIG. 3 in a first state of operation;

FIG. 4B depicts a cross-sectional side view of the process chip of FIG. 3 in a second state of operation;

FIG. 4C depicts a cross-sectional side view of the process chip of FIG. 3 in a third state of operation;

FIG. 4D depicts a cross-sectional side view of the process chip of FIG. 3 in a fourth state of operation;

FIG. 4E depicts a cross-sectional side view of the process chip of FIG. 3 in a fifth state of operation;

FIG. 4F depicts a cross-sectional side view of the process chip of FIG. 3 in a sixth state of operation;

FIG. 5 depicts a perspective view of an example of a mixing stage that may be incorporated into the process chip of FIG. 3;

FIG. 6 depicts a top plan view of a portion of an example of a process chip incorporating mixing stages;

FIG. 7A depicts a schematic cross-sectional view of an example of a pressure sensing stage that may be incorporated into the process chip of FIG. 3, with an elastic layer in a non-deflected state;

FIG. 7B depicts a schematic cross-sectional view of the pressure sensing stage of FIG. 7A, with the elastic layer in a deflected state;

FIG. 8 depicts a top plan view of a portion of the pressure sensing stage of FIG. 7A;

FIG. 9 depicts a perspective view of an example assembly including a process chip and a body for a dynamic light scattering stage;

FIG. 10 depicts a top plan view of the assembly of FIG. 9;

FIG. 11 depicts a side elevational view of the assembly of FIG. 9;

FIG. 12 depicts an enlarged top plan view of mixing assemblies in the process chip of FIG. 9;

FIG. 13 depicts an enlarged plan view of a dynamic light scattering chamber in the process chip of FIG. 9;

FIG. 14 depicts a perspective view of the dynamic light scattering chamber of FIG. 13;

FIG. 15 depicts another perspective view of the dynamic light scattering chamber of FIG. 13;

FIG. 16 depicts a perspective view of the body of the dynamic light scattering stage of the assembly of FIG. 9, with schematic representations of associated optical components;

FIG. 17 depicts a perspective view of the body of the dynamic light scattering stage of the assembly of FIG. 9, with a collimator and an optical filter separated from the body;

FIG. 18 depicts a top plan view of the body of the dynamic light scattering stage of the assembly of FIG. 9;

FIG. 19 depicts a bottom plan view of the body of the dynamic light scattering stage of the assembly of FIG. 9;

FIG. 20 depicts a cross-sectional view of the body of the dynamic light scattering stage of the assembly of FIG. 9, taken along line 20-20 of FIG. 18;

FIG. 21 depicts a graph plotting an example of an autocorrelation function associated with use of a multimode optical fiber in the dynamic light scattering stage of the assembly of FIG. 9;

FIG. 22 depicts a graph plotting an example of an autocorrelation function associated with use of a single mode optical fiber in the dynamic light scattering stage of the assembly of FIG. 9;

FIG. 23 depicts a perspective view of an assembly including a process chip and several bodies for several corresponding dynamic light scattering stages;

FIG. 24 depicts a top plan view of the assembly of FIG. 23;

FIG. 25 depicts a perspective view of a measurement stage that may be incorporated into a process chip;

FIG. 26 depicts a flow chart representing an example of a process for measuring viscosity in a process chip using the measurement stage of FIG. 25;

FIG. 27 depicts a graph plotting examples of autocorrelation functions associated with execution of the process of FIG. 26 through the measurement stage of FIG. 25;

FIG. 28 depicts a flow chart representing another example of a process for measuring viscosity in a process chip using the measurement stage of FIG. 25;

FIG. 29 depicts a graph plotting an example of gamma values that may be yielded during execution of the process of FIG. 26 through the measurement stage of FIG. 25;

FIG. 30 depicts a top plan view of another example of a process chip;

FIG. 31 depicts another top plan view of the process chip of FIG. 30, with certain features omitted for clarity;

FIG. 32 depicts an enlarged top plan view of a mixing assembly of the process chip of FIG. 30; and

FIG. 33 depicts an enlarged top plan view of a measurement stage of the process chip of FIG. 30.

### DETAILED DESCRIPTION

In some aspects, apparatuses and methods are disclosed herein for processing therapeutic polynucleotides. In particular, these apparatuses and methods may be closed path apparatuses and methods that are configured to minimize or eliminate manual handling during operation. The closed path apparatuses and methods may provide a nearly entirely aseptic environment, and the components may provide a sterile path for processing from initial input (e.g., template) to output (e.g., compounded therapeutic). Material inputs (e.g., nucleotides, and any chemical components) into the apparatus may be sterile; and may be input into the system without requiring virtually any manual interaction.

The apparatuses and methods described herein may generate therapeutics at very rapid cycle times at very high degree of reproducibility. The apparatuses described herein are configured to provide, in a single integrated apparatus, synthesis, purification, dialysis, compounding, and concentration of one or more therapeutic compositions. Alternatively, one or more of these processes may be carried out in two or more apparatuses as described herein. In some scenarios, the therapeutic compositions include therapeutic polynucleotides. Such therapeutic polynucleotides may include, for example, ribonucleic acids or deoxyribonucleic acids. The polynucleotides may include only natural nucleotide units or may include any kind of synthetic or semi-synthetic nucleotide units. All or some of the processing steps may be performed in an unbroken fluid processing pathway, which may be configured as one or a series of consumable microfluidic path device(s)—in some instances herein also referred to as process chip or biochip (through the chip need not necessarily be used in bio-related applications). This may allow for patient-specific therapeutics to be synthesized, including compounding, at a point of care (e.g., hospital, clinic, pharmacy, etc.).

### I. OVERVIEW OF SYSTEM INCLUDING MICROFLUIDIC PROCESS CHIP

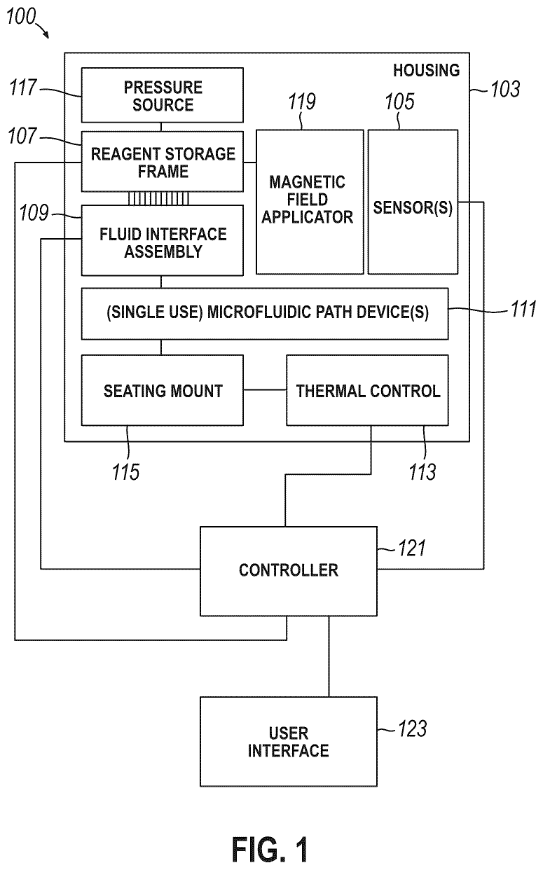

FIG. 1 depicts examples of various components that may be incorporated into a system (100). System (100) of this example includes a housing (103) enclosing a seating mount (115) that may removably hold one or more microfluidic process chips (111). In other words, system (100) includes a component that is configured to removably accommodate a process chip (111), where the process chip (111) itself defines one or more microfluidic channels or fluid pathways. Components of system (100) (e.g., within housing (103)) that fluidically interact with process chip (111) may include fluid channels or pathways that are not necessarily considered microfluidic (e.g., with such fluid channels or pathways being larger than the microfluidic channels or fluid pathways in process chip (111)). In some versions, process chips (111) are provided and utilized as single-use devices, while the rest of system (100) is reusable. Housing (103) may be in the form of a chamber, enclosure, etc., with an opening that may be closed (e.g., via a lid or door, etc.) to thereby seal the interior. Housing (103) may enclose a thermal regulator and/or may be configured to be enclosed in a thermally-regulated environment (e.g., a refrigeration unit, etc.). Housing (103) may form an aseptic barrier. In some variations, housing (103) may form a humidified or humidity-controlled environment. In addition, or in the alternative, system (100) may be positioned in a cabinet (not shown). Such a cabinet may provide a temperature-regulated (e.g., refrigerated) environment. Such a cabinet may also provide air filtering and air flow management and may promote reagents being kept at a desired temperature through the manufacturing process. In addition, such a cabinet may be equipped with UV lamps for sterilization of process chip (111) and other components of system (100). Various suitable features that may be incorporated into a cabinet that houses system (100) will be apparent to those skilled in the art in view of the teachings herein.

Seating mount (115) may be configured to secure process chip (111) using one or more pins or other components configured to hold process chip (111) in a fixed and predefined orientation. Seating mount (115) may thus facilitate process chip (111) being held at an appropriate position and orientation in relation to other components of system (100). In the present example, seating mount (115) is configured to hold process chip (111) in a horizontal orientation, such that process chip (111) is parallel with the ground.

In some variations, a thermal control (113) may be located adjacent to seating mount (115), to modulate the temperature of any process chip (111) mounted in seating mount (115). Thermal control (113) may include a thermoelectric component (e.g., Peltier device, etc.) and/or one or more heat sinks for controlling the temperature of all or a portion of any process chip (111) mounted in seating mount (115). In some variations, more than one thermal control (113) may be included, such as to separately regulate the temperature of different ones of one or more regions of process chip (111). Thermal control (113) may include one or more thermal sensors (e.g., thermocouples, etc.) that may be used for feedback control of process chip (111) and/or thermal control (113).

As shown in FIG. 1, a fluid interface assembly (109) couples process chip (111) with a pressure source (117), thereby providing one or more paths for fluid (e.g., gas) at a positive or negative pressure to be communicated from pressure source (117) to one or more interior regions of process chip (111) as will be described in greater detail below. While only one pressure source (117) is shown, system (100) may include two or more pressure sources (117). In some scenarios, pressure may be generated by one or more sources other than pressure source (117). For instance, one or more vials or other fluid sources within reagent storage frame (107) may be pressurized. In addition, or in the alternative, reactions and/or other processes carried out on process chip (111) may generate additional fluid pressure. In the present example, fluid interface assembly (109) also couples process chip (111) with a reagent storage frame (107), thereby providing one or more paths for liquid reagents, etc., to be communicated from reagent storage frame (107) to one or more interior regions of process chip (111) as will be described in greater detail below.

In some versions, pressurized fluid (e.g., gas) from at least one pressure source (117) reaches fluid interface assembly (109) via reagent storage frame (107), such that reagent storage frame (107) includes one or more components interposed in the fluid path between pressure source (117) and fluid interface assembly (109). In some versions, one or more pressure sources (117) are directly coupled with fluid interface assembly, such that the positively pressurized fluid (e.g., positively pressurized gas) or negatively pressurized fluid (e.g., suction or other negatively pressurized gas) bypasses reagent storage frame (107) to reach fluid interface assembly (109). Regardless of whether the fluid interface assembly (109) is interposed in the fluid path between pressure source (117) and fluid interface assembly (109), fluid interface assembly (109) may be removably coupled to the rest of system (100), such that at least a portion of fluid interface assembly (109) may be removed for sterilization between uses. As described in greater detail below, pressure source (117) may selectively pressurize one or more chamber regions on process chip (111). In addition, or in the alternative, pressure source may also selectively pressurize one or more vials or other fluid storage containers held by reagent storage frame (107).

Reagent storage frame (107) is configured to contain a plurality of fluid sample holders, each of which may hold a fluid vial or cassette that is configured to hold a reagent (e.g., nucleotides, solvent, water, etc.) for delivery to process chip (111). In some versions, one or more fluid vials, cassettes, or other storage containers in reagent storage frame (107) may be configured to receive a product from the interior of the process chip (111). In addition, or in the alternative, a second process chip (111) may receive a product from the interior of a first process chip (111), such that one or more fluids are transferred from one process chip (111) to another process chip (111). In some such scenarios, the first process chip (111) may perform a first dedicated function (e.g., synthesis, etc.) while the second process chip (111) performs a second dedicated function (e.g., encapsulation, etc.). Reagent storage frame (107) of the present example includes a plurality of pressure lines and/or a manifold configured to divide one or more pressure sources (117) into a plurality of pressure lines that may be applied to process chip (111). Such pressure lines may be independently or collectively (in sub-combinations) controlled.

Fluid interface assembly (109) may include a plurality of fluid lines and/or pressure lines where each such line includes a biased (e.g., spring-loaded) holder or tip that individually and independently drives each fluid and/or pressure line to process chip (111) when process chip (111) is held in seating mount (115). Any associated tubing (e.g., the fluid lines and/or the pressure lines) may be part of fluid interface assembly (109) and/or may connect to fluid interface assembly (109). In some versions, each fluid line comprises a flexible tubing that connects between reagent storage frame (107), via a connector that couples the vial to the tubing in a locking engagement (e.g., ferrule) and process chip (111). In some versions, the ends of the fluid lines/pressure lines, may be configured to seal against process chip (111), e.g., at a corresponding sealing port formed in process chip (111), as described below. In the present example, the connections between pressure source (117) and process chip (111), and the connections between vials in reagent storage frame (107) and process chip (111), all form sealed and closed paths that are isolated when process chip (111) is seated in seating mount (115). Such sealed, closed paths may provide protection against contamination when processing therapeutic polynucleotides.

The vials of reagent storage frame (107) may be pressurized (e.g., >1 atm pressure, such as 2 atm, 3 atm, 5 atm, or higher). In some versions, the vials are pressurized by pressure source (117). Negative or positive pressure may thus be applied. For example, the fluid vials may be pressurized to between about 1 and about 20 psig (e.g., 5 psig, 10 psig, etc.). Alternatively, a vacuum (e.g., about −7 psig or about 7 psia) may be applied to draw fluids back into the vials (e.g., vials serving as storage depots) at the end of the process. The fluid vials may be driven at lower pressure than the pneumatic valves as described below, which may prevent or reduce leakage. In some variations, the difference in pressure between the fluid and pneumatic valves may be between about 1 psi and about 25 psi (e.g., about 3 psi, about 5 psi, 7 psi, 10 psi, 12 psi, 15 psi, 20 psi, etc.).

System (100) of the present example further includes a magnetic field applicator (119), which is configured to create a magnetic field at a region of the process chip (111). Magnetic field applicator (119) may include a movable head that is operable to move the magnetic field to thereby selectively isolate products that are adhered to magnetic capture beads within vials or other storage containers in reagent storage frame (107).

System (100) of the present example further includes one or more sensors (105). In some versions, such sensors (105) include one or more cameras and/or other kinds of optical sensors. Such sensors (105) may sense one or more of a barcode, a fluid level within a fluid vial held within reagent storage frame (107), fluidic movement within a process chip (111) that is mounted within seating mount (115), and/or other optically detectable conditions. In versions where a sensor (105) is used to sense barcodes, such barcodes may be included on vials of reagent storage frame (107), such that sensor (105) may be used to identify vials in reagent storage frame (107). In some versions, a single sensor (105) is positioned and configured to simultaneously view such barcodes on vials in reagent storage frame (107), fluid levels in vials in reagent storage frame (107), fluidic movement within a process chip (111) that is mounted within seating mount (115), and/or other optically detectable conditions. In some other versions, more than one sensor (105) is used to view such conditions. In some such versions, different sensors (105) are positioned and configured to separately view corresponding optically detectable conditions, such that a sensor (105) may be dedicated to a particular corresponding optically detectable condition.

In versions where sensors (105) include at least one optical sensor, visual/optical markers may be used to estimate yield. For example, fluorescence may be used to detect process yield or residual material by tagging with fluorophores. In addition, or in the alternative, dynamic light scattering (DLS) may be used to measure particle size distributions within a portion of the process chip (111) (e.g., such as a mixing portion of process chip (111)). In some variations, sensor (105) may provide measurements using one or two optical fibers to convey light (e.g., laser light) into process chip (111); and detect an optical signal coming out of process chip (111). In versions where sensor (105) optically detects process yield or residual material, etc., sensor (105) may be configured to detect visible light, fluorescent light, an ultraviolet (UV) absorbance signal, an infrared (IR) absorbance signal, and/or any other suitable kind of optical feedback.

In versions where sensors (105) include at least one optical sensor that is configured to capture video images, such sensors (105) may record at least some activity on process chip (111). For example, an entire run for synthesizing and/or processing a material (e.g., a therapeutic RNA) may be recorded by one or more video sensors (105), including a video sensor (105) that may visualize process chip (111) (e.g., from above). Processing on process chip (111) may be visually tracked and this video record may be retained for later quality control and/or processing. Thus, the video record of the processing may be saved, stored, and/or transmitted for subsequent review and/or analysis. In addition, as will be described in greater detail below, the video may be used as a real-time feedback input that may affect processing using at least visually observable conditions captured in the video.

System (100) of the present example is controlled by a controller (121). Controller (121) may include one or more processors, one or more memories, and various other electrical components as will be apparent to those skilled in the art in view of the teachings herein. In some versions, one or more components of controller (121) (e.g., one or more processors, etc.) is/are embedded within system (100) (e.g., contained within housing (103)). In addition, or in the alternative, one or more components of controller (121) (e.g., one or more processors, etc.) may be detachably attached or detachably connected with other components of system (100). Thus, at least a portion of controller (121) may be removable. Moreover, at least a portion of controller (121) may be remote from housing (103) in some versions.

The control by controller (121) may include activating pressure source (117) to apply pressure through process chip (111) to drive fluidic movement, among other tasks. Controller (121) may be completely or partially outside of housing (103); or completely or partially inside of housing (103). Controller (121) may be configured to receive user inputs via a user interface (123) of system (100); and provide outputs to users via user interface (123). In some versions, controller (121) is fully automated to a point where user inputs are not needed. In some such versions, user interface (123) may provide only outputs to users. User interface (123) may include a monitor, a touchscreen, a keyboard, and/or any other suitable features. Controller (121) may coordinate processing, including moving one or more fluid(s) onto and on process chip (111), mixing one or more fluids on process chip (111), adding one or more components to process chip (111), metering fluid in process chip (111), regulating the temperature of process chip (111), applying a magnetic field (e.g., when using magnetic beads), etc. Controller (121) may receive real-time feedback from sensors (105) and execute control algorithms in accordance with such feedback from sensors (105). Such feedback from sensors (105) may include, but need not be limited to, identification of reagents in vials in reagent storage frame (107), detected fluid levels in vials in reagent storage frame (107), detected movement of fluid in process chip (111), fluorescence of fluorophores in fluid in process chip (111), etc. Controller (121) may include software, firmware and/or hardware. Controller (121) may also communicate with a remote server, e.g., to track operation of the apparatus, to re-order materials (e.g., components such as nucleotides, process chips (111), etc.), and/or to download protocols, etc.

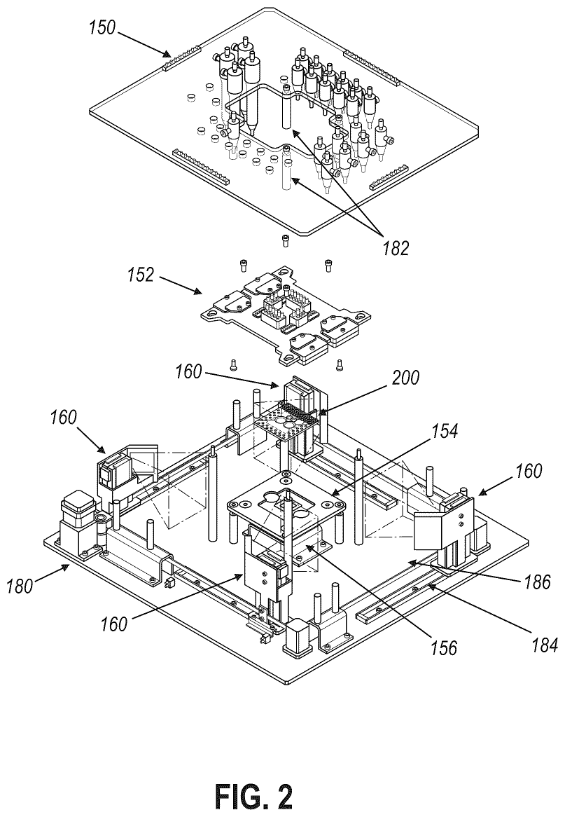

FIG. 2 shows examples of certain forms that may be taken by various components of system (100). In particular, FIG. 2 shows a reagent storage frame (150), a fluid interface assembly (152), a seating mount (154), a thermal control (156), and a process chip (200). Reagent storage frame (150), fluid interface assembly (152), seating mount (154), thermal control (156), and process chip (200) of this example may be configured and operable just like reagent storage frame (107), fluid interface assembly (109), seating mount (115), thermal control (113), and process chip (111), respectively, described above. These components are secured relative to a base (180). A set of rods (182) support reagent storage frame (150) over fluid interface assembly (152).

As shown in FIG. 2, a set of optical sensors (160) are positioned at four respective locations along base (180). Optical sensors (160) may be configured and operable like sensors (105) described above. Optical sensors (160) may include off-the-shelf cameras or any other suitable kinds of optical sensors. Optical sensors (160) are positioned such that fluid vials held within reagent storage frame (150) are within the field of view of one or more of optical sensors (160). In addition, process chip (200) is within the field of view of one or more of optical sensors (160). Each optical sensor (160) is movably secured to base (180) via a corresponding rail (184) (e.g., in a gantry arrangement), such that each optical sensor (160) is configured to translate laterally along each corresponding rail (184). A linear actuator (186) is secured to each optical sensor (160) and is thereby operable to drive lateral translation of each optical sensor (160) along the corresponding rail (184). Each actuator (186) may be in the form of a drive belt, a drive chain, a drive cable, or any other suitable kind of structure. Controller (121) may drive operation of actuators (186). Optical sensors (160) may be moved along rails (184) during operation of system (100) in order to facilitate viewing of the appropriate regions of vials in reagent storage frame (150) and/or process chip (200). In some scenarios, optical sensors (160) move in unison along corresponding rails (184). In some other scenarios, optical sensors (160) move independently along corresponding rails (184).

While optical sensors (160) are shown in FIG. 2 as being mounted to base (180), optical sensors (160) may be positioned elsewhere within system (100), in addition to or as an alternative to being mounted to base (180). For instance, some versions of reagent storage frame (107) may include one or more optical sensors (160) positioned and configured to provide an overhead field of view. In some such versions, such optical sensors (160) may be mounted to rails, movable cantilever arms, or other structures that allow such optical sensors (160) to be repositioned during operation of system (100). Other suitable locations in which optical sensors (160) may be positioned will be apparent to those skilled in the art in view of the teachings herein. While not shown, system (100) may also include one or more sources of light (e.g., electroluminescent panels, etc.) to provide illumination that aids in optical sensing by optical sensors (160).

In some versions, one or more mirrors are used to facilitate visualization of components of system (100) by optical sensors (160). Such mirrors may allow optical sensors (160) to view components of system (100) that may not otherwise be within the field of view of sensors (160). Such mirrors may be placed directly adjacent to optical sensors (160). In addition, or in the alternative, such mirrors may be placed adjacent to one or more components of system (100) that are to be viewed by optical sensors (160).

In use of system (100), an operator may select a protocol to run (e.g., from a library of preset protocols), or the user may enter a new protocol (or modify an existing protocol), via user interface (123). From the protocol, controller (121) may instruct the operator which kind of process chip (111) to use, what the contents of vials in reagent storage frame (107) should be, and where to place the vials in reagent storage frame (107). The operator may load process chip (111) into seating mount (115); and load the desired reagent vials and export vials into reagent storage frame (107). System (100) may confirm the presence of the desired peripherals, identify process chip (111), and scan identifiers (e.g., barcodes) for each reagent and product vial in reagent storage frame (107), facilitating the vials to match the bill-of-reagents for the selected protocol. After confirming the starting materials and equipment, controller (121) may execute the protocol. During execution, valves and pumps are actuated to deliver reagents as described in greater detail below, reagents are blended, temperature is controlled, and reactions occur, measurements are made, and products are pumped to destination vials in reagent storage frame (107).

### II. EXAMPLE OF PROCESS CHIP

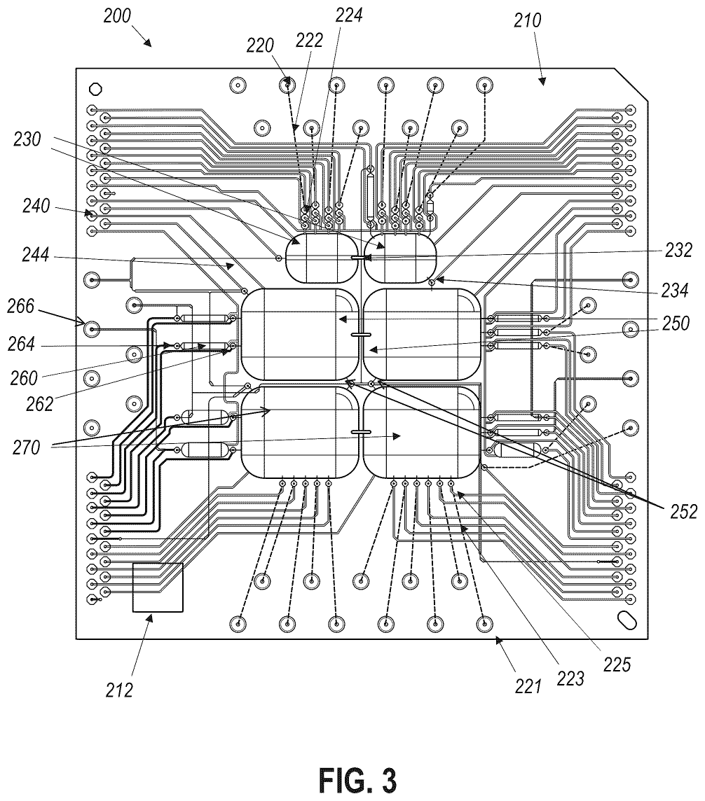

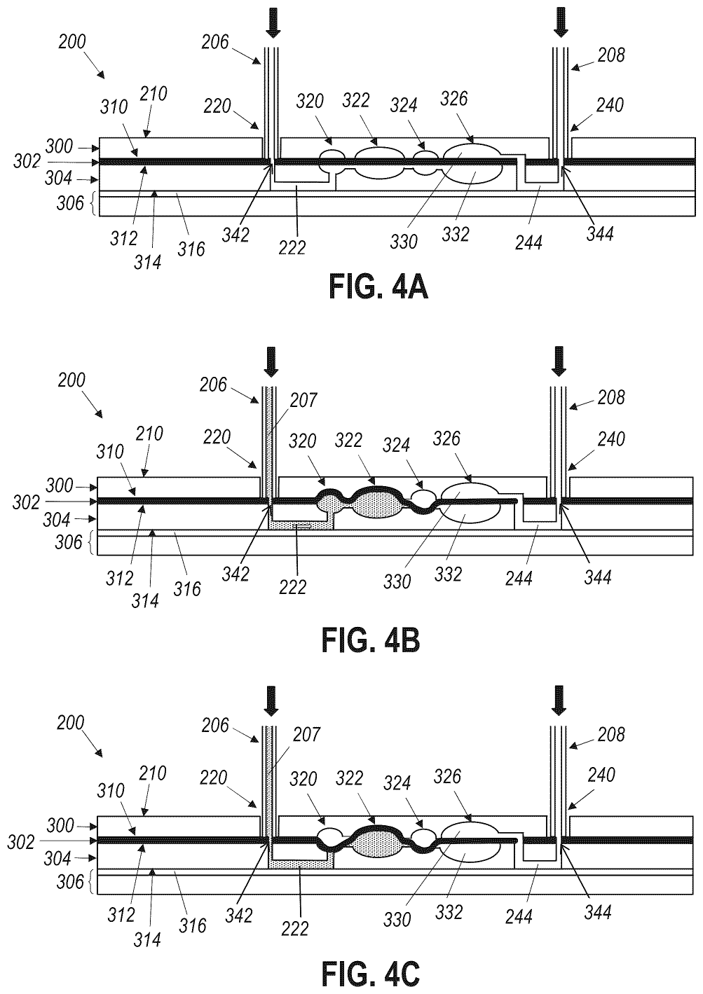

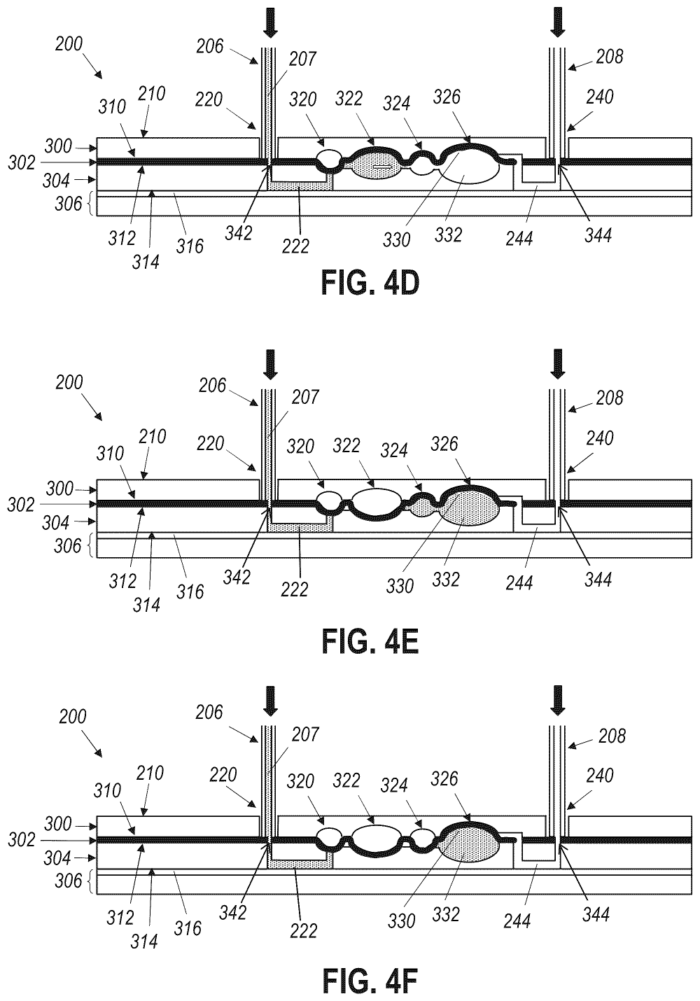

FIGS. 3 and 4A-4F depict the example of process chip (200) in further detail. In combination with the rest of system (100), process chip (200) may be utilized to provide in-vitro synthesis, purification, concentration, formulation, and analysis of therapeutic compositions, including but not limited to therapeutic polynucleotides. As shown in FIG. 3, process chip (200) of this example includes a plurality of fluid ports (220). Each fluid port (220) has an associated fluid channel (222) formed in process chip (200), such that fluid communicated into fluid port (220) will flow through the corresponding fluid channel (222). As described in greater detail below, each fluid port (220) is configured to receive fluid from a corresponding fluid line (206) from fluid interface assembly (109). In the present example, each fluid channel (222) leads to a valve chamber (224), which is operable to selectively prevent or permit fluid from the corresponding fluid channel (222) to be further communicated along process chip (200) as will be described in greater detail below.

As also shown in FIG. 3, process chip (200) of this example includes a plurality of additional chambers (230, 250, 270) that may be used to serve different purposes during the process of producing the therapeutic composition as described herein. By way of example only, such additional chambers (230, 250, 270) may be used to provide synthesis, purification, dialysis, compounding, and concentration of one or more therapeutic compositions; or to perform any other suitable function(s). Fluid may be communicated from one chamber (230) to another chamber (230) via a fluidic connector (232). In some versions, fluidic connector (232) is operable like a valve between an open and closed state (e.g., similar to valve chamber (224)). In some other versions, fluidic connector (232) remains open throughout the process of making the therapeutic composition. In the present example, chambers (230) are used to provide synthesis of polynucleotides, though chambers (230) may alternatively serve any other suitable purpose(s).

In the example shown in FIG. 3, another valve chamber (234) is interposed between one of chambers (230) and one of chambers (250), such that fluid may be selectively communicated from chamber (230) to chamber (250). Chambers (250) are provided in a pair and are coupled with each other such that process chip (200) may communicate the fluid back and forth between chambers (250). While a pair of chambers (250) are provided in the present example, any other suitable number of chambers (250) may be used, including just one chamber (250) or more than two chambers (250). Chambers (250) may be used to provide purification of the fluid and/or may serve any of the other various purposes described herein; and may have any suitable configuration. In versions where a chamber (250) is used for purification, chamber (250) may include a material that is configured to absorb selected moieties from a fluidic mixture in chamber (250). In some such versions, the material may include a cellulose material, which may selectively absorb double-stranded mRNA from a mixture. In some such versions, the cellulose material may be inserted in only one chamber (250) of a pair of chambers (250), such that upon mixing the fluid from the first chamber (250) of the pair to the second chamber (250), mRNA and/or some other component may be effectively removed from the fluidic mixture, which may then be transferred to another pair of chambers (270) further downstream for further processing or export. Alternatively, chambers (250) may be used for any other suitable purpose.

Additional valve chambers (252) are interposed between each chamber (250) and a corresponding chamber (270), such that fluid may be selectively communicated from chambers (250) to chambers (270) via valve chambers (252). Chambers (270) are also coupled with each other such that process chip (200) may communicate the fluid back and forth between chambers (270). Chambers (270) may be used to provide mixing of the fluid and/or may serve any of the other various purposes described herein; and may have any suitable configuration.

As shown in FIG. 3, chambers (270) are also coupled with additional fluid ports (221) via corresponding fluid channels (223) and valve chambers (225). Fluid ports (221), fluid channels (223), and valve chambers (225) may be configured an operable like fluid ports (220), fluid channels (222), and valve chambers (224) described above. In some versions, fluid ports (221) are used to communicate additional fluids to chambers (270). In addition, or in the alternative, fluid ports (221) may be used to communicate fluid from process chip (200) to another device. For instance, fluid from chambers (270) may be communicated via fluid ports (221) directly to another process chip (200), to one or more vials in reagent storage frame (107), or elsewhere.

Process chip (200) further includes several reservoir chambers (260). In this example, each reservoir chamber (260) is configured to receive and store fluid that is being communicated to or from a corresponding chamber (250, 270). Each reservoir chamber (260) has a corresponding inlet valve chamber (262) and outlet valve chamber (264). Each inlet valve chamber (262) is interposed between reservoir chamber (260) and the corresponding chamber (250, 270) and is thereby operable to permit or prevent the flow of fluid between reservoir chamber (260) and the corresponding chamber (250, 270). Each outlet valve chamber (264) is operable to meter the flow of fluid between reservoir chamber (260) and a corresponding fluid port (266). In some versions, each fluid port (266) is configured to communicate fluid from a corresponding vial in reagent storage frame (107) to a corresponding reservoir chamber (260). In addition, or in the alternative, each fluid port (266) may be configured to communicate fluid from a corresponding reservoir chamber (260) to a corresponding vial in reagent storage frame (107). In the present example, reservoir chambers (260) are used to provide metering of fluid communicated to and/or from process chip (200). Alternatively, reservoir chambers (260) may be utilized for any other suitable purposes, including but not limited to pressurizing fluid that is communicated to and/or from process chip (200).

As also shown in FIG. 3, process chip (200) of this example includes a plurality of pressure ports (240). Each pressure port (240) has an associated pressure channel (244) formed in process chip (200), such that pressurized gas communicated through pressure port (240) will be further communicated through the corresponding pressure channel (244). As described in greater detail below, each pressure port (240) is configured to receive pressurized gas from a corresponding pressure line (208) from fluid interface assembly (109). In the present example, each pressure channel (244) leads to a corresponding chamber (224, 225, 230, 234, 250, 252, 260, 262, 264, 270) to thereby provide valving or peristaltic pumping via such chambers (224, 225, 230, 234, 250, 252, 260, 262, 264, 270) as described in greater detail below.

Process chip (200) may also include electrical contacts, pins, pin sockets, capacitive coils, inductive coils, or other features that are configured to provide electrical communication with other components of system (100). In the example shown in FIG. 3, process chip (200) includes an electrically active region (212) includes such electrical communication features. Electrically active region (212) may further include electrical circuits and other electrical components. In some versions, electrically active region (212) may provide communication of power, data, etc. While electrically active region (212) is shown in one particular location on process chip, electrically active region (212) may alternatively be positioned at any other suitable location or locations. In some versions, electrically active region (212) is omitted.

As shown in FIGS. 4A-4F, process chip (200) further includes a first plate (300), an elastic layer (302), a second plate (304), and a third plate (306). As described in greater detail below, some versions of elastic layer (302) are in the form of a flexible membrane. First plate (300) has an upper surface (210) and a lower surface (310), with lower surface (310) apposing elastic layer (302). Second plate (304) has an upper surface (312) and a lower surface (314), with upper surface (312) apposing elastic layer (302); and with lower surface (314) apposing third plate (306). Elastic layer (302) is thus interposed between first and second plates (300, 304). In the present example, another elastic layer (316) is also interposed between second and third plates (304, 306), though this elastic layer (316) is optional.

Plates (300, 304, 306) of the present example are substantially translucent to visible light and/or ultraviolet light. By “substantially translucent” is meant that at least 90% (including in some instances 100%) of light is transmitted through the material compared to a translucent material. In some variations, the one or more of plates (300, 304, 306) may comprise materials that are substantially transparent to visible light and/or ultraviolet light. By “substantially” translucent is meant that at least 90% (including in some instances 100%) of light is transmitted through the material compared to a completely transparent material. As another example, one or more of plates (300, 304, 306) may provide transmission of ultraviolet light at a wavelength of approximately 260 nm at a transmission rate ranging from approximately 0.2% to approximately 20%, including from approximately 0.4% to approximately 15%, or including from approximately 0.5% to approximately 10%.

Plates (300, 304, 306) of the present example are also rigid. In some other versions, one or more of plates (300, 304, 306) are semi-rigid. Plates (300, 304, 306) may comprise glass, plastic, silicone, and/or any other suitable material(s). In some versions, one or more of plates (300, 304, 306) is formed as a lamination of two or more layers of material, such that each plate (300, 304, 306) does not necessarily need to be formed as a single homogenous continuum of material. The material(s) comprising one of plates (300, 304, 306) may also differ from the material(s) comprising other plates (300, 304, 306).

Elastic layer (302) of the present example is formed as a liquid-impermeable flexible membrane. In some versions, elastic layer (302) is gas-permeable despite being liquid-impermeable. In some such versions, certain regions of elastic layer (302) are treated to be gas-permeable while the non-treated regions of elastic layer (302) are gas-impermeable. As described below, elastic layer (302) may be used to drive fluids across process chip (200) via peristaltic pumping action. As also described below, elastic layer (302) may be used to provide valves at various locations along process chip (200). In some versions, a single sheet of elastic material spans across the width of process chip (200) to form elastic layer (302). In some other versions, two or more discrete pieces of elastic material are used to form elastic layer (302), which such discrete pieces of elastic material being positioned at different locations across the width of process chip (200). By way of example only, elastic layer (302) may include a membrane comprising polydimethylsilicone (PDMS) elastomer film.

As best seen in FIGS. 4A-4F, first and second plates (300, 304) cooperate to define a plurality of chambers (320, 322, 324, 326), with elastic layer (302) bisecting each chamber (320, 322, 324, 326) into a corresponding upper chamber region (330) and lower chamber region (332). Chambers (224, 225, 230, 234, 250, 252, 260, 262, 264, 270) shown in FIG. 3 may be configured and operable just like chambers (320, 322, 324, 326) shown in FIGS. 4A-4F. For instance, chamber (320) may be analogous to chamber (264), chamber (322) may be analogous to chamber (260), chamber (324) may be analogous to chamber (262), and chamber (326) may be analogous to chamber (250).

As shown in FIGS. 4A-4F, fluid port (220) is formed through first plate (220). A corresponding opening (342) is formed through the region of elastic layer (302) underlying fluid port (220). Fluid channel (222) extends from opening (342) to lower chamber region (332) of first chamber (320). As noted above, fluid port (220) is configured to receive a fluid line (206) from fluid interface assembly (109). The distal end of fluid line (206) is configured to seal against the region of elastic layer (302) that is exposed by fluid port (220) and communicate fluid (207) through opening (342). In some versions, a spring or other resilient member provides a resilient bias to fluid line (206), urging the distal end of fluid line (206) against the region of elastic layer (302) that is exposed by fluid port (220) to thereby maintain the seal. Fluid (207) from fluid line (206) reaches lower chamber region (332) of first chamber (320) via fluid channel (222). As described in greater detail below, this fluid (207) may be further communicated from first chamber (320) to other chambers (322, 324, 326) through a peristaltic pumping action that is provided via elastic layer (302). After reaching fourth chamber (326), the fluid (207) may be further communicated to other chambers or other features in process chip (200), may be communicated to a storage vial in reagent storage frame (107), or may be otherwise processed. The path for fluid (207) thus does not necessarily terminate at fourth chamber (326). It should also be understood that any of the other fluid ports (221, 266) shown in FIG. 3 may be configured and operable like fluid port (220) shown in FIGS. 4A-4F.

Pressure port (240) is formed through first plate (220). A corresponding opening (344) is formed through the region of elastic layer (302) underlying fluid port (240). Pressure channel (244) extends from opening (344) to upper chamber region (330) of first chamber (320). As noted above, pressure port (240) is configured to receive a pressure line (208) from fluid interface assembly (109), to thereby receive pressurized gas from pressure source (117). The distal end of pressure line (208) is configured to seal against the region of elastic layer (302) that is exposed by pressure port (240) and communicate either positively pressurized gas or negatively pressurized gas through opening (344). In some versions, a spring or other resilient member provides a resilient bias to pressure line (208), urging the distal end of pressure line (208) against the region of elastic layer (302) that is exposed by pressure port (240) to thereby maintain the seal. Positively pressurized gas or negatively pressurized gas from pressure line (208) reaches upper chamber region (330) of fourth chamber (326) via pressure channel (244).

While FIGS. 4A-4F depict just one pressure line (208) being coupled with process chip (200), process chip (200) may have several coupled pressure lines (208), with such pressure lines (208) independently applying positive or negative pressure to corresponding chambers (320, 322, 324, 326) of process chip (200). In some versions, one or more of chambers (320, 322, 324, 326) has its own dedicated pressure line (208) and corresponding pressure channel (244). In addition, or in the alternative, one or more of chambers (320, 322, 324, 326) may share a common pressure line (208), via the same pressure channel (244) or via separate pressure channels (244). While FIGS. 4A-4F depict pressure channel (244) formed through second plate (304), some pressure channels (244) (or regions of pressure channels (244)) may be formed by first plate (300). For instance, some pressure channels (244) (or regions of pressure channels (244)) may be formed between a recess in the lower surface of first plate (300) and the top surface of elastic layer (302).

### A. Example of Valving and Peristaltic Pumping Driven via Elastic Layer

As noted above, elastic layer (302) may be operated to drive fluid through process chip (200) through a peristaltic pumping action; and to arrest movement of fluid through process chip (200) by providing a valving action. An example of such operation is illustrated in the sequence depicted through FIGS. 4A-4F. In this example, chambers (320, 324) serve as valve chambers, while chamber (322) serves as a metering chamber. Chamber (326) serves as a working chamber, such that synthesis, purification, dialysis, compounding, concentration, or some other process is performed in chamber (326). This configuration, arrangement, and usage of chambers (320, 322, 324, 326) is provided as an illustrative example. Chambers (320, 322, 324, 326) may alternatively be configured, arranged, and used in other ways.

FIG. 4A shows process chip (200) in a state where fluid is not yet being communicated to process chip (200); and pressurized gas is not yet being communicated to process chip (200). In FIG. 4B, positively pressurized gas is communicated to upper chamber region (330) of chamber (324), negatively pressurized gas is communicated to upper regions (330) of chambers (320, 322), and fluid (207) is communicated to chambers (320, 322). In this state, the positively pressurized gas deforms the portion of elastic layer (302) in chamber (324) such that elastic layer (302) seats against the surface of lower chamber region (332) of chamber (324). This seating of elastic layer (302) against the surface of lower chamber region (332) of chamber (324) prevents fluid (207) from entering chamber (324), such that chamber (324) is operating like a closed valve in the state shown in FIG. 4B. The negatively pressurized gas in upper chamber regions (330) of chambers (320, 322) causes the corresponding portion of elastic layer (302) in chambers (320, 322) to deform and seat against upper chamber regions (330) of chambers (320, 322). This allows fluid (207) to occupy the full capacity of chambers (320, 322).

After reaching the state shown in FIG. 4B, positively pressurized gas is communicated to upper chamber region (330) of chamber (320) while the pneumatic state of chambers (322, 324) may remain unchanged. This results in the state shown in FIG. 4C. As shown, the positively pressurized gas deforms the portion of elastic layer (302) in chamber (320) such that elastic layer (302) seats against the surface of lower chamber region (332) of chamber (320). This seating of elastic layer (302) against the surface of lower chamber region (332) of chamber (320) drives the fluid (207) out from chamber (320) and results in chamber (320) operating like a closed valve in the state shown in FIG. 4C. However, the volume of fluid (207) in chamber (322) is unaffected in the state shown in FIG. 4C. Chamber (322) may thus be used to provide metering of fluid (207), such that only a precise, predetermined volume of fluid (207) is communicated further along process chip (200). By way of example only, such metered volumes may be on the order of approximately 10 nL, 20 nL, 25 nL, 50 nL, 75 nL, 100 nL, 1 microliter, 5 microliters, etc.

Once the appropriate metering volume has been achieved, negatively pressurized gas is communicated to upper chamber regions (330) of chambers (324, 326) while the pneumatic state of chambers (320, 322) may remain unchanged. This results in the state shown in FIG. 4D. As shown, the negatively pressurized gas in upper chamber regions (330) of chambers (324, 326) causes the corresponding portion of elastic layer (302) in chamber (324, 326) to deform and seat against the surface of upper chamber regions (330) of chambers (324, 326). This effectively opens the valve formed by chamber (324) and puts chamber (326) in a state to receive fluid (207). This also produces a negative pressure in chamber (324) that draws fluid (207) from chamber (322) into chamber (324).

With the valve formed by chamber (324) being in the open state, positively pressurized gas is communicated to upper chamber region (330) of chamber (322) while the pneumatic state of chambers (320, 324, 326) may remain unchanged. This results in the state shown in FIG. 4E. As shown, the positively pressurized gas in upper chamber region (330) of chamber (322) causes the corresponding portion of elastic layer (302) in chamber (322) to deform and seat against the surface of lower chamber region (332) of chamber (322). This deformation of elastic layer (302) drives fluid (207) out of chamber (322). Since the valve formed by chamber (320) is in a closed state and the valve formed by chamber (324) is in an open state, fluid (207) travels from chamber (322) into chamber (324). In the present example, the capacity of chamber (322) is greater than the capacity of chamber (324), such that fluid (207) from chamber (322) overflows from chamber (324) into chamber (326).

Once fluid (207) has been communicated from chamber (322) to chambers (324, 326), positively pressurized gas is communicated to upper chamber region (330) of chamber (324) while the pneumatic state of chambers (320, 322, 326) may remain unchanged. This results in the state shown in FIG. 4F. As shown, the positively pressurized gas in upper chamber region (330) of chamber (324) causes the corresponding portion of elastic layer (302) in chamber (324) to deform and seat against the surface of lower chamber region (332) of chamber (324). This deformation of elastic layer (302) drives fluid (207) out of chamber (324). Since the deformed portion of elastic layer (302) in chamber (324) is effectively sealing off chamber (324) from chamber (324) (e.g., such that chamber (324) is operating like a valve in a closed state), fluid (207) travels from chamber (324) into chamber (326).

At the stage shown in FIG. 4F, fluid (207) has been evacuated from chambers (320, 332, 324), and chamber (326) contains the volume of fluid (207) that was precisely metered in chamber (322). Fluid (207) in chamber (326) may be further processed within chamber (326) in accordance with the teachings herein. In addition, or in the alternative, fluid (207) in chamber (326) may be communicated to one or more other chambers in process chip (200), may be communicated to a vial in reagent storage frame (107), or may be otherwise handled. Regardless of what is done with fluid (207) after fluid (207) has reached chamber (326), it should be understood that fluid (207) was communicated along chambers (320, 322, 324), in a sequence, to reach chamber (326) via a peristaltic action created through elastic layer (302) in response to positively pressurized gas or negatively pressurized gas being communicated to upper chamber regions (330) of chambers (320, 322, 324, 326) in a particular sequence. Such peristaltic pumping may have particular advantage for moving fluid that may be viscous or contain suspended particles such as purification or capture beads. Such peristaltic pumping through selective deformation of elastic layer (302) may also be referred to as pneumatic barrier deflection or “pneumodeflection.”

In some scenarios, it may be desirable to remove air or other gas from one or more fluid pathways in process chip (200). To accomplish this, process chip (200) may include one or more chambers that are configured to provide ventilation of a fluid pathway or otherwise evacuate gas from the fluid pathway. For instance, such ventilation or evacuation may be performed as part of a priming process as fluid is initially introduced to process chip (200). In addition, or in the alternative, such ventilation or evacuation may be performed to relieve gas that is generated in the fluid during the process of forming the therapeutic composition. Such ventilation or gas relief chambers may be referred to as “vacuum caps.” In some versions, at least the region of elastic layer (302) that is positioned in the vacuum cap (if not the entirety of elastic layer (302)) is gas permeable (while still being liquid impermeable). Negatively pressurized gas may be applied to the upper chamber region (330) of the chamber that is being used as a vacuum cap, and this negatively pressurized gas may draw the air or gas from the fluid pathway out through the corresponding region of elastic layer (302). In some versions, the upper chamber region (330) of the chamber that is being used as a vacuum cap includes one or more projections or stand-off features that prevent the corresponding region of elastic layer (302) from fully seating against the surface of the upper chamber region (330) of the chamber that is being used as a vacuum cap. This may further promote evacuation of air or other gas via the vacuum cap.

### B. Example of Mixing Stage

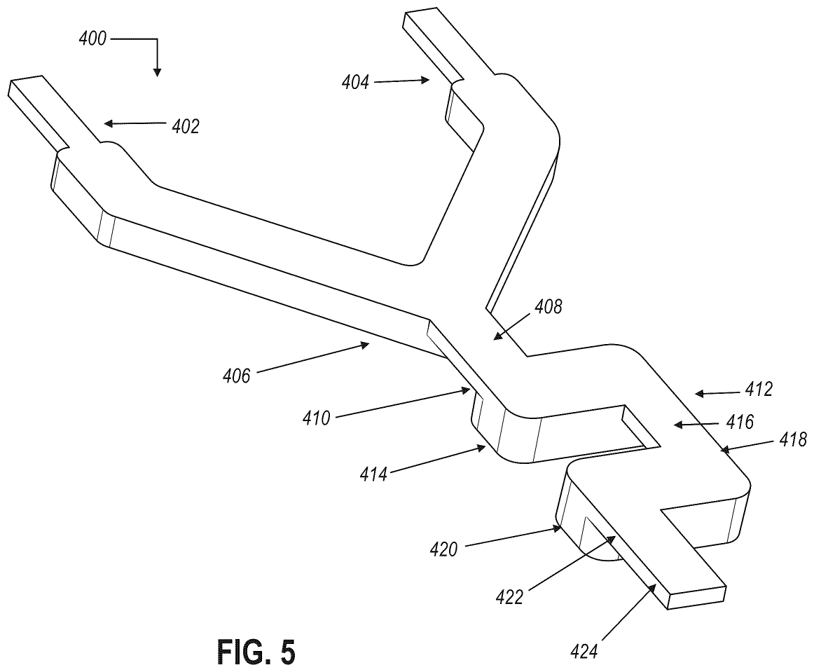

While chambers (270) may be used to perform mixing of a fluid (e.g., by repeatedly communicating the fluid back and forth between chambers (270)), it may be desirable to provide a differently configured mixing stage along a fluid path leading toward a chamber. FIG. 5 shows an example of such a mixing stage (400) that may be incorporated into a process chip (111, 200). Mixing stage (400) may also be referred to as a “mixer,” such that the terms “mixer” and “mixing stage” should be read interchangeably. Mixing stage (400) of this example includes two fluid inlet channels (402, 404) that are offset from each other and are configured to transport one or more substances (e.g., biomolecular product(s), buffers, carriers, subsidiary components) that may be combined together. Although two inlet channels (402, 404) are shown, three or more (4, 5, 6, etc.) may be used, and may converge in the same mixing stage (400). The fluidic mixtures may transit inlet channels (402, 404) under positive pressure. This pressure may be constant, variable, increasing, decreasing, and/or pulsatile. Inlet channels (402, 404) may receive fluid from any of the various kinds of chambers or fluid ports described herein.

Inlet channels (402, 404) converge at an intersection (406) that leads to a merged channel (408). In the present example, merged channel (408) has a cross-sectional area that is smaller than the cross-sectional area of each inlet channel (402, 404). The reduced cross-sectional area may include a channel height that is less than the channel height of inlet channels (402, 404) and/or a channel width that is less than the channel width of inlet channels (402, 404). This reduced cross-sectional area may promote mixing of fluids that are introduced via inlet channels (402, 404).

A first vortex mixing chamber (414) is positioned downstream of merged channel (408), with fluid flowing into first vortex mixing chamber (414) via an inlet opening (410). Inlet opening (410) is positioned near a corner of first vortex mixing chamber (414). An outlet opening (412) is positioned near another corner of first vortex mixing chamber (414). First vortex mixing chamber (414) has a height and width greater than the height and width of merged channel (408). These greater dimensions, along with the relative positioning of inlet opening (410) and outlet opening (412), may promote the formation of a vortex within first vortex mixing chamber (414). Such a vortex may further promote mixing of fluid as the fluid flows through first vortex mixing chamber (414).

A connecting channel (416) connects first vortex mixing chamber (414) with a second vortex mixing channel (420). Connecting channel (416) has a height and width less than the height and width of first vortex mixing chamber (414). Second vortex mixing channel (420) has a height and width greater than the height and width of connecting channel (416). Fluid flows from connecting channel (416) into second vortex mixing chamber (420) via an inlet opening (418), which is positioned near a corner of second vortex mixing chamber (420). Fluid flows out of second vortex mixing chamber (420) via an outlet opening (422), which is positioned at another corner of second vortex mixing chamber (420). Outlet opening (420) leads to an outlet channel (424). Outlet channel (424) has a height and width less than the height and width of second vortex mixing chamber (420). The greater dimensions of second vortex mixing chamber (420) (relative to the dimensions of channels (416, 424), and the relative positioning of inlet opening (418) and outlet opening (422), may promote the formation of a vortex within second vortex mixing chamber (420). Such a vortex may further promote mixing of fluid as the fluid flows through second vortex mixing chamber (420).

By the time the fluid flows out through outlet channel (424), the fluid may be sufficiently mixed by mixing stage (400). Such mixed fluid may be further communicated to other chambers or ports for further processing. While mixing stage (400) of this example has two vortex mixing chambers (414, 420), other versions may have just one vortex mixing chamber or more than two vortex mixing chambers.

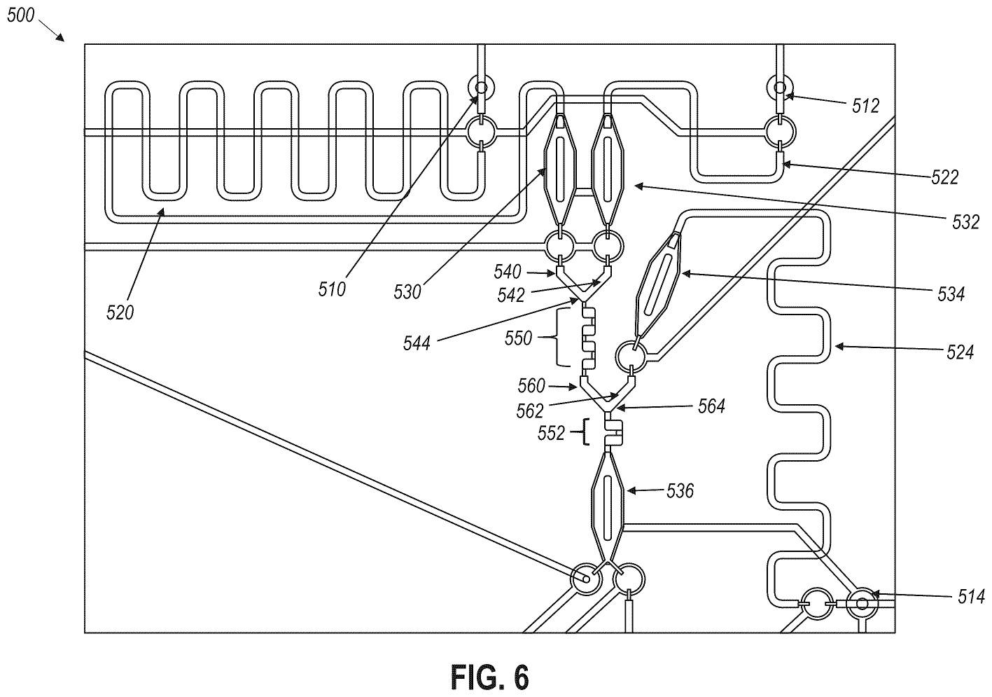

FIG. 6 shows an example of a region of a process chip (500) incorporating two mixing stages. In this example, a first fluid passes through a first inlet valve (510), then through a first flow restrictor (520) in the form of a serpentine channel, then through a first vacuum cap (530), before reaching a first inlet (540) of a first mixing stage. A second fluid passes through a second fluid inlet valve (512), then through a second flow restrictor (522) in the form of a serpentine channel, then through a second vacuum cap (532) before reaching a second inlet (542) of the first mixing stage. Inlets (540, 542) converge to provide a single flow path through a merged channel (544), which leads to a first set (550) of vortex mixing chambers. The vortex mixing chambers of first set (550) may be configured and operable like vortex mixing chambers (414, 420) described above. While four vortex mixing chambers are included in first set (550) in this example, first set (550) may instead have any other suitable number of vortex mixing chambers.

After flowing through first set (550) of vortex mixing chambers, the fluid reaches a first inlet (560) of a second mixing stage. A third fluid passes through a third fluid inlet valve (514), then through a third flow restrictor (524) in the form of a serpentine channel, then through a third vacuum cap (534) before reaching a second inlet (562) of the second mixing stage. Inlets (560, 562) converge to provide a single flow path through a merged channel (564), which leads to a second set (552) of vortex mixing chambers. The vortex mixing chambers of second set (552) may be configured and operable like vortex mixing chambers (414, 420) described above. While two vortex mixing chambers are included in second set (552) in this example, second set (552) may instead have any other suitable number of vortex mixing chambers.

After flowing through second set (552) of vortex mixing chambers, the fluid passes through a fourth vacuum cap (536). After passing through fourth vacuum cap (536), the fluid may be substantially mixed by both sets (550, 552) of vortex mixing chambers; and any air bubbles may have been removed by vacuum caps (530, 532, 534, 536). The mixed fluid may be further communicated to other chambers or ports for further processing after passing through fourth vacuum cap (536).

In one example of how process chip (500) may be used, a polynucleotide (e.g., mRNA in water) may be introduced via first inlet valve (510) while a delivery vehicle molecule or molecules in a fluid medium (e.g., ethanol or some other fluid medium) may be introduced via second inlet valve (512). These fluids may be mixed through first set (550) of vortex mixing chambers to form complexed nanoparticles. A dilution agent (e.g., citrate-based buffer solution or other kind of buffer) may be introduced via third inlet valve (514) to provide pH adjustment as the dilution agent is mixed with the complexed nanoparticle in second set (552) of vortex mixing chambers. Other suitable ways in which process chip (500) may be used will be apparent to those skilled in the art in view of the teachings herein.

The foregoing structures are examples of how mixing of fluids from different sources may be carried out in a process chip (111, 200, 500). It is contemplated that various other kinds of structures may be used to provide mixing of fluids from different sources in a process chip (111, 200, 500).

### C. Example of Pressure Sensing Stage

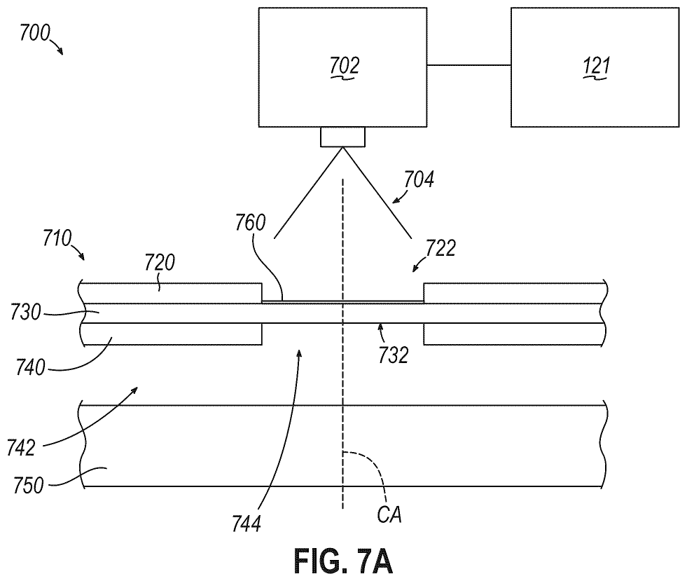

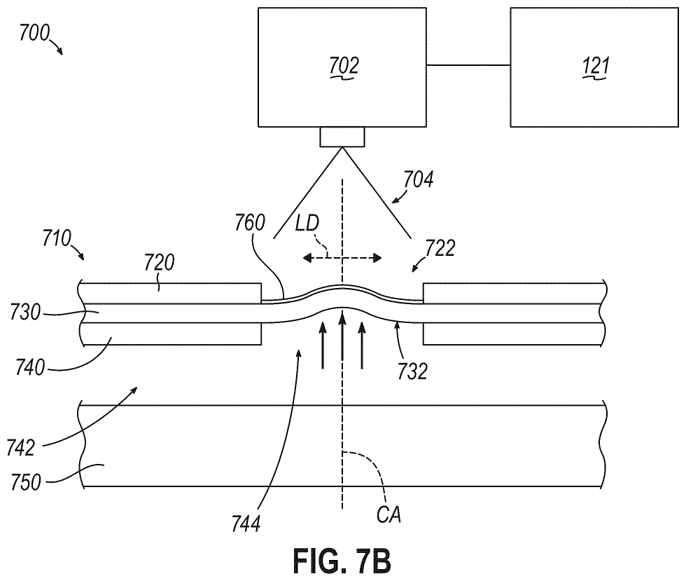

In some scenarios, it may be desirable to provide one or more sensors that are operable to sense the pressure of fluid in a process chip (111, 200, 500). FIGS. 7A-7B show an example of a pressure sensing stage (700) that includes a portion of a process chip (710), a camera (702), and controller (121). In addition to including the features and functionality described below, process chip (710) may include any of the other features and functionalities described above in the context of process chips (111, 200, 500). In other words, the following teachings relating to pressure sensing stage (700) may be readily applied to any of the various process chips (111, 200, 500) described herein.

Camera (702) of the present example is positioned to provide a field of view (704) in which camera (702) may capture images of an optical feature (760) of process chip (700). Controller (121) receives image signals from camera (702) and processes those image signals to determine a fluid pressure value as described in greater detail below. Controller (121) may further execute various algorithms using at least such determined fluid pressure values, as will also be described in greater detail below. In the present example, controller (121) of pressure sensing stage (700) is the same controller (121) that is used to perform other operations in system (100) as described above. In some other versions, a separate controller is used to determine fluid pressure values using at least image signals from camera (702). In such versions, the separate controller may communicate those determined fluid pressure values to controller (121) for execution of pressure-based algorithms. Alternatively, the determined fluid pressure values may be utilized in any other suitable fashion by any other suitable hardware components.

Process chip (710) of the present example includes a first plate (720), an elastic layer (730), a second plate (740), and a third plate (750). Elastic layer (730) is interposed between plates (720, 740). Third plate (750) cooperates with second plate (740) to define a channel (742) through which fluid may flow. The region of channel (742) at the left-hand side of FIGS. 7A-7B may be regarded as a fluid inlet port of pressure-sensing stage (700); while the region of channel (742) at the right-hand-side of FIGS. 7A-7B may be regarded as a fluid output port of pressure-sensing stage (700). Plates (720, 740, 750) of process chip (710) may be configured and operable like plates (300, 304, 306) of process chip (200). Similarly, elastic layer (730) of process chip (710) may be configured and operable like elastic layer (302) of process chip (200). Thus, elastic layer (730) may extend across all or a substantial portion of the width of process chip (710), such that elastic layer (730) may also perform functions in other chambers of process chip (710) (e.g., valving, peristaltic pumping, ventilating etc.).

Second plate (740) defines an opening (744) that is fluidically coupled with channel (742), such that opening (744) exposes a portion (732) of elastic layer (730) to fluid in channel (742). First plate (720) defines an opening (722) that is aligned with opening (744) of second plate (740). In the present example, with opening (744) providing a path for fluid in channel (742) to reach portion (732) of elastic layer (730), and with opening (722) providing clearance for elastic layer (730) to deform, portion (732) of elastic layer (730) may achieve a deformed state as shown in FIG. 7B in response to positive pressurization of fluid within channel (742).

Optical feature (760) is positioned atop portion (732) of elastic layer (730). Optical feature (760) is configured to deform with elastic layer (730). For instance, as shown in the transition from FIG. 7A (non-pressurized state) to FIG. 7B (pressurized state), clastic layer (730) and optical feature (760) deform together, upwardly along a central axis (CA), in response to positive pressurization of fluid within channel (742). In this example, the central axis (CA) is perpendicular to the plane defined by elastic layer (730) when elastic layer (730) is in a non-deformed state (FIG. 7A); and is positioned at the radial center of opening (722). The pressurized state shown in FIG. 7B may occur during the peristaltic driving of fluid from one location upstream of channel (742) to another location downstream of channel (742) during any of the various operations described herein. In addition, or in the alternative, the pressurized state shown in FIG. 7B may occur in various other scenarios, including but not limited to the fluid in channel (742) being from an already-pressurized fluid source in reagent storage frame (107), changes in ambient pressure, pressure loss due to piping, and/or various other conditions. With optical feature (760) being directly or indirectly within the field of view (704) of camera (702), camera (702) is operable to capture images of the deformation of optical feature (760) and transmit the image data to controller (121). Controller (121) is operable to convert the image data into a pressure value indicating the pressure of fluid in channel (742) as described in greater detail below.

As elastic layer (730) and optical feature (760) deform together along the central axis (CA) in response to positive pressurization of fluid within channel (742) (FIG. 7B), elastic layer (730) and optical feature (760) may also deform along a lateral dimension (LD) that is transverse to the central axis (CA). As described in greater detail below, camera (702) and controller (121) may be operated to particularly track this “lateral deformation” along the lateral dimension (LD) to determine the pressure of fluid in channel (742). Such lateral deformation of elastic layer (730) and optical feature (760) may be tracked in addition to, or in lieu of, tracking the deformation of elastic layer (730) and optical feature (760) along the central axis (CA).

While FIG. 7B depicts elastic layer (730) and optical feature (760) deforming upwardly along the central axis (CA) in response to positive pressurization of fluid within channel (742), there may also be scenarios where elastic layer (730) and optical feature (760) deform downwardly along the central axis (CA) in response to negative pressurization of fluid within channel (742). In such scenarios, elastic layer (730) and optical feature (760) may also achieve lateral deformation as described above. Camera (702) and controller (121) may thus be operated to track this lateral deformation to determine the pressure of fluid in channel (742) regardless of whether the pressure is positive (resulting in upward deformation along the central axis (CA)) or negative (resulting in downward deformation along the central axis (CA)).

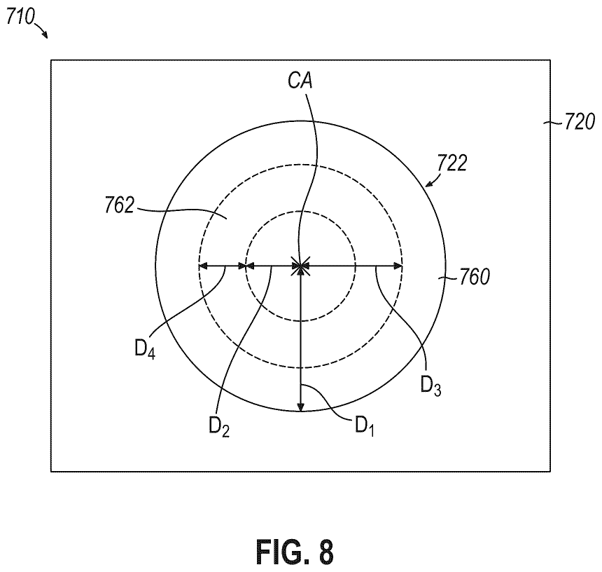

As shown in FIG. 8, optical feature (760) spans across the full radial distance (D₁) of opening (722). Alternatively, optical feature (760) may span across only a portion of the full radial distance (D₁) of opening (722). In some versions, it may be desirable to track lateral deformation of elastic layer (730) via a certain annular region (762) of optical feature (760). In other words, it may be desirable to track deformation of a certain annular region of elastic layer (730) by optically tracking optical feature (760) within annular region (762) of optical feature (760). In this example, annular region (762) is radially offset outwardly from the central axis (CA); and radially offset inwardly from the outer perimeter of opening (722). Annular region (762) is defined between a first partial radial distance (D₂) and a second partial radial distance (D₃). Annular region (762) thus has a radial dimension (D₄) between these partial radial distances (D₂, D₃).

By way of example only, opening (722) may have a full radial distance (D₁) ranging from approximately 0.75 mm to approximately 3.5 mm. By way of further example only, first partial radial distance (D₂) may range from approximately 0.2 mm to approximately 2.0 mm. By way of further example only, second partial radial distance (D₃) may range from approximately 1.0 mm to approximately 3.0 mm. By way of further example only, radial dimension (D₄) of annular region (762) may range from approximately 0.5 mm to approximately 2.25 mm. As another example, optical feature (760) may take the form of concentric rings that are spaced apart from each other by a distance ranging from approximately 50 micrometers to approximately 150 micrometers.

In the present example, optical feature (760) does not affect the elasticity of elastic layer (730). In some versions, optical feature (760) is adhered to elastic layer (730) via an adhesive. In some other versions, optical feature (760) is in the form of a film that is applied to elastic layer (730). In some other versions, optical feature (760) is printed directly on elastic layer (730). In some other versions, optical feature (760) is inscribed on elastic layer (730). In some other versions, optical feature (760) is formed as a texture on elastic layer (730). Alternatively, optical feature (760) may be secured to or otherwise incorporated into elastic layer (730) in any other suitable fashion. In some versions, optical feature (760) spans across the full area of portion (732) of elastic layer (730) as defined by the full radial distance (D₁) of opening (722). In some other versions, optical feature (760) is only positioned on one or more discrete regions of portion (732) of elastic layer (730) within opening (722), without spanning across the full area of portion (732) of elastic layer (730) within opening (722). For instance, in some versions, optical feature (760) is only positioned in annular region (762) shown in FIG. 8, such that optical feature (760) does not extend through first partial radial distance (D₂) or through the space between second partial radial distance (D₃) and full radial distance (D₁).

In the present example, the pressure sensing portion (732) of elastic layer (730) and optical feature (760) are exposed to atmosphere, such that the deformation of elastic layer (730) and optical feature (760) is using at least the difference between the pressure of fluid in channel (742) and atmospheric pressure. In some other versions, the region of process chip (700) above the pressure sensing portion (732) of elastic layer (730) and optical feature (760) may be enclosed and exposed to a fluid path that is pressurized by system (100) at a known pressure level. In such scenarios, controller (121) may measure the pressure of fluid in channel (742) relative to this known, system-generated pressure level. Such versions may prevent changes in atmospheric pressure from affecting the pressure sensing process in a manner that might otherwise occur in versions where the pressure sensing portion (732) of elastic layer (730) and optical feature (760) are exposed to atmosphere.

### III. EXAMPLE OF PARTICLE SIZE SENSING VIA DYNAMIC LIGHT SCATTERING

As noted above, one or more process chips (111, 200, 500) may be utilized to prepare polynucleotide therapeutics (e.g., mRNA therapeutics, etc.). For instance, a polynucleotide such as mRNA in water may be mixed with a delivery vehicle molecule or molecules in ethanol to form complexed nanoparticles. In some scenarios where a process chip (111, 200, 500) is utilized to prepare an mRNA therapeutic composition, it may be desirable to encapsulate mRNA in particles that are on the order of 100 nm in diameter. The process of encapsulating may include tuned mixing of mRNA with delivery vehicle molecules via mixing stages such as the mixing stages (400) described above. Such delivery vehicle molecules may include lipitoid-based molecules, such as amino-lipidated peptoids. During this process, the temperature of the mixing stages (400) may be controlled to a temperature or range of temperatures (e.g., between about 2 degrees C. and about 20 degrees C.) that is calibrated to enhance mixing for mixing in the mixing stages (400). The enhanced mixing temperature may be based on the formulation being mixed (in some examples the sequence of the mRNA and/or the delivery vehicle) within the particular geometry of the mixing chamber.

As used herein, “delivery vehicle” refers to any substance that facilitates, at least in part, the in vivo, in vitro, or ex vivo delivery of a polynucleotide to targeted cells or tissues (e.g., tumors, etc.). Referring to something as a delivery vehicle need not exclude the possibility of the delivery vehicle also having therapeutic effects. Some versions of a delivery vehicle may provide additional therapeutic effects. In some versions, a delivery vehicle may be an amino-lipidated peptoid delivery vehicle that may at least partially encapsulate mRNA.

Variations in the shape of the mixing chambers (414, 420, 550, 552), flow rates, chemical compositions, and mixing ratios may all affect particle size and/or size distribution, which may in turn affect therapeutic effectiveness. While these variations may occur due to process control limitations, these variations may also change over time due to the dynamic nature of the process. For instance, material may deposit and accumulate on the walls of the mixing chamber (414, 420, 550, 552) over time, thereby altering the properties of the mixing chamber (414, 420, 550, 552), thereby altering the output from the mixing chamber (414, 420, 550, 552). While some such changes may be tolerable to an extent, it may be beneficial to provide a quality control feature to monitor whether the output of a mixing chamber (414, 420, 550, 552) has deviated beyond tolerance. It may be further desirable for such a quality control feature to provide such monitoring on the process chip (111, 200, 500), without requiring fluids to be communicated from the process chip (111, 200, 500) to an external quality control stage.

In the context of the encapsulated mRNA particle example provided above, mixing chamber (414, 420, 550, 552) output parameters that may vary include the encapsulated mRNA particle size and/or size distribution. In the event that the particle size and/or size distribution of encapsulated mRNA from a mixing chamber (414, 420, 550, 552) deviates beyond tolerance, such deviation may indicate in excessive build-up of material on the walls of the mixing chamber (414, 420, 550, 552) and/or other undesirable conditions. Moreover, an intolerable encapsulated mRNA particle size and/or size distribution may render such encapsulated mRNA particles unusable in therapy, such that it may be desirable to immediately cease output from any mixing chambers (414, 420, 550, 552) that are outputting encapsulated mRNA particles whose particle size and/or size distribution deviates beyond tolerance.

One method that may be used to measure the size and/or size distribution of particles (e.g., encapsulated mRNA particles, etc.) is dynamic light scattering (DLS). DLS includes projecting light into a liquid containing particles, where the particles in the liquid scatter the light. An optical sensor is used to sense the patterns of light scattered by the particles. This scattering pattern changes over time as the particles disperse in the liquid through Brownian motion. Due to the Brownian motion, the particles may initially be highly correlated; then eventually transition to an uncorrelated state. Autocorrelation may be used to track changes in the scattering pattern over time. With the autocorrelation function being plotted over time, the resulting curve may be analyzed to determine particle diffusion, which may be used to determine particle size and/or size distribution. In some scenarios, the shape of the autocorrelation function curve may indicate whether an encapsulation process performed through one or more mixing chambers (414, 420, 550, 552) has been successful (i.e., within tolerance).

The following examples show how DLS may be incorporated into a process chip (111, 200, 500). While these examples are provided in the context of encapsulated mRNA particles, the same teachings may be readily applied to other contexts where some other kind of particle is being generated through a process chip (111, 200, 500). Similarly, while the examples are provided in the context of outputs from mixing chambers, the same teachings may be readily applied to outputs from other kinds of stages in a process chip (111, 200, 500). The following teachings are therefore not necessarily limited to encapsulated mRNA particles or outputs from mixing chambers.

### A. Example of Process Chip Configuration for Dynamic Light Scattering

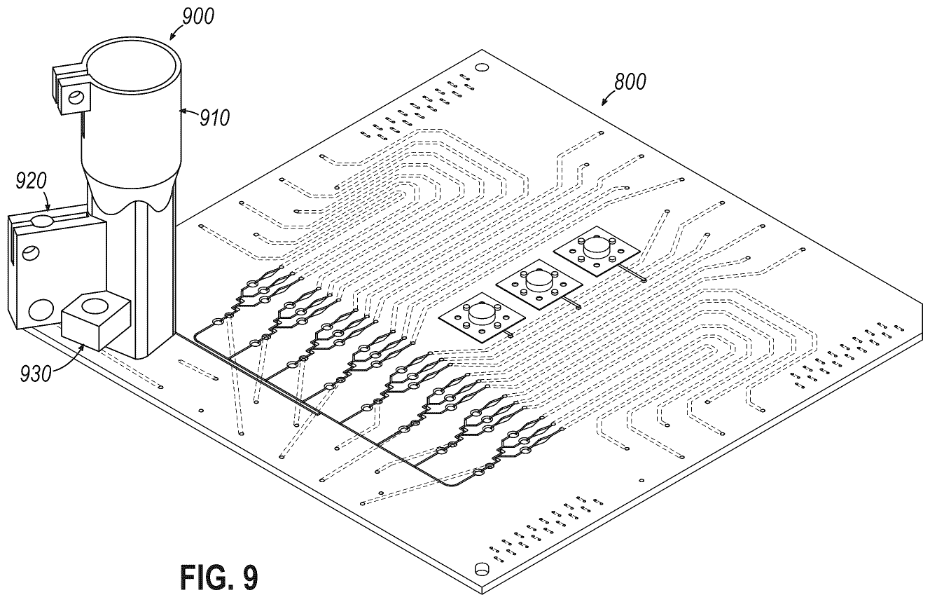

FIGS. 9-11 show an example of a process chip (800) and a body (900). Process chip (800) of this example may be used to generate encapsulated mRNA particles; while body (900) may be coupled with other optical components as described below to provide a dynamic light scattering stage. Process chip (800) of this example has a generally square shape, with body (900) being positioned near a corner of the square shape. Such positioning may minimize encroachment of body (900) over the upper surface (806) of process chip (800), thereby leaving room for other components to be positioned over the upper surface (806) of process chip (800); and preventing body (900) from substantially obscuring regions of process chip (800) that may need to be visually observed by sensors (105, 160) or camera (702), etc. Except as otherwise described below, process chip (800) may be configured and operable like process chips (111, 200, 500) described above.

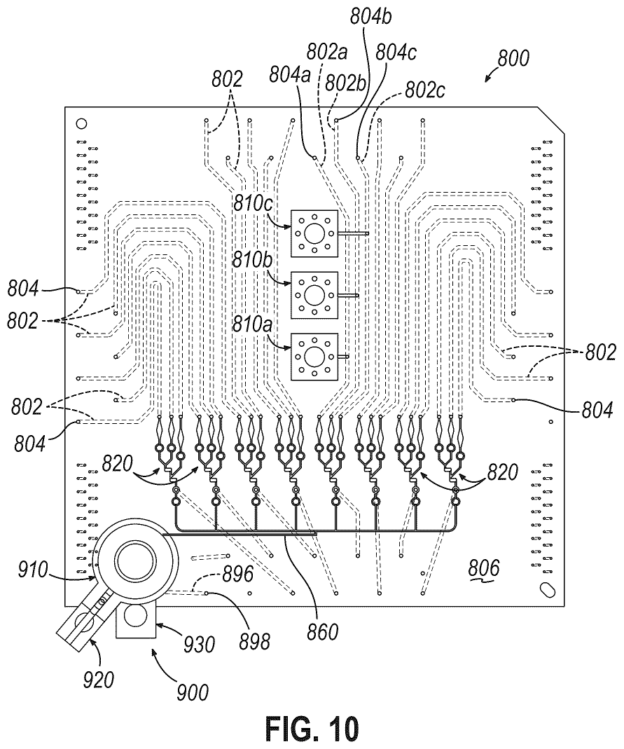

As best seen in FIG. 10, process chip (800) of this example includes a plurality of fluid channels (802). Each fluid channel (802) has a respective fluid input port (804), such that fluid may be communicated to fluid channels (802) via corresponding fluid input ports (804). Some fluid input ports (804) may receive fluid from corresponding vials in reagent storage frame (107). In addition, or in the alternative, some fluid input ports (804) may receive fluid from corresponding fluid outputs of another process chip (111, 200, 500). Alternatively, fluid input ports (804) may receive fluid from any other suitable sources.

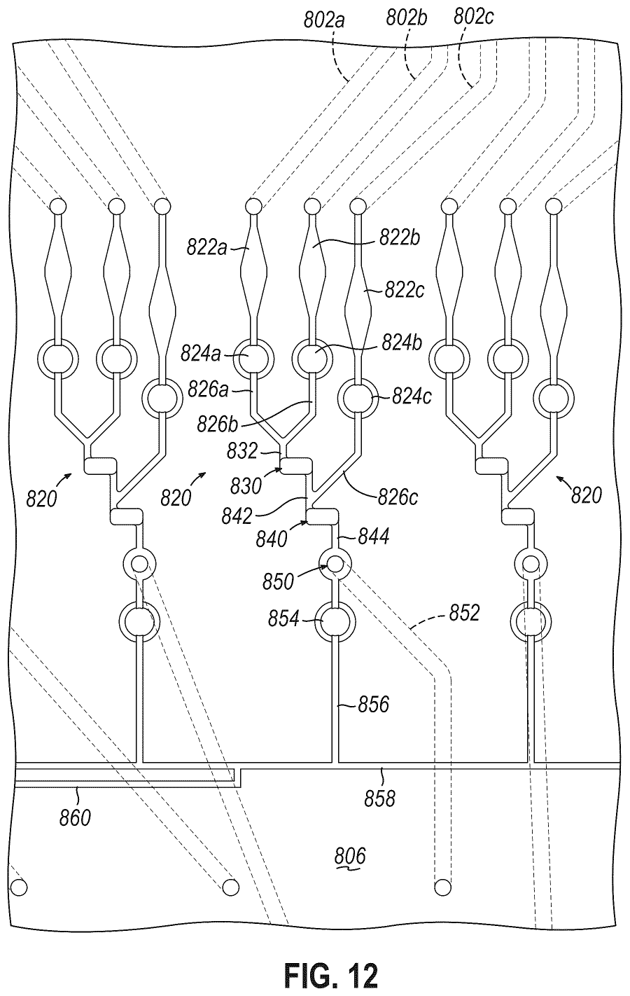

Fluid channels (802) lead to several mixing assemblies (820) that are integrated into process chip (800). In some versions, all mixing assemblies (820) on a process chip (800) have the same kinds of fluid inputs and are intended to all generate the same kind of fluid output. As best seen in FIG. 12, each mixing assembly (820) includes a set of vacuum caps (822), a set of inlet valves (824), and a set of mixing chambers (830, 840). Referring to one mixing assembly (820) as being representative of the other mixing assemblies (820), mixing assembly (820) includes a first vacuum cap (822a), which receives fluid from a first fluid channel (802a); a second vacuum cap (822b), which receives fluid from a second fluid channel (802b); and a third vacuum cap (822c), which receives fluid from a third fluid channel (802c). Each fluid channel (802a, 802b, 802c) receives fluid via a respective fluid input port (804a, 804b, 804c). A first valve (824a) meters the flow of fluid from first vacuum cap (822a) into a first channel (826a) leading toward first mixing chamber (830). A second valve (824b) meters the flow of fluid from second vacuum cap (822b) into an inlet channel (826b) leading toward first mixing chamber (830). Channels (826a, 826b) converge to form an inlet channel (832) leading into first mixing chamber (830). The fluids from channels (826a, 826b) are thus mixed together within first mixing chamber (830).

A third valve (824c) meters the flow of fluid from third vacuum cap (822c) into a third channel (826c) leading toward second mixing chamber (840). An outlet channel (834) from first mixing chamber (830) converges with third channel (826c) to form an inlet channel (842) leading into second mixing chamber (840). The fluids from channels (834, 826c) are thus mixed together within second mixing chamber (840). The fluid mixed in second mixing chamber (840) is output through an outlet channel (844).

In some versions where mixing assemblies are used to provide encapsulated mRNA, a combination of mRNA and water may be communicated through first fluid channel (802a) and a delivery vehicle molecule or molecules in ethanol may be communicated through second fluid channel (802b). In such versions, the mRNA and delivery vehicle molecules may thus be combined for encapsulation in first mixing chamber (830). A dilution agent (e.g., a citrate-based buffer solution, etc.) may be communicated through third fluid channel (802c). In such versions, second mixing chamber (840) may thus be used to provide pH adjustment. In some variations, the mRNA and water are combined in another mixing chamber (not shown) that is upstream of first fluid channel (802a). Similarly, the delivery vehicle molecules and ethanol may be combined in another mixing chamber (not shown) that is upstream of second fluid channel (802b).

An additional channel (852) is fluidically coupled with outlet channel (844) via an opening (850). Channel (852) leads to a fluid outlet port (853), which may be fluidically coupled with a collection vial in reagent storage frame (107) (e.g., for storage, etc.), with another process chip (111, 200, 500, 800) (e.g., for further processing, etc.), or with anything else. Another valve (854) is positioned downstream of outlet channel (844) and opening (850); and upstream of manifold inlet channel (856). When valve (854) is in a closed state, fluid from outlet channel (844) may flow only through opening (850) and channel (852), such that fluid from outlet channel (844) will ultimately be communicated out through fluid outlet port (853). When valve (854) is in an open state, at least some of fluid from outlet channel (844) may flow through a manifold inlet channel (856). In some variations, another valve (not shown) is placed in channel (852). In such versions, this other valve may be transitioned to a closed state when valve (854) is in an open state, to ensure that fluid from outlet channel (844) only flows through manifold inlet channel (856) and not through channel (852). Thus, fluid from outlet channel (844) may not exit via fluid outlet port (853) when the valve in channel (852) is in the closed state. This other valve in channel (852) may be transitioned to an open state when valve (854) is in a closed state.

The manifold inlet channels (856) of all mixing assemblies (820) are all fluidically coupled with a shared manifold channel (858), which ultimately leads to a manifold outlet channel (860). Channels (856, 858, 860) thus cooperate to form a manifold. In the present example, valves (854) may be operated such that fluid from only one manifold inlet channel (856) is being communicated to channels (858, 860) at any given time. In other words, during some modes of operation of process chip (800), only one valve (854) is in an open state at any given moment in time while the other valves (854) are in a closed state. This may ensure that the output of only one mixing assembly (820) is being subject to DLS testing (as described in greater detail below) at any given time. In some scenarios, all valves (854) may be in a closed state during certain periods of time.

Referring back to FIG. 10, process chip (800) of this example includes three pressure sensing regions (810). A first pressure sensing region (810a) is fluidically coupled with first fluid channel (802a), such that first pressure sensing region (810a) may detect the pressure of fluid within first fluid channel (802a). A second pressure sensing region (810b) is fluidically coupled with second fluid channel (802b), such that second pressure sensing region (810b) may detect the pressure of fluid within second fluid channel (802b). A third pressure sensing region (810c) is fluidically coupled with third fluid channel (802c), such that third pressure sensing region (810c) may detect the pressure of fluid within third fluid channel (802c). Pressure sensing regions (810) may be part of pressure sensing stages that are configured and operable like pressure sensing stage (700) described above. While FIG. 10 shows a set of pressure sensing regions (810) being coupled with only one mixing assembly (820), other versions may be configured with the same arrangement of pressure sensing regions (810) for each and every mixing assembly (820).

As will be described in greater detail below, pressure sensing stages at pressure sensing regions (810) may provide pressure data associated with fluid inlets into mixing assemblies (820), which may be used to determine fluid flow rates through mixing assemblies (820). Such flow rates may be correlated with particle size and/or size distribution data from a DLS stage to determine whether a mixing assembly (820) is operating within tolerable parameters. In other words, when DLS data indicates that the encapsulated mRNA particle size and/or size distribution deviates beyond tolerance, data from pressure sensing stages at pressure sensing regions (810) may provide further indication of where a corresponding failure is occurring within process chip (800).

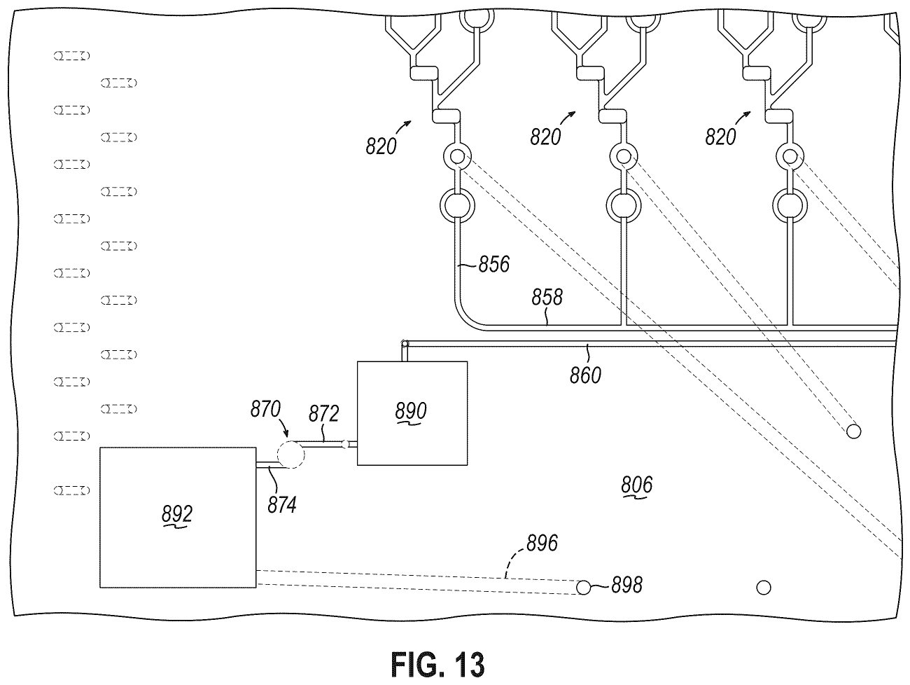

FIGS. 13-15 show components of a DLS stage that are integrated into process chip (800). As shown, manifold outlet channel (860) from mixing assemblies (820) leads toward a DLS chamber (870). In the present example, fluid from manifold outlet channel (860) passes through a pre-DLS stage (890) before reaching an inlet channel (872) of DLS chamber (870). In some versions, pre-DLS stage (890) includes a dilution stage that dilutes the fluid before the fluid reaches DLS chamber (870). Such a dilution stage may be configured and operable in any suitable fashion. In addition, or in the alternative, pre-DLS stage (890) may take any other suitable form and may provide any other suitable functionality (e.g., ventilation, etc.). In some versions, pre-DLS stage (890) is omitted.

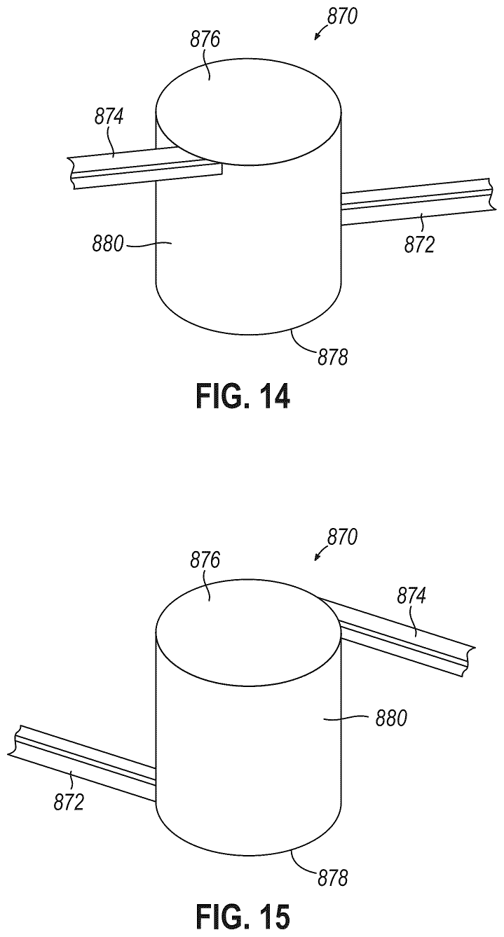

As best seen in FIGS. 14-15, DLS chamber (870) of the present example includes a circular upper wall (876), a circular lower wall (878), and a cylindrical sidewall (880) extending between walls (876, 878). Walls (876, 878) and sidewall (880) cooperate to define a hollow interior. Inlet channel (872) provides a fluid entry into the hollow interior of DLS chamber through sidewall (880), near circular lower wall (878). Outlet channel (874) provide a fluid exit from the hollow interior of DLS chamber through sidewall (880), near circular upper wall (876). Viewed from an end of DLS chamber (870), channels (872, 874) are oriented generally tangentially relative to sidewall (880); and are angularly spaced apart from each other by approximately 180 degrees. The cylindraceous configuration of DLS chamber (870), along with the vertical positioning and tangential orientation of channels (872, 874) may provide a sweeping flow of fluid through the interior of DLS chamber (870), which may assist in clearing bubbles from DLS chamber (870) that might otherwise adversely impact the DLS process. In some scenarios, this flow is substantially stopped in DLS chamber (870) during a DLS process.

While DLS chamber (870) has a cylindraceous configuration in the present example (e.g., with a circular cross-sectional shape), DLS chamber (870) may alternatively have any other suitable configuration. For instance, DLS chamber (870) may have an elliptical cross-sectional shape (viewed from the top down), a vesica piscis cross-sectional shape (viewed from the top down), or any other suitable cross-sectional shape, instead of a circular cross-sectional shape as shown. Similarly, while channels (872, 874) are shown as having a generally rectangular cross-sectional shape, channels (872, 874) may have any other suitable cross-sectional shapes. By way of example only, some versions of channels (872, 874) may taper along the vertical dimension and/or along the horizontal dimension. In some such versions, the wider end of the taper may be at DLS chamber (870), with the narrower end of the taper being further away from DLS chamber (870). Such tapers may be linear and/or curved.

As described in greater detail below, the DLS process includes projecting light into DLS chamber (870) such that the light will scatter off of particles that are in the fluid in DLS chamber (870). The scattered light is detected and processed to establish an autocorrelation curve. In the present example, the projected light and the scattered light pass through the region of process chip (800) above DLS chamber (870). Thus, at least this region of process chip (800) includes an optically transmissive material (e.g., glass, plastic, silicone, and/or any other suitable material(s)). Such material may allow the projected and scattered light to pass through the region between upper surface (806) of process chip (800) and DLS chamber (870) without such material causing additional scattering of the light (which might otherwise adversely affect the accuracy of the DLS readings).

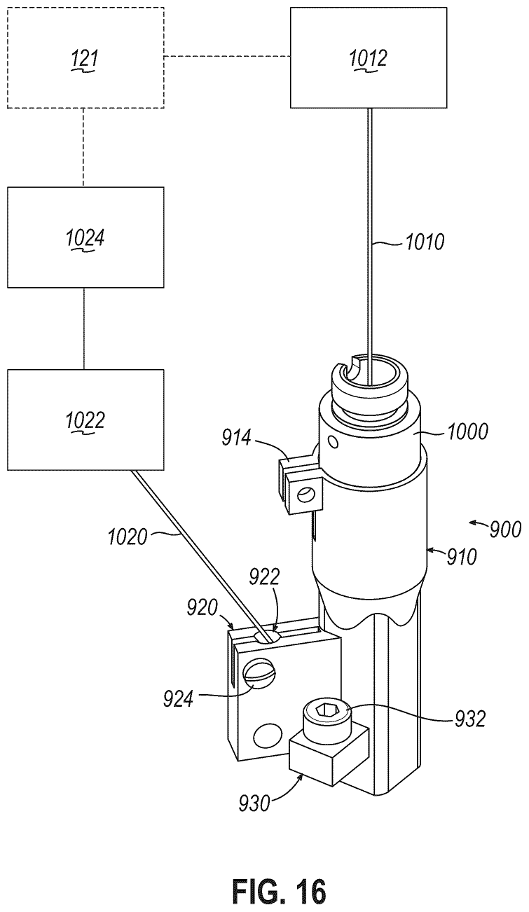

In addition, the region of process chip (800) that is at or under circular lower wall (878) and/or other regions of process chip (800) may include a light absorbing material. For instance, such material may be applied on the region of lower surface (808) of process chip (800); or somewhere between lower surface (808) and circular lower wall (878) of DLS chamber (870). Such light absorbing material may prevent or minimize intrusion of ambient light into DLS chamber (870) that might otherwise occur. In some versions, circular lower wall (878) and sidewall (880) are coated with an opaque material that does not scatter light. As another variation, the material at or under circular lower wall (878) and/or other regions of process chip (800) may be oriented or otherwise configured to directionally reflect light away from a sensing optical fiber (1020) (FIG. 16) in body (900). For instance, a wedge-shaped piece of smoked glass, etc., may be positioned at or under circular lower wall (878) and/or other regions of process chip (800).

Process chip (800) of the present example further includes a post-DLS stage (892) that is fluidically coupled with outlet channel (874) of DLS chamber (870). In some versions, post-DLS stage (892) is used in combination with pre-DLS stage (890) to purge bubbles from fluid that will be tested in DLS chamber (870). For instance, the fluid may be pumped back and forth between stages (890, 892) before being allowed to rest in DLS chamber (870) for the DLS process. In addition, or in the alternative, post-DLS stage (892) may take any other suitable form and may provide any other suitable functionality (e.g., ventilation, etc.). In some versions, post-DLS stage (892) is omitted. An outlet channel (896) is fluidically coupled with post-DLS stage (892) and leads to an output port (898). Fluid that has passed through DLS chamber (870) may thus eventually be communicated out from process chip (800) via outlet channel (896) and output port (898). In versions where post-DLS stage (892) is omitted, outlet channel (874) of DLS chamber (870) may be directly fluidically coupled with output port (898).

In some versions, fluid from output port (898) is communicated to a waste storage compartment. Such a waste storage compartment may be located in another process chip (111, 200, 500), in reagent storage frame (107), or elsewhere. In some other versions, fluid from output port (898) is further processed to form a therapeutic composition. Such further processing may include communicating the fluid to another process chip (111, 200, 500, 800), to a vial in reagent storage frame (107), or elsewhere. As another option, fluid from output port (898) may be used in some other quality control testing (e.g., on another process chip (111, 200, 500, 800) or elsewhere). Alternatively, fluid from output port (898) may be handled in any other suitable fashion.

### B. Example of Optical Components for Dynamic Light Scattering

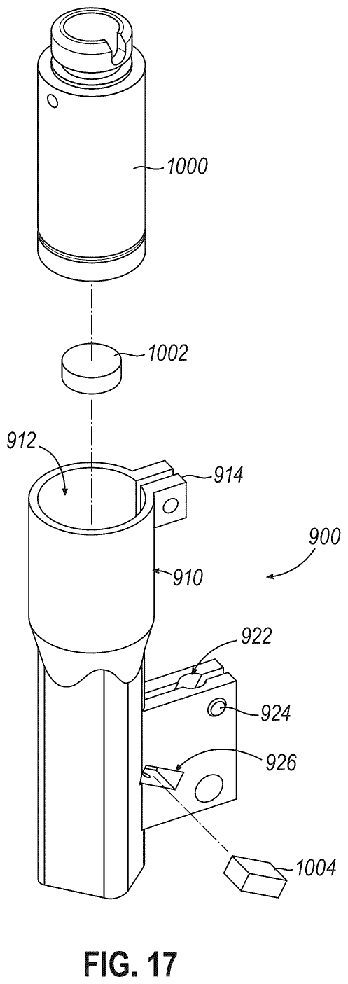

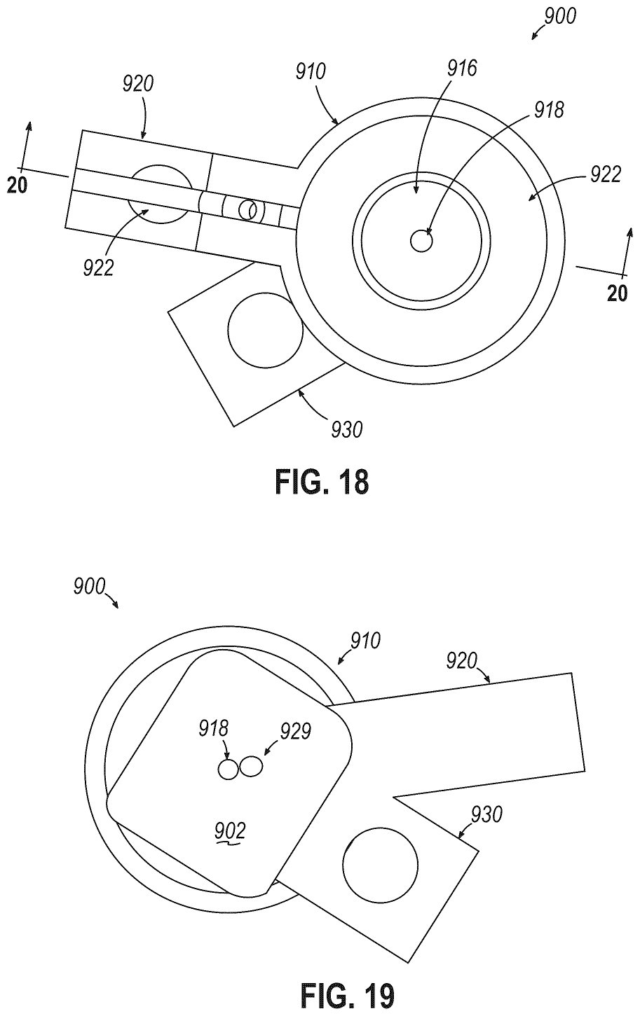

FIGS. 16-20 show body (900) in greater detail. Body (900) of the present example includes an elongate vertical portion (910), a transverse portion (920), and a mounting flange (930). Vertical portion (910) defines an upper channel (912), a lens seating region (915) positioned beneath upper channel (912), and a closed focusing volume (916) positioned beneath lens seating region (915). As shown in FIGS. 16-17, upper channel (912) is sized to receive a collimator (1000); while lens seating region (915) is sized to receive a focusing lens (1002). A clamping flange (914) extends transversely from vertical portion (910). When a collimator (1000) is inserted into upper channel (912), a screw or other component may be secured to clamping flange (914), such that vertical portion (910) may thereby grip collimator (1000) and securely retain collimator (1000) in upper channel (912). Alternatively, collimator (1000) may be retained in any other suitable fashion. Focusing lens (1002) is captured between collimator (1000) and closed focusing volume (916). Closed focusing volume (916) defines a cone-shaped optical path that tapers toward an opening (918) formed through the lower surface (902) of body (900). In the present example, the sidewall (917) of closed focusing volume (916) includes a light absorbing material. As described in greater detail below, vertical portion (910) provides projection of light through opening (918) along a first axis (A₁).

Transverse portion (920) extends transversely from vertical portion (910). Transverse portion (920) defines an upper channel (922) and a lower channel (928), with a filter slot (926) interrupting lower channel (928). As shown in FIG. 16, upper channel (922) is sized to receive a sensing optical fiber (1020). In some versions, sensing optical fiber (1020) is a multimode fiber. In some such versions, sensing optical fiber (1020) has a core diameter ranging from approximately 50 μm to approximately 400 μm; or of approximately 50 μm. In some other versions, sensing optical fiber (1020) is a single mode fiber. In some such versions, sensing optical fiber (1020) has a core diameter ranging from approximately 2 μm to approximately 11 μm; or of approximately 5 μm.

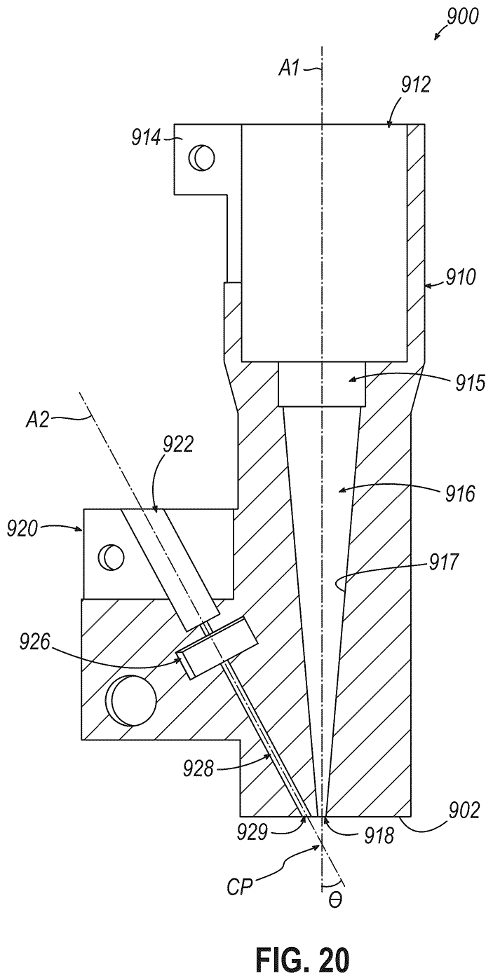

When sensing optical fiber (1020) is inserted into upper channel (922), a screw (924) may be inserted into transverse portion (920) and tightened, such that transverse portion (920) may thereby secure sensing optical fiber (1020) and securely retain sensing optical fiber (1020) in upper channel (922). In the present example, a ferrule (not shown) is positioned about the region of sensing optical fiber (1020) that is inserted into transverse portion (920), such that transverse portion (920) effectively grips sensing optical fiber (1020) via the ferrule. Alternatively, sensing optical fiber (1020) may be retained in any other suitable fashion. Lower channel (928) defines a cylindrical optical path that leads to an opening (929) formed through the lower surface (902) of body (900). In the present example, lower channel (928) includes a light absorbing material. As described in greater detail below, transverse portion (920) provides communication of light received through opening (929) along a second axis (A₂). As best seen in FIGS. 19-20, openings (918, 929) are spaced apart from each other in the present example, such that openings (918, 929) do not overlap with each other.

As shown in FIG. 17, an optical filter (1004) may be inserted in filter slot (926). Optical filter (1004) may thus filter light received through opening (929) and lower channel (928) before such light is further communicated to sensing optical fiber (1020) in upper channel (922). As part of this filtering, optical filter (1004) may assist in removing wavelengths of light associated with ambient lighting. Optical filter (1004) may thus be tuned to match (or otherwise accommodate) the wavelength of light that is emitted through the source optical fiber (1010) (i.e., the incident light) as described in greater detail below. In some variations, optical filter (1004) may also be used to detect fluorescence (e.g., by filtering out the wavelength of the source light). Various suitable forms and configurations that may be used for optical filter (1004) will be apparent to those skilled in the art in view of the teachings herein.

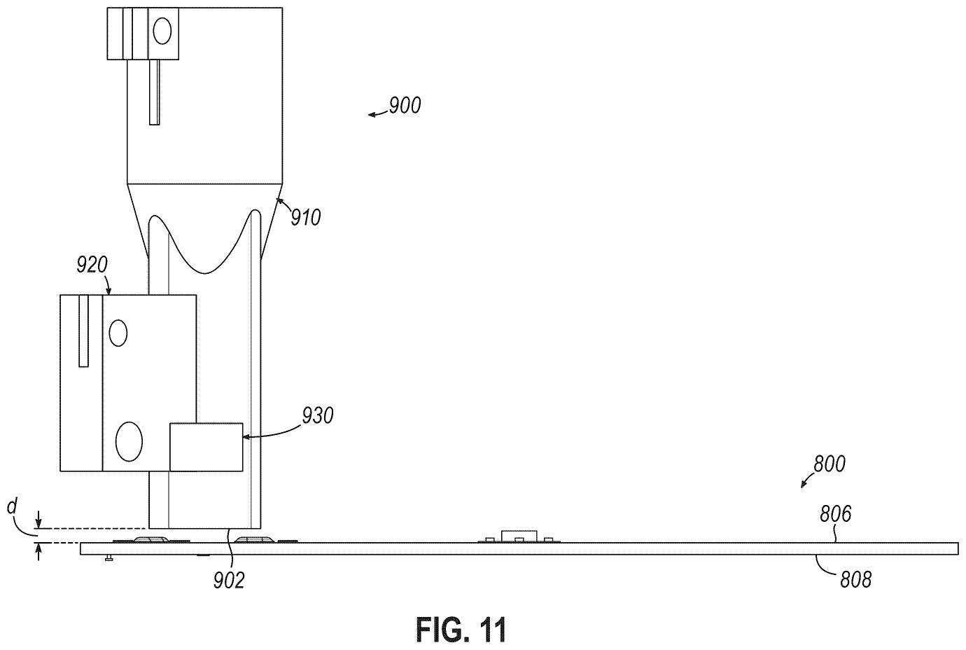

Mounting flange (930) extends transversely from vertical portion (910), adjacent to transverse portion (920). Mounting flange (930) is configured to receive a screw (930) (FIG. 16) and thereby secure body (900) to a fixture (e.g., seating mount (154) of base (180)), such that body (900) may be fixedly secured relative to base (180). In other words, body (900) is not secured to process chip (800) in the present example. Instead, as shown in FIG. 11, body (900) may be secured via mounting flange (930) such that lower surface (902) of body (900) is parallel with upper surface (806) of process chip (800); and such that lower surface (902) is separated from upper surface (806) by a gap distance (d). By way of example only, this gap distance (d) may range from approximately 0 mm to approximately 0.5 mm; or may be approximately 0 mm. Alternatively, any other suitable gap distance (d) may be used. In versions where gap distance (d) is 0 mm, such that lower surface (902) of body (900) contacts upper surface (806) of process chip (800), one or both of lower surface (902) or upper surface (806) may include complementary surface features (e.g., protrusions and/or recesses) that assist in properly registering the position of body (900) with respect to process chip (800).

When body (900) is secured at the gap distance (d) from upper surface (806) if process chip (800), axes (A₁, A₂) converge at a convergence point (CP) that is located within DLS chamber (870). The position of the convergence point (CP) may be dictated by the angle (O) formed by axes (A₁, A₂). By way of further example only, the angle (e) formed by axes (A₁, A₂) may range from approximately 10 degrees to approximately 90 degrees; or range from approximately 10 degrees to approximately 45 degrees; or be approximately 28.8 degrees. By way of further example only, the convergence point (CP) may be positioned away from lower surface (902) by a distance ranging from approximately 1 mm to approximately 5 mm; or at approximately 1.2 mm.

As shown in FIG. 16, one end of a source optical fiber (1010) may be coupled with collimator (1000). The other end of source optical fiber (1010) may be coupled with a coherent light source (1012). By way of example only, light source (1012) may include a single-frequency laser that is operable to emit light at a wavelength at which process chip (800) is optically transmissive. Light source (1012) may be mounted to base (180) or may otherwise be integrated into system (100). In some versions, light source (1012) is in communication with controller (121). For instance, controller (121) may be operable to selectively activate light source (121) and tune the intensity of light generated by light source (121). In addition, or in the alternative, controller (121) may receive feedback relating to the operation of light source (121). In some other versions, light source (121) is controlled and/or monitored independently of controller (121). In the present example, the light generated by light source (1012) is communicated along source optical fiber (1010) to collimator (1000). To the extent that collimated light presents safety concerns with respect to human operators, it may be beneficial to have collimator (1000) positioned in body (900) where the collimated light will not reach the eyes of a human operator. The collimated light from collimator (1000) is further passed through focusing lens (1002), through closed focusing volume (916), and then out through opening (918). The projected light ultimately reaches DLS chamber (970) as noted above.

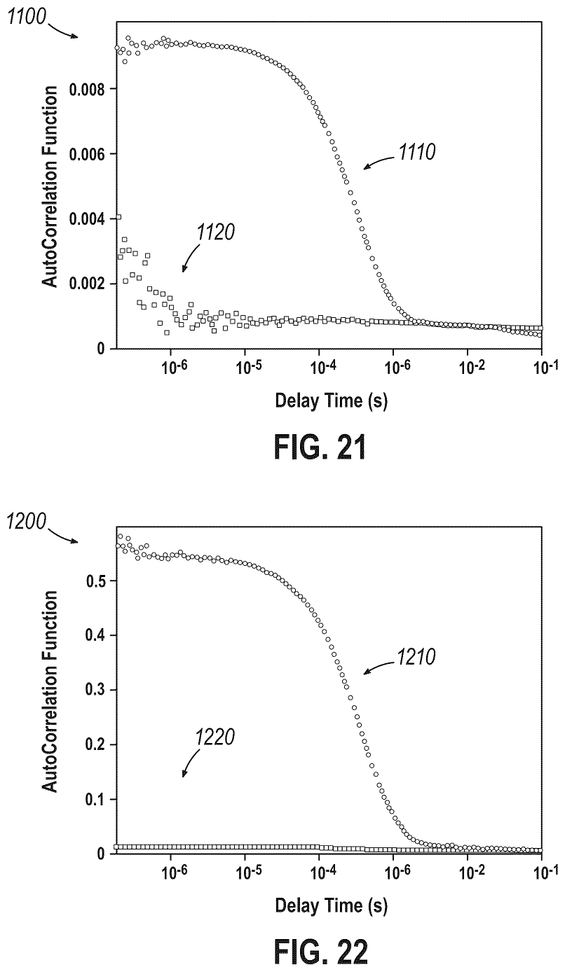

As also shown in FIG. 16, one end of sensing optical fiber (1020) may be secured within upper channel (922) while the other end of sensing optical fiber (1020) may be coupled with a photon counter (1022), which may be further coupled with an autocorrelator (1024). Photon counter (1022) and autocorrelator (1024) may take any suitable form as will be apparent to those skilled in the art in view of the teachings herein. When light projected through opening (918) is scattered from particles in the fluid in DLS chamber (970), the scattered light is communicated through opening (929), lower channel (928), and optical filter (1004), ultimately reaching sensing optical fiber (1020). Sensing optical fiber (1020) further communicates the light to photon counter (1022), which counts the photons and communicates corresponding photon count data to autocorrelator (1024). Autocorrelator (1024) performs an autocorrelation function on this data to generate autocorrelation curves such as those shown in FIGS. 21-22 and described in greater detail below. Autocorrelator (1024) may be further coupled with controller (121), such that controller (121) may process autocorrelation data from autocorrelator (1024) and execute algorithms using at least such data. Examples of processes that may be carried out using at least autocorrelation data will be described in greater detail below. While FIG. 16 depicts autocorrelator (1024) and controller (121) as separate components, some variations of controller (121) may directly integrate an autocorrelating module or otherwise provide autocorrelating functionality. In other words, some versions may not have autocorrelator (1024) and controller (121) as separate components.

FIG. 21 depicts a graph (1100) plotting examples of autocorrelation curves (1110, 1120) that may be developed using a DLS stage as described above. In the example depicted in FIG. 21, autocorrelation curve (1110) represents data acquired using a multimode fiber for sensing optical fiber (1020) detecting DLS in a fluid containing light-scattering beads. Autocorrelation curve (1120) represents data acquired using a multimode fiber for sensing optical fiber (1020) detecting DLS in water (i.e., as a control). In this example, autocorrelation curve (1110) has a y-intercept at approximately 0.009. To the extent that the autocorrelation curve (1110) is somewhat erratic or noisy during the very early stage of the time period, autocorrelation curve (1110) soon transitions into a relatively smooth curve with very little noise.

FIG. 22 depicts a graph (1200) plotting other examples of autocorrelation curves (1210, 1220) that may be developed using a DLS stage as described above. In the example depicted in FIG. 22, autocorrelation curve (1210) represents data acquired using a single mode fiber for sensing optical fiber (1020) detecting DLS in a fluid containing light-scattering beads. Autocorrelation curve (1220) represents data acquired using a multimode fiber for sensing optical fiber (1020) detecting DLS in a fluid containing light-scattering beads. In other words, autocorrelation curve (1220) in FIG. 22 is analogous to autocorrelation curve (1110) in FIG. 21. In this example, autocorrelation curve (1220) has a y-intercept at approximately 0.55, which is much higher than the y-intercept for autocorrelation curve (1110, 1220). To the extent that the autocorrelation curve (1220) is somewhat erratic or noisy during the very early stage of the time period, autocorrelation curve (1220) soon transitions into a relatively smooth curve with very little noise.

In view of graphs (1100, 1200) shown in FIGS. 21-22, using a multimode fiber for sensing optical fiber (1020) or using a single mode fiber for sensing optical fiber (1020) may produce acceptable results. To the extent that a single mode fiber may produce a substantially higher y-intercept in its autocorrelation curve (1210), a multimode fiber may still yield a useful and reliable autocorrelation curve (1110).

### C. Example of Method of Using Dynamic Light Scattering Stage

In a method of operating process chip (800), various fluid components may be communicated through fluid input ports (804) and fluid channels (802) to reach mixing assemblies (820). Such fluid components may include mRNA, surfactants, pH regulating buffers, ethanol, water, and/or other components. The output of each mixing assembly (820) may include encapsulated mRNA particles. Valves (854) may be operated to sequentially direct the output of each mixing assembly (820) toward the DLS stage via channels (858, 860). When a sample volume of a fluid output of one mixing assembly (820) reaches DLS chamber (870), light from light source (1012) may be emitted into DLS chamber (870) via source optical fiber (1010) and associated components of body (900). In some versions, the flow of fluid in DLS chamber (870) is stopped during the DLS process, such that light from light source (1012) is emitted into DLS chamber (870) once the fluid in DLS chamber (870) has achieved a substantially static state. In some other versions, light from light source (1012) is emitted into DLS chamber (870) while the fluid in DLS chamber (870) is in a flowing state.

Regardless of whether the fluid in DLS chamber (870) is static or flowing when light from light source (1012) is emitted into DLS chamber (870), the light may be scattered by particles in the sample volume in DLS chamber (870). This scattered light may be communicated through sensing optical fiber (1020) and associated components of body (900), ultimately reaching photon counter (1022). Autocorrelator (1024) may process the corresponding data from photon counter (1022) and generate an autocorrelation curve, similar to what is shown in FIGS. 21-22. The autocorrelation curve may be compared against a baseline curve to determine whether the autocorrelation curve is within tolerance. In some versions, this comparison is executed by controller (121). The determination of whether an autocorrelation curve is within tolerance may include determining whether the y-intercept of the curve is at an appropriate level, whether the curve follows a path that is within a tolerable deviation from the path of the baseline curve, how well the curve fits in a certain model (e.g., cumulant, etc.), whether the curve descends to a value close to zero, the autocorrelation time when the transition occurs, and/or whether the autocorrelation curve meets other criteria.

If the autocorrelation curve is within tolerance, then this may indicate that the size and/or size distribution of the particles (e.g., encapsulated mRNA particles, etc.) in DLS chamber (870) is appropriate; and that the mixing assembly (820) that generated the sample volume in DLS chamber (870) is operating properly. Process chip (800) may then continue delivering the output of that mixing assembly (820) to a subsequent stage (e.g., a storage vial in reagent storage frame (107), another process chip (111, 200, 500), etc.). If the autocorrelation curve is outside tolerance, then this may indicate that the size and/or size distribution of the of the particles (e.g., encapsulated mRNA particles, etc.) in DLS chamber (870) is inappropriate; and that the mixing assembly (820) that generated the sample volume in DLS chamber (870) is operating improperly.

If a mixing assembly (820) fails at the DLS stage (i.e., the DLS data indicates that the particle size and/or size distribution from the output of the mixing assembly (820) is outside of tolerance), that mixing assembly (820) may be effectively shut down. A mixing assembly (820) may be effectively shut down by not having any additional fluids communicated through the fluid input ports (804) upstream of that mixing assembly (820). In addition, no fluid will be communicated from the fluid output port (853) downstream of a mixing assembly (820) that has been effectively shut down. In some versions, controller (121) executes an algorithm to ensure that no additional fluids are communicated through the fluid input ports (804) upstream of a mixing assembly (820) that fails at the DLS stage, by automatically preventing communication of fluid from whichever fluid source (e.g., vials in reagent storage frame (107), outputs of another process chip (111, 200, 500), etc.) would otherwise provide fluid to such fluid input ports (804).

Each DLS measurement process may be performed for any suitable duration. For instance, in some versions, from the time a sample volume of fluid reaches DLS chamber (870), the process of emitting light into the fluid and collecting scattered light may be performed for a duration ranging from approximately 1 second to approximately 60 seconds; or the duration may be approximately 10 seconds. After the DLS has been performed on the sample volume of fluid, that sample volume of fluid may be handled in any suitable fashion. For instance, if the DLS indicates that the size and/or size distribution of particles in the fluid are appropriate, the sample volume may be further communicated to a vial in reagent storage frame (107), to another process chip (111, 200, 500) for further processing, to a waste reservoir, or elsewhere. If the DLS indicates that the size and/or size distribution of particles in the fluid are inappropriate, the sample volume may be further communicated to a waste reservoir or elsewhere. In some versions, DLS measurements may be performed several times (e.g., iterations ranging from 1 time to 20 times; or more specifically 10 time). Such repeated measurements may be used to gather statistics, capture time-varying conditions, etc.

Regardless of whether the output of a mixing assembly (820) has yielded acceptable or unacceptable particle sizes and/or size distribution, process chip (800) may operate valves (854) to communicate the output of the next mixing assembly (820) to the DLS stage after the output of the first mixing assembly (820) has been analyzed in the DLS stage. This sequence may continue until the output of each mixing assembly (820) has been analyzed in the DLS stage. Once the output of the last mixing assembly (820) has been analyzed in the DLS stage, the process may start over with the first mixing assembly (820) and continue through the sequence throughout the duration of operation of process chip (800). In the event that any mixing assemblies (820) have been shut down due to their output failing at the DLS stage, such mixing assemblies (820) may be passed over as process chip (800) reiterates the sequence of testing mixing assembly (820) outputs in the DLS stage.

In some instances, it may be desirable to provide some kind of spacer or purging fluid through the DLS stage in between outputs of mixing assemblies (820). For instance, an air bubble may be communicated through DLS chamber (870) in between the outputs of mixing assemblies (820). In addition, or in the alternative, a predetermined water or some other liquid may be communicated through DLS chamber (870) in between the outputs of mixing assemblies (820). In either case, the air, water, or other fluid may assist in purging any particles that may otherwise remain in DLS chamber (870) before the output of the next mixing assembly (820) reaches DLS chamber (870).

In versions where process chip (800) includes pressure sensing regions (810) that are parts of pressure sensing stages that are configured and operable like pressure sensing stage (700) described above, such pressure sensing stages may be used in combination with a DLS stage in numerous ways. In some versions, controller (121) initially only monitors pressure data from the pressure sensing stages, without activating the DLS stage until the pressure data indicates that the pressure level of one or more fluid channels (802) is outside of tolerance. For instance, if a pressure level of a fluid channel (802) exceeds a predetermined threshold, this elevated pressure level may indicate that an obstruction is forming (or has formed) in a mixing assembly (820) that is being fed by fluid channel (802). If this occurs, controller (121) may open a valve (854) downstream of that mixing assembly (820) to direct the output from that mixing assembly (820) to the DLS stage for testing. Once the output from that mixing assembly (820) reaches the DLS chamber (870), the DLS stage may be used to determine whether the size and/or size distribution of the particles from that mixing assembly (820) are appropriate. If they are, the DLS stage may be used to continue monitoring the output of that mixing assembly (820) to determine if and when the particle size and/or size distribution falls outside of tolerance (at which point the mixing assembly (820) may be effectively shut down).

In some other versions where process chip (800) includes pressure sensing regions (810) that are parts of pressure sensing stages that are configured and operable like pressure sensing stage (700) described above, controller (121) may observe pressure data in response to the DLS stage detecting particle sizes and/or size distributions that fall outside of tolerance. In other words, if the DLS stage determines that the output from a mixing assembly (820) includes unacceptable particle sizes and/or size distribution, controller (121) may observe the fluid pressures of the fluid channels (802) that serve as inlets to that mixing assembly (820) and determine whether any of those fluid channels (802) have fluid pressures falling outside of tolerance. For instance, if the DLS stage determines that the output from a mixing assembly (820) includes unacceptable particle sizes and/or size distribution, controller (121) may determine that one of the fluid channels (802) feeding that mixing assembly (820) has an unacceptably high fluid pressure; and this may indicate that an obstruction is forming (or has formed) in that mixing assembly (820). That mixing assembly (820) may then be effectively shut down and/or treated (e.g., chemically, etc.) to remove the obstruction, such that only the other mixing assemblies (820) on that process chip (800) are used thereafter (or until the treatment to remove the obstruction is complete). In the event that the DLS stage determines that the output from a mixing assembly (820) includes unacceptable particle sizes and/or size distribution, and there are no abnormalities in the fluid pressures of the fluid channels (802) feeding that mixing assembly (820), then this may indicate that there is some other kind of problem (e.g., chemical composition variations, etc.) and an appropriate remedial action may be taken.

While the foregoing example provides a sequence of DLS measurement followed by fluid pressure measurement (where the fluid pressure measurement is triggered by a certain particle size and/or size distribution measurement), or a sequence of fluid pressure measurement followed by DLS measurement (where the DLS measurement is triggered by a certain fluid pressure measurement), some other variations may provide pressure measurements and DLS measurements in parallel. For instance, controller (121) may continuously monitor the pressure measurements and DLS measurements; and determine that a mixing assembly (820) should be shut down when the combination of pressure measurements and particle size and/or size distribution measurements meet certain criteria.

Regardless of whether and how fluid pressure measurements and DLS measurements are taken in a certain sequence (e.g., pressure measurements first, then DLS measurements; DLS measurements first, followed by fluid pressure measurements; or pressure measurements and DLS measurements in parallel), controller (121) may provide a degree of artificial intelligence in learning from correlations between DLS measurements and fluid pressure measurements. For instance, controller (121) may learn which fluid pressure levels tend correspond with points where the DLS measurements indicate unacceptable particle sizes and/or size distribution; and controller (121) may thereby shut down a mixing assembly (820) in advance, based on fluid pressure values associated with that mixing assembly (820), before that mixing assembly (820) produces unacceptable particle sizes and/or size distribution. In other words, controller (121) may adjust fluid pressure threshold values using at least correlations between sensed fluid pressures and detected unacceptable particle sizes and/or size distributions.

Regardless of whether or how pressure data from pressure sensing regions (810) is correlated with DLS data, pressure data from pressure sensing regions (810) may also be utilized in some versions to vary inputs via fluid input ports (804). For instance, if the pressure data at pressure sensing region (810a) indicates that the pressure of fluid in fluid channel (802a) is above a certain value, then controller (121) may activate pressure source (117) to reduce the pressure of fluid being communicated into fluid input port (804a). Similarly, if the pressure data at pressure sensing region (810a) indicates that the pressure of fluid in fluid channel (802a) is below a certain value, then controller (121) may activate pressure source (117) to increase the pressure of fluid being communicated into fluid input port (804a). The pressure data at pressure sensing region (810b) may be similarly used to track the pressure of fluid in fluid channel (802b); and such pressure data may be used to vary the pressure of fluid being communicated into fluid input port (804b). Likewise, the pressure data at pressure sensing region (810c) may be similarly used to track the pressure of fluid in fluid channel (802c); and such pressure data may be used to vary the pressure of fluid being communicated into fluid input port (804c). Pressure sensing stages at pressure sensing regions (810) may thus be used to provide a feedback loop enabling real-time adjustments to pressures of fluids communicated into fluid input ports (804), to thereby achieve consistency in desired pressure values.

In some scenarios, the pressure data from pressure sensing regions (810) is compared to the pressure of fluid being provided by pressure source (117) to the corresponding fluid channels that are upstream of fluid input ports (804), to determine whether the pressure data from pressure sensing regions (810) acceptably deviates from the pressure in the corresponding fluid channels that are upstream of fluid input ports (804). In this context, some deviation may be expected, such as the fluid pressure in pressure sensing regions (810) being lower than the fluid pressure in corresponding fluid channels that are upstream of fluid input ports (804). Similarly, the pressure data from pressure sensing regions (810) may be compared to the pressure of fluid being provided by pressure source (117) to the corresponding fluid channels that are upstream of fluid input ports (804) to determine the flow rate of fluid flowing through fluid channels (802). Such flow rate data may be particularly useful in scenarios where DLS is performed on fluid that is flowing rather than static. Further examples of DLS being performed on fluid that is flowing are described in greater detail below.

As another example of how pressure sensing stages at pressure sensing regions (810) may be used to provide a feedback loop enabling real-time adjustments to pressures of fluids communicated into fluid input ports (804), the pressure data from the pressure sensing regions (810a, 810b, 810c) associated with a given mixing assembly (820) may be evaluated to ensure that the fluid pressures along channels (802) are appropriately balanced with each other. Similarly, where the pressure data from the pressure sensing regions (810a, 810b, 810c) is compared with pressure data from corresponding fluid channels that are upstream of fluid input ports (804) to determine flow rates through channels (802), the flow rates through channels (802) may be evaluated to ensure that the flow rates through channels (804) are appropriately balanced with each other. In the event that the fluid pressures and/or flow rates in channels (802) are not appropriately balanced with each other, then controller (121) may activate pressure source (117) to increase ore reduce the pressure of fluid being communicated into any fluid input ports (804) where such adjustment is warranted.

The foregoing examples of pressure data being used in a real-time feedback loop refer to pressure adjustments being made via pressure source (117), to increase ore reduce the pressure of fluid being communicated into fluid input ports (804). In some variations, the fluid pressure is generated or otherwise controlled via peristaltic pumping that is performed on process chip (800) (e.g., as described above in the context of process chips (111, 200, 500)). In such variations, controller (121) may adjust the peristaltic pumping action on process chip (800) in response to pressure data from pressure sensing regions (810).

D. Example of Process Chip with Plurality of Dynamic Light Scattering Stages

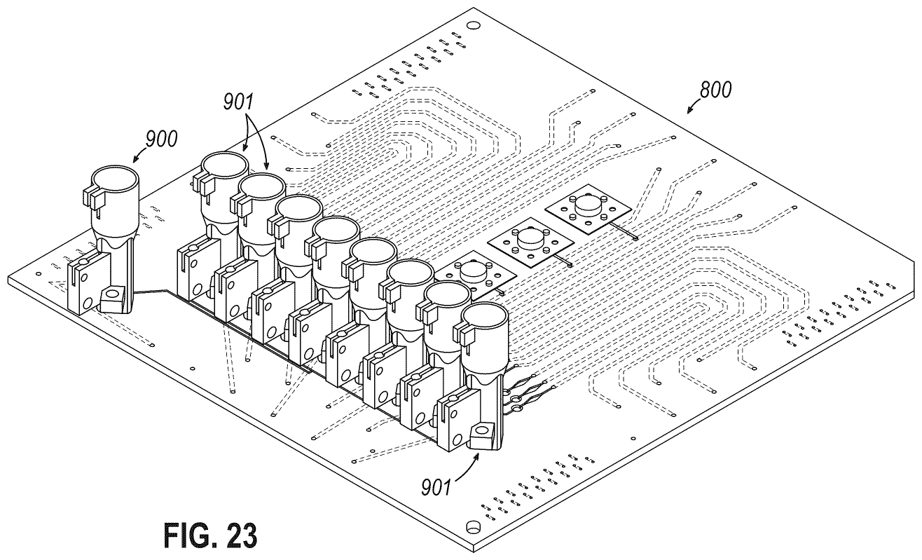

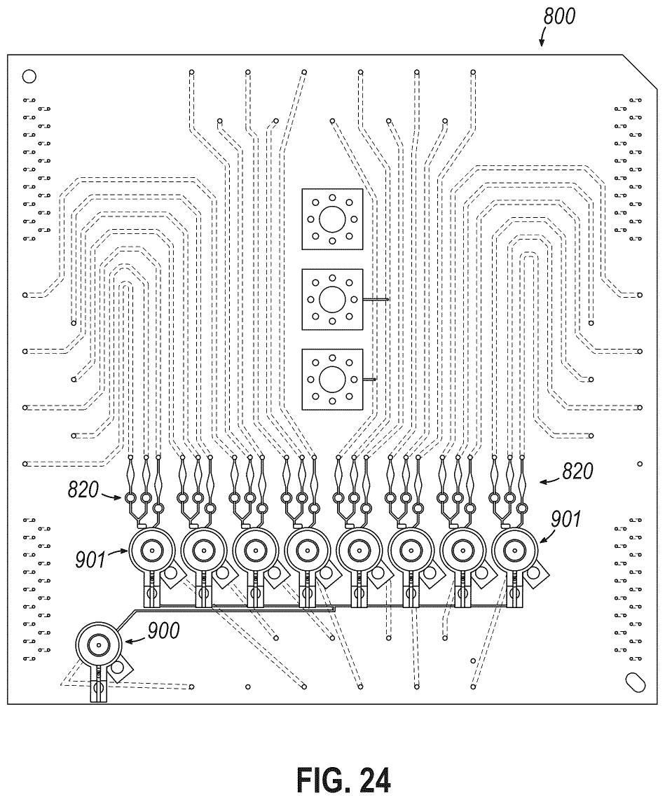

While FIGS. 9-11 show an arrangement where only one DLS stage is used with a process chip (800), it may be desirable to provide arrangements where a process chip (800) includes several DLS stages. FIGS. 23-24 show one example of such an alternative arrangement. In this example, one body (900) is positioned near a corner of process chip (800), similar to the arrangement shown in FIGS. 9-11. However, unlike the arrangement shown in FIGS. 9-11, the arrangement shown in FIGS. 23-24 further includes several additional bodies (901), with each additional body (901) being positioned over a respective mixing assembly (820). These additional bodies (901) may be configured and operable like body (900) described above. In the arrangement shown in FIGS. 23-24, each body (900, 901) may form part of a corresponding DLS stage as described above. Thus, each mixing assembly (820) has an associated DLS stage in the arrangement shown in FIGS. 23-24.

Each body (901) in this example is positioned over a corresponding outlet channel (844) of the mixing assembly (820) associated with the body (901). Thus, each DLS stage associated with each body (901) may be used to measure the size and/or size distribution of particles in the direct output of each mixing assembly (820). In some versions of this arrangement, the DLS stages associated with bodies (901) measure the size and/or size distribution of particles in fluid as the fluid is in a flowing state; while the DLS stage associated with body (900) measures the size and/or size distribution of particles in fluid as the fluid is in a static state. In other words, the DLS stages associated with bodies (901) may be regarded as providing dynamic fluid testing while the DLS stage associated with body (900) may be regarded as providing static fluid testing.

In some versions of the arrangement shown in FIGS. 23-24, the DLS stages associated with bodies (901) measure the size and/or size distribution of particles in fluid on a constant basis (i.e., as the fluid continues to flow through the corresponding outlet channel (844)); while the DLS stage associated with body (900) only measures the size and/or size distribution of particles in fluid on an ad hoc basis. For instance, a sample volume of fluid may be communicated to the DLS stage associated with body (900) only when the fluid pressure data and/or DLS the data (from DLS stages associated with body (901)) indicates that there may be a problem with respect to a particular mixing assembly (820). In such instances, the output of this particular mixing assembly (820) may be sent to the DLS stage associated with body (900) to determine whether the size and/or size distribution of particles generated by the mixing assembly (820) is within tolerance.

As another variation, the DLS stage associated with body (900) may be operated continuously, with the outputs from mixing assemblies (820) being communicated sequentially to that DLS stage, in addition to the DLS stages associated with bodies (901) being operated continuously. In such scenarios, the DLS data from the stage associated with body (900) may be correlated with the DLS data from the stage associated with the body (901) corresponding to the mixing assembly (820) whose output is in DLS chamber (870). For instance, the autocorrelation curves from these DLS stages may be compared to each other; and controller (121) may determine whether deviations between these curves are within a predefined tolerance.

In addition to providing DLS sensing as described above, the foregoing arrangements may also provide laser Doppler velocimetry. Laser Doppler velocimetry may be used to assist in determining flow conditions. As another variation, a tunable electric field may be used to determine Zeta Potentials that indicate particle charge status. Such particle charge data may indicate the extent to which mRNA is present in a particle, as mRNA may have a characteristic charge.

### IV. EXAMPLE OF VISCOSITY SENSING VIA DYNAMIC LIGHT SCATTERING

As described above, it may be desirable to monitor encapsulated mRNA particle size and/or size distribution during a process of forming encapsulated mRNA particles via a process chip (800), as the encapsulated mRNA particle size and/or size distribution may tend to vary as process chip (800) is used to form encapsulated mRNA particles. It may also be desirable to determine and monitor viscosity of the solution carrying the encapsulated mRNA particles, as such viscosity may also tend to vary as process chip (800) is used to form encapsulated mRNA particles, and the initial viscosity of the fluid might not be known. For instance, some solutions may include a combination of mRNA and water (e.g., introduced via fluid channel (802a)), a delivery vehicle molecule or molecules in ethanol (e.g., introduced via fluid channel (802b)), and a dilution agent or buffer (e.g., introduced via fluid channel (802c)). The mixture of ethanol and water may produce a significant change in viscosity and may therefore be very sensitive to ethanol concentration variations.

As described in greater detail below, the viscosity of the solution may be monitored using a DLS stage as described above. Moreover, the same DLS stage that is used to monitor encapsulated mRNA particle size and/or size distribution may also be used to monitor viscosity of the solution carrying the encapsulated mRNA particles.

In some scenarios, it may be important to determine and monitor the viscosity of the solution because variation in viscosity of the solution may tend to produce measurement effects that are comparable to measurement effects that are produced by variations in encapsulated mRNA particle size in the solution. This may be observed via the following equation (I):

$$\frac{d {λ}^{2} vT}{{Tn}^{2} {sin}^{2} \frac{θ}{2}} = \frac{16}{3} π {k}_{B} \qquad ( I )$$

where “d” is the encapsulated mRNA particle diameter,
“λ” is the wavelength of the laser emitted by light source (1012),
“v” is the viscosity of the solution,
“Γ” is the autocorrelation curve fit value (i.e., a value determined from fitting to the autocorrelation curve),
“T” is the temperature of the solution,
“n” is the refractive index of the solution,
“Θ” is the scattering measurement angle formed by axes (A₁, A₂) of body (900) in the measurement medium (e.g., liquid or gas), and
“k_{B}” is Boltzmann's constant.
   Thus, in order to obtain a reliable measurement of encapsulated mRNA particle size and/or size distribution within a solution, it may be desirable to obtain a measurement of the viscosity of the solution. The following description provides examples of how a DLS stage as described above may be used to measure and monitor viscosity of a solution carrying encapsulated mRNA particles while simultaneously measuring and monitoring the particle size and/or size distribution of those mRNA particles in the solution. Each of the examples described below provide measurement and monitoring of solution viscosity without requiring any contact between a sensor and the solution that is being subject to measurement.

While the following examples describe methods for determining the viscosity of a solution, the size of particles in a solution, and the size distribution of particles in a solution, the same methods may be used to determine other parameters such as refractive index or temperature. Such parameters may be performed using equation (I) in conjunction with data collected as described below.

### A. Example of Process Chip Features for Providing Solution Viscosity Measurement

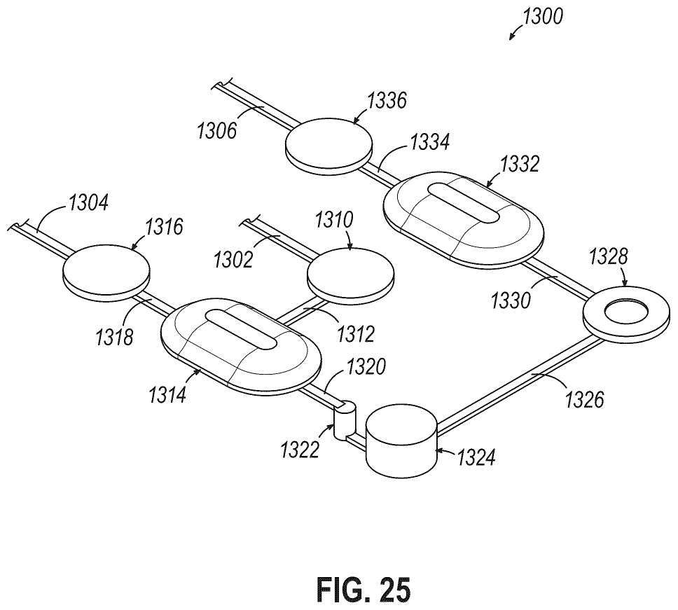

As noted above with reference to FIG. 13, process chip (800) may include a pre-DLS stage (890) and a post-DLS stage (892), with DLS chamber (870) being positioned in the fluid path between pre-DLS stage (890) and post-DLS stage (892). FIG. 25 shows an example of a measurement stage (1300) that includes components that may be used to effectively form a pre-DLS stage (890) and a post-DLS stage (892). It should therefore be understood that measurement stage (1300) of FIG. 25 may be incorporated into a process chip like process chip (800). In the present example, the entire set of features of measurement stage (1300) described below may effectively replace the combination of pre-DLS stage (890), DLS chamber (870), channels (872, 874), and post-DLS stage (892).

Measurement stage (1300) is in fluid communication with a sample inlet channel (1302), a testing fluid inlet channel (1304), and an outlet channel (1306). In the context of process chip (800), sample inlet channel (1302) may be deemed analogous to manifold outlet channel (860), such that sample input channel (1302) receives an aliquot (i.e., sample volume) of the solution carrying the encapsulated mRNA particles, as output from mixing assemblies (820). Testing fluid inlet channel (1304) is in fluid communication with a source of a testing fluid (not shown). As described in greater detail below, the testing fluid may include a fluid with beads, a dilutant (e.g., a buffer fluid, water, etc.) without beads, and/or any other suitable kind(s) of fluid(s). Outlet channel (1306) may be deemed analogous to outlet channel (896), such that the solution may exit from measurement stage (1300) via outlet channel (1306). By way of example only, outlet channel (1306) may ultimately lead to a waste storage compartment, some other stage where the solution is utilized to form a therapeutic composition, or some other component(s).

Measurement stage (1300) of the present example also include a first valve (1310), a first channel (1312), a first pump (1314), a second valve (1316), a second channel (1318), a third channel (1320), a mixing chamber (1322), a DLS chamber (1324), a fourth channel (1326), a third valve (1328), a fifth channel (1330), a second pump (1332), a sixth channel (1334), and a fourth valve (1336). Valves (1310, 1316, 1328, 1336) of this example may be configured and operable like valves (824, 854) described above. Thus, valves (1310, 1316, 1328, 1336) may be transitioned between opened and closed states by driving an elastic layer (e.g., like elastic layer (302)) of process chip (800) by selectively applying pressure to elastic layer (or relieving pressure against elastic layer) in regions of process chip (800) corresponding to valves (1310, 1316, 1328, 1336). Valves (1310, 1316, 1328, 1336) may thus be used to selectively prevent or permit fluid flow. Pumps (1314, 1332) may also be operated by selectively applying pressure to an elastic layer (e.g., like elastic layer (302)) of process chip (800) in regions of process chip (800) corresponding to pumps (1314, 1332), to thereby drive fluid flow through a peristaltic pumping action.

First valve (1310) is interposed between sample inlet channel (1302) and first channel (1312), such that first valve (1310) is operable to selectively prevent or permit flow of fluid between sample inlet channel (1302) and first channel (1312). First channel (1312) is further in fluid communication with first pump (1314). Second valve (1316) is interposed between testing fluid inlet channel (1304) and second channel (1318), such that second valve (1316) is operable to selectively prevent or permit flow of fluid between testing fluid inlet channel (1304) and second channel (1318). Second channel (1318) is further in fluid communication with first pump (1314). First pump (1314) is also in fluid communication with third channel (1320). First pump (1314) is operable to pump fluid from sample inlet channel (1302) and/or testing fluid inlet channel (1304) toward third channel (1320), depending on the state of each respective valve (1310, 1316).

Third channel (1320) is further in fluid communication with mixing chamber (1322). Mixing chamber (1322) is configured to mix fluids from sample inlet channel (1302) and testing fluid inlet channel (1304), as pumped into mixing chamber (1322) via first pump (1314). By way of example only, mixing chamber (1322) may be configured and operable like any mixing chamber described herein. Alternatively, mixing chamber (1322) may be configured and operable in any other suitable fashion.

Mixing chamber (1322) leads directly into DLS chamber (1324). DLS chamber (1324) may be configured and operable like DLS chamber (870) described above. Thus, body (900) may be positioned adjacent to DLS chamber (1324), such that source optical fiber (1010) may emit light into DLS chamber (1324); and such that sensing optical fiber (1020) may receive light scattered from particles in the fluid in DLS chamber (1324) as described above. The scattered light may reach photon counter (1022), and the corresponding data may be processed by autocorrelator (1024) as described above and as further described in greater detail below.

DLS chamber (1324) is further in fluid communication with fourth channel (1326), which leads to third valve (1328). Third valve (1328) is further in fluid communication with fifth channel (1330). Third valve (1328) is thus operable to selectively prevent or permit flow of fluid between fourth channel (1326) and fifth channel (1330). Fifth channel (1330) is further in fluid communication with second pump (1332). Second pump (1332) is also in fluid communication with sixth channel (1334). Second pump (1332) is operable to pump fluid from fifth channel (1330) toward sixth channel (1334). Second pump (1332) is also operable to pump fluid back toward fifth channel (1330).

Sixth channel (1334) is further in fluid communication with fourth valve (1336). Fourth valve (1336) is also in fluid communication with outlet channel (1306), such that fourth valve (1336) is operable to selectively prevent or permit flow of fluid between sixth channel (1334) and outlet channel (1306).

It should be understood from the foregoing that pumps (1314, 1332) may drive fluid from two separate sources toward and away from DLS chamber (1324). In addition, valves (1310, 1316, 1328, 1336) may selectively prevent flow of fluids at different respective regions of process chip (800) in conjunction with operation of pumps (1314, 1332). Examples of how measurement stage (1300) may be used in combination with the DLS components shown in FIGS. 9-11 and 16-20 to sense viscosity, particle size, and particle size density will be described in greater detail below.

### B. Example of Viscosity Sensing Using Addition of Beads

In some scenarios, viscosity of a solution may be measured by introducing known beads into the solution, then performing DLS on the solution with the beads. In this context, “known beads” includes beads having a known diameter. As used herein, the term “beads” should not be read as being necessarily limited to manufactured spherical structures. For instance, “beads” may include other calibrants such as calibration molecules of a known size, etc. An example of a calibrant bead in the form of a calibration molecule is dextran. Alternatively, any other suitable kind of calibration molecule (or other calibrant) may be used.

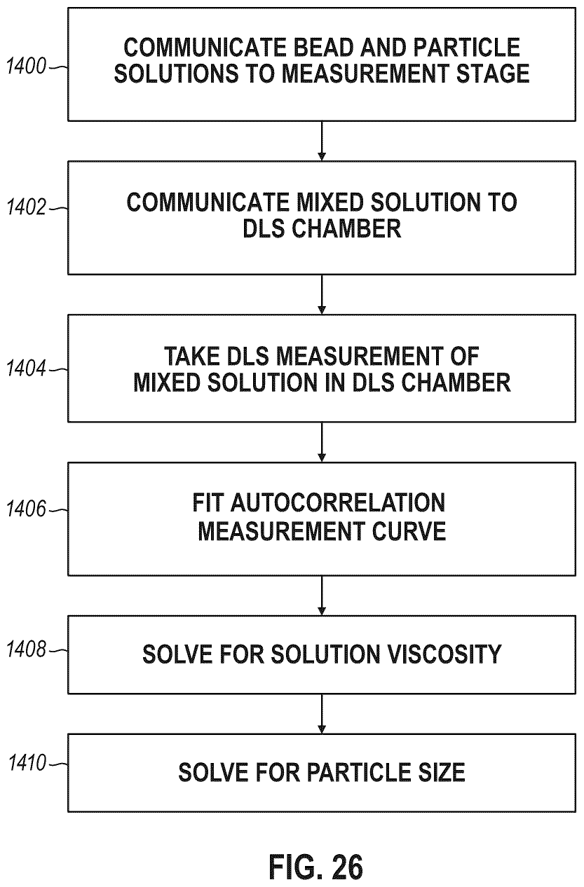

FIG. 26 shows an example of a process utilizing beads via the measurement stage (1300) shown in FIG. 25. In this example, a bead-containing solution and an encapsulated mRNA particle-containing solution are communicated to measurement stage (1300), as shown in block (1400) of FIG. 26. This includes opening first valve (1310) and driving an aliquot of encapsulated mRNA particle-containing solution toward first pump (1314) via channels (1302, 1312). This also includes opening second valve (1316) and driving a volume of the bead-containing solution toward first pump (1314) via channels (1304, 1318). In this example, the beads in the bead-containing solution are of a known size; while encapsulated mRNA particles in the encapsulated mRNA particle-containing solution are of an unknown size and the encapsulated mRNA particle-containing solution is of an unknown viscosity.

In some scenarios, the encapsulated mRNA particle-containing solution and bead-containing solution are driven toward first pump (1314) simultaneously. In some other scenarios, the encapsulated mRNA particle-containing solution and bead-containing solution are driven toward first pump (1314) in a series (e.g., the encapsulated mRNA particle-containing solution being driven first, followed by the bead-containing solution; or the bead-containing solution being driven first, followed by the encapsulated mRNA particle-containing solution). In versions where the different solutions are driven toward the first pump (1314) in a series, one valve (1310, 1316) may remain in a closed state while the other valve (1310, 1316) is opened.

Once both solutions have reached first pump (1314), both valves (1310, 1316) may be closed; and first pump (1314) may be activated to drive the two solutions toward DLS chamber (1324), as shown block (1402). Third valve (1328) may remain in a closed state during this part of the process. En route to DLS chamber (1324), the solutions will pass through third channel (1320) and mixing chamber (1322), such that DLS chamber (1324) will receive a mixture of the two solutions.

At this stage, first pump (1314) may be deactivated, and valves (1310, 1316, 1328) may remain closed, such that the mixture remains in DLS chamber (1324). With the mixture being held in DLS chamber (1324), the DLS components shown in FIGS. 9-11 and 16-20 may be activated as described above to perform DLS on the mixture and thereby take a DLS measurement of the mixture, as shown in block (1404). This DLS measurement may include projecting light into the mixture, receiving the light scattered by the beads and particles in the mixture, and tracking the scattering pattern changes over time as the beads and particles disperse in the liquid through Brownian motion. The DLS data may be used to generate an autocorrelation curve, as shown in block (1406), and as also described in greater detail above.

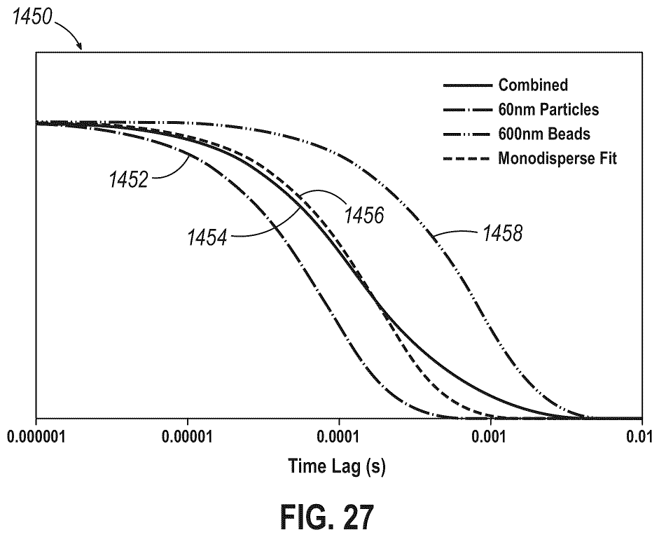

FIG. 27 shows a graph (1450) including examples of autocorrelation curves (1452, 1454, 1456, 1458) that may be obtained via DLS chamber (1324). For instance, curve (1452) represents an autocorrelation curve generated by the encapsulated mRNA particle-containing solution where the encapsulated mRNA particles have a relatively small diameter (e.g., approximately 60 nm). Curve (1458) represents an autocorrelation curve generated by the bead-containing solution where the beads have a relatively large diameter (e.g., approximately 600 nm). Curve (1454) represents an autocorrelation curve generated by the mixture of the encapsulated mRNA particle-containing solution and the bead-containing solution. Curve (1456) represents an example of an autocorrelation curve corresponding to a certain single particle-size population, based on fitting the autocorrelation curve from a two-population solution to a single-population model. Curve (1456) signifies that an autocorrelation curve resulting from a solution containing two populations differs from that of a solution containing a monodisperse (single) population.

Returning to the process shown in FIG. 26, using the data from the autocorrelation curve, the next step may include applying the data to the following equation (II) to determine the viscosity of the encapsulated mRNA particle-containing solution, as shown in block (1408):

$$y = A + {[ B {e}^{- {Γ}_{1} x} + D {e}^{- {Γ}_{2} x} ]}^{2} \qquad ( II )$$

where “y” is the autocorrelation value,
“A” is the vertical offset of the autocorrelation curve,
“B” is the magnitude of the exponential associated with one single population (e.g., encapsulated mRNA particles),
“Γ₁” is the autocorrelation curve fit value associated with the encapsulated mRNA particles, determined from fitting to the autocorrelation curve,
“D” is the magnitude of the exponential associated with another single population (e.g., beads),
“Γ₂” is the autocorrelation curve fit value associated with the beads, determined from fitting to the autocorrelation curve, and
“x” is the time lag of the autocorrelation.

The “Γ₁” and “Γ₂” values of equation (II) may each be independently consistent with equation (I), where the larger “Γ” value corresponds with the larger known bead diameter. Thus, equation (I) may be effectively rewritten as the following equation (III):

$$v = \frac{K}{{Γ}_{2} {d}_{bead}} \qquad ( III )$$

where “v” is the viscosity of the mixture of the aliquot and the bead solution,
“Γ₂” is the autocorrelation curve fit value associated with the beads, determined from fitting to the autocorrelation curve,
“d_{bead}” is the diameter of the beads (the value of which is known in the present example), and
“K” is the rest of the parameters in equation (I), expressed in equation (III) as “K” for the sake of simplicity.
   Equation (III) may thus be solved to determine the viscosity of the mixture, as shown in block (1408). It should be understood that this will represent the viscosity of the combination of the encapsulated mRNA particle-containing solution and the bead-containing solution. It should also be understood that, in this example, the beads of a known size are used as a calibration tool to determine viscosity.

With the mixture viscosity having been determined, the size of the encapsulated mRNA particles may be determined using the following equation (IV):

$${d}_{particle} = \frac{K}{{Γ}_{1} v} \qquad ( IV )$$

where “d_{particle}” is the diameter of the encapsulated mRNA particles,
“Γ₁” is the autocorrelation curve fit value associated with the encapsulated mRNA particles, determined from fitting to the autocorrelation curve,
“v” is the viscosity of the mixture (e.g., as determined via equation (III)), and
“K” is the rest of the parameters in equation (I), expressed in equation (III) as “K” for the sake of simplicity.

Once the mixture viscosity and encapsulated mRNA particle size have been determined in accordance with blocks (1408, 1410), third valve (1328) may be transitioned to an open state, and first pump (1324) may be activated to drive the mixture toward second pump (1332) via fourth channel (1326) and fifth channel (1330). Fourth valve (1336) may be transitioned to an open state, and second pump (1332) may be activated to drive the mixture toward outlet channel (1306) via sixth channel (1334). In some versions, the mixture is received in a waste storage compartment after exiting measurement stage (1300) via outlet channel (1306). In some other versions, the mixture is utilized to form a therapeutic composition after exiting measurement stage (1300) via outlet channel (1306). Alternatively, the mixture may be handled in any other suitable fashion after exiting measurement stage (1300) via outlet channel (1306).

The process described above with reference to FIGS. 26-27 may be carried out repeatedly to test different aliquots of the encapsulated mRNA particle-containing solution. In some versions, valves (854) are operated to sequentially direct the output of each mixing assembly (820) toward measurement stage (1300). The measured encapsulated mRNA particle sizes and/or particle size distributions may be compared against a threshold or predetermined range to determine whether the actual encapsulated mRNA particle sizes and/or particle size distributions are within tolerance. This comparison may indicate whether the mixing assembly (820) that generated the aliquot processed through measurement stage (1300) is operating properly. If an encapsulated mRNA particle size and/or particle size distribution is outside tolerance, then this may indicate that the size and/or size distribution of the of the encapsulated mRNA particles in measurement stage (1300) is inappropriate; and that the mixing assembly (820) that generated the aliquot in measurement stage (1300) is operating improperly. Process chip (800) may then cease delivery of the output of that mixing assembly (820).

Regardless of whether the output of a mixing assembly (820) has yielded acceptable or unacceptable particle sizes and/or size distribution, process chip (800) may operate valves (854) to communicate the output of the next mixing assembly (820) to measurement stage (1300) after the output of the first mixing assembly (820) has been analyzed in measurement stage (1300) in accordance with the process described above with reference to FIGS. 26-27. This sequence may continue until the output of each mixing assembly (820) has been analyzed in measurement stage (1300). Once the output of the last mixing assembly (820) has been analyzed in measurement stage (1300), the process may start over with the first mixing assembly (820) and continue through the sequence throughout the duration of operation of process chip (800). In the event that any mixing assemblies (820) have been shut down due to their output failing at measurement stage (1300), such mixing assemblies (820) may be passed over as process chip (800) reiterates the sequence of testing mixing assembly (820) outputs in measurement stage (1300).

In some variations of measurement stage (1300) where beads of a known size are used as a calibration tool to measure the viscosity of a solution as described above with reference to FIGS. 26-27, second pump (1332) and either third valve (1328) or fourth valve (1336) are omitted. In other words, the above-described process of using beads of a known size as a calibration tool to measure the viscosity of a solution may be performed without second pump (1332) and either third valve (1328) or fourth valve (1336). The above-described process of using beads of a known size as a calibration tool to measure the viscosity of a solution may also be performed using other variations of measurement stage (1300), such that the features and arrangement shown in FIG. 25 are not necessarily the only features and arrangement that may be used to perform this process.

In addition to the foregoing teachings provided specifically in the context of measurement stage (1300) and FIGS. 26-27, a version of process chip (800) that includes measurement stage (1300) may be operated in accordance with the other teachings provided above with respect to operation of process chip (800).

As with other calculations and performed algorithms as described herein, the process shown in FIG. 26 may be executed by controller (121). This may include controller (121) activating components that drive valves (1310, 1316, 1328, 1336), pumps (1314, 1332), and the DLS components shown in FIGS. 9-11 and 16-20. This may also include controller (121) processing autocorrelation data from autocorrelator (1024) to generate autocorrelation curves and to perform the calculations associated with blocks (1408, 1410) as described above. Of course, controller (121) may perform various other functions in connection with the process shown in FIG. 26, including but not limited to the other functions explicitly described herein.

### C. Example of Viscosity Sensing Using Serial Dilution

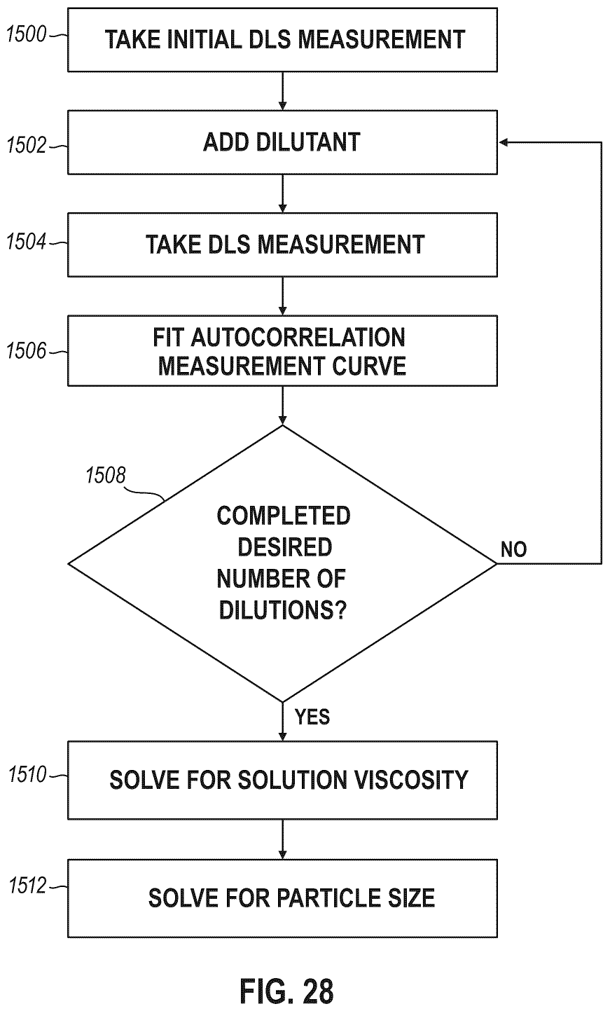

In addition to, or in lieu of, using beads of a known size as a calibration tool to measure the viscosity of a solution, the viscosity of a solution may be measured by providing controlled serial dilution of the solution and tracking changes in the solution based on the serial dilution. An example of such a serial dilution process is shown in FIG. 28. In this example, an aliquot of encapsulated mRNA particle-containing solution is communicated toward DLS chamber (1324), and an initial DLS measurement is obtained, as shown in block (1500). This includes opening first valve (1310) and driving the aliquot of encapsulated mRNA particle-containing solution toward first pump (1314) via channels (1302, 1312). Once the aliquot reaches first pump (1314), first valve (1310) is closed; then first pump (1314) is activated to drive the aliquot into DLS chamber (1324) via channel (1320) and mixing chamber (1322). Third valve (1328) may remain in a closed state during this part of the process. Alternatively, third valve (1328) may be in an open state and the aliquot may reside in mixing chamber (1322), DLS chamber (1324), and second pump (1332). With at least a portion of the aliquot being held in DLS chamber (1324), the DLS components shown in FIGS. 9-11 and 16-20 may be activated as described above to perform DLS on the aliquot and thereby take an initial or baseline DLS measurement of the aliquot.

Once the initial DLS measurement of the aliquot has been taken, a dilutant is added to the aliquot, as shown in block (1502). By way of example only, the dilutant may include a buffer or any other suitable kind of dilutant. Moreover, the viscosity of the dilutant may be known. This part of the process may include opening second valve (1316) and driving a first volume of the dilutant toward first pump (1314) via channels (1304, 1318). In some versions, the first volume of dilutant exceeds the capacity of first pump (1314), such that at least some of the first volume of dilutant is communicated past first pump (1314) in measurement stage (1300). Once the first volume of dilutant has been introduced into measurement stage (1300), second valve (1316) is closed; then first pump (1314) is activated to drive the first volume of dilutant into DLS chamber (1324) via channel (1320) and mixing chamber (1322), such that the first volume of dilutant combines with the aliquot of encapsulated mRNA particle-containing solution in DLS chamber (1324). In some versions, the combined volume of the first volume of dilutant and the aliquot of encapsulated mRNA particle-containing solution is approximately equal to the combined capacity of mixing chamber (1322), DLS chamber (1324), at least one pump (1314, 1332), and channels (1320, 1326, 1330).

To further mix the first volume of dilutant and the aliquot of encapsulated mRNA particle-containing solution, pumps (1314, 1332) may be activated in a sequence for a predetermined number of repetitions. For instance, valves (1310, 1316, 1336) may be kept in a closed state while valve (1328) is kept in an open state, then first pump (1314) may be activated to drive the mixture toward second pump (1332). Next, second pump (1332) may be activated to drive the mixture back toward first pump (1314). In this manner, pumps (1314, 1332) may be alternatingly activated any suitable number of times. As the mixture flows between pumps (1314, 1332), the mixture may repeatedly flow through mixing chamber (1322), which may further promote mixing of the first volume of dilutant with the aliquot of encapsulated mRNA particle-containing solution.

Once the first volume of dilutant has been suitably mixed with the aliquot of encapsulated mRNA particle-containing solution, even in scenarios where pumps (1314, 1332) not alternatingly activated to further mix the first volume of dilutant with the aliquot of encapsulated mRNA particle-containing solution, the mixture may be held in in DLS chamber (1324); and the DLS components shown in FIGS. 9-11 and 16-20 may be activated as described above to perform DLS on the mixture and thereby take a DLS measurement of the mixture as shown in block (1504). This DLS measurement may include projecting light into the mixture, receiving the light scattered by the beads and particles in the mixture, and tracking the scattering pattern changes over time as the beads and particles disperse in the liquid through Brownian motion. The DLS data may be used to generate an autocorrelation curve, as shown in block (1506), and as also described in greater detail above.

Thereafter, a number of additional volumes of dilutant may be added to the mixture to further dilute the mixture. Each additional volume of dilutant may be the same volume as the first volume of dilutant. Each additional volume of dilutant may also be added to (and mixed with) the previously formed mixture of dilutant and aliquot in accordance with the procedure described above. Thus, part of the process includes determining whether additional volumes of dilutant should be added, as shown in block (1508). In some versions, additional volumes of dilutant are added (block (1502)), corresponding DLS measurements are taken (block (1504)), and corresponding autocorrelation curves are fitted (block (1506)) a predetermined number of times. In some other versions, the data obtained through the DLS measuring process is monitored to determine whether enough data has been obtained, such that the number of iterations of dilution, DLS measuring, and autocorrelation curve fitting may vary from process to process.

In versions where a predetermined number of iterations are used, controller (121) or some other component may track the number of times an additional volume of dilutant has been added, as shown in block (1506); and may ensure that additional volumes of dilutant are added, corresponding DLS measurements taken (block (1504)), and corresponding autocorrelation curves fitted (block (1506)), until the predetermined number of dilutant volumes have been added. Similarly, controller (121) may track the data obtained through the DLS measuring process to determine whether enough data has been obtained; and cease further iterations once controller (121) has determined that enough data has been obtained. In either scenario, controller (121) or some other component may drive a subroutine of serial dilutions, corresponding DLS measurements, and corresponding autocorrelation curve fittings. In some versions, each iteration of dilution (block (1502)) provides a 50% dilution. Alternatively, any other suitable duration rate may be used, though it may still be beneficial to provide the same dilution rate for each and every iteration of dilution.

Once the appropriate number of dilutant volumes have been added (e.g., the act of dilution (block (1502)) has been iterated the predetermined number of times or the data shows that further iterations are unnecessary, etc.), the corresponding DLS measurements have been taken (block (1504)), and the corresponding autocorrelation curves fitted (block (1506)), viscosity of the diluted mixture may be determined as shown in block (1510). In the present example, the encapsulated mRNA particles are conveyed in a fluid medium that contains ethanol, such that the encapsulated mRNA particle-containing solution includes encapsulated mRNA particles and ethanol; while the dilutant includes water. Alternatively, any other suitable fluid medium may be used to convey the encapsulated mRNA particles; and any other fluid may be used as a dilutant. Returning to the present example, while the precise amount of ethanol in the encapsulated mRNA particle-containing solution may be unknown, the amount of ethanol in the encapsulated mRNA particle-containing solution may be assumed to be approximately around a certain amount (e.g., approximately 15%, etc.). The viscosity of the mixture may increase linearly with ethanol concentration, as illustrated in the following equation (V):

$$v = f ( [ ethanol ] ) \approx m [ ethanol ] + b \qquad ( V )$$

where “v” is the viscosity of the mixture of the aliquot and the dilutant,
“f([ethanol])” is the viscosity as a linear function of ethanol content,
“m([ethanol])” is a linearization term in the equation, representing the concentration of ethanol, and
“b” is a linearization term in the equation, representing the initial viscosity without any ethanol.

With the viscosity of the mixture being determined as described above using equation (V), the next step of the process includes solving for the encapsulated mRNA particle size, as shown in block (1512). To that end. as the concentration of the ethanol in the mixture is reduced by a known factor (“f”) with each iteration of dilution (block (1502)), the value of an autocorrelation gamma value (“Γᵢ”) to the number of dilutions may be determined in accordance with the following equation (VI):

$${Γ}_{i} = \frac{K / d}{b + {m [ ethanol ]}_{0} {f}^{i}} = \frac{A}{B + C {f}^{i}} \qquad ( VI )$$

where “Γᵢ” is the autocorrelation curve fit value determined from fitting the autocorrelation curve for each iteration of dilution (block (1502)),
“K” is the rest of the parameters in equation (I), expressed in equation (III) as “K” for the sake of simplicity,
“d” is the diameter of the encapsulated mRNA particles,
“b” is a linearization term in the equation, representing the initial viscosity without any ethanol,
“m([ethanol]) o” is a linearization term in the equation, representing the initial concentration of ethanol,
“f” is a dilution factor, determined by the microfluidic volumes (e.g., if the input microfluidic buffer dilutes the sample by half each time, it would have a 50% dilution factor each time, and this would be determined by the buffer volume that is introduced for each dilution cycle as determined by microfluidic geometries/volumes),
“A” is a fit parameter, representing K/d,
“B” is a fit parameter, representing b, and
“C” is a fit parameter, representing m ([ethanol])₀.
   In this example, the value “A” may enable determination of the size of the encapsulated mRNA particles in the aliquot; and the value “C” may enable determination of the concentration of ethanol in the aliquot.

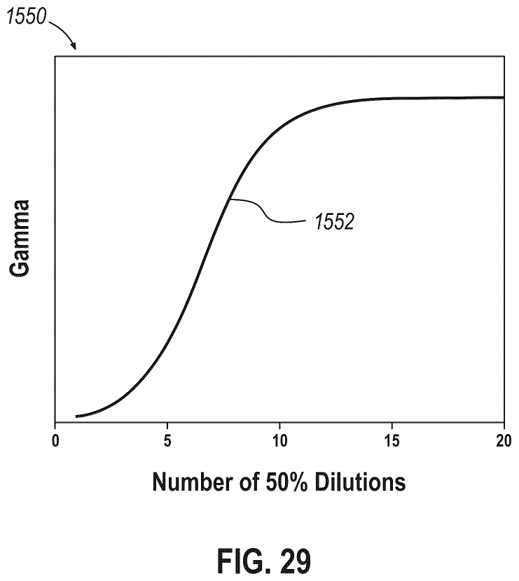

FIG. 29 shows a graph (1550) including an example of a curve (1552), plotting an example of the value of “Γᵢ” over the course of a 20 iterations of dilution (block (1502)), with each iteration of dilution (block (1502)) providing a dilution rate of 50%. As shown, the value of “Γᵢ” increases substantially from about the third dilution (block (1502)) iteration to about the ninth dilution iteration; then substantially plateaus beginning at about the tenth dilution (block (1502)) iteration. Thus, in this example, it may be determined that dilution (block (1502)) may be iterated between about three and nine times, with additional dilution (block (1502)) iterations not necessarily being beneficial. It should be understood that this is just an illustrative example, and different processes may warrant more or fewer iterations of dilution (block (1502)).

In view of the foregoing, with each repetition of the dilution step (block (1502)), the concentration of the sample in measurement stage (1300) is reduced by a known factor that is characteristic to the design of measurement stage (1300). This factor may scale with the volume of pumps (1314, 1332), mixing chamber (1322), DLS chamber (1324), etc.

The process described above with reference to FIGS. 28-29 may be carried out repeatedly to test different aliquots of the encapsulated mRNA particle-containing solution. In some versions, valves (854) are operated to sequentially direct the output of each mixing assembly (820) toward measurement stage (1300). The measured encapsulated mRNA particle sizes and/or particle size distributions may be compared against a threshold or predetermined range to determine whether the actual encapsulated mRNA particle sizes and/or particle size distributions are within tolerance. This comparison may indicate whether the mixing assembly (820) that generated the aliquot processed through measurement stage (1300) is operating properly. If an encapsulated mRNA particle size and/or particle size distribution is outside tolerance, then this may indicate that the size and/or size distribution of the of the encapsulated mRNA particles in measurement stage (1300) is inappropriate; and that the mixing assembly (820) that generated the aliquot in measurement stage (1300) is operating improperly. Controller (121) may then effectively shut down that mixing assembly (820) as described herein.

Regardless of whether the output of a mixing assembly (820) has yielded acceptable or unacceptable particle sizes and/or size distribution, controller (121) may operate process chip (800) by driving valves (854) to communicate the output of the next mixing assembly (820) to measurement stage (1300) after the output of the first mixing assembly (820) has been analyzed in measurement stage (1300) in accordance with the process described above with reference to FIGS. 28-29. This sequence may continue until the output of each mixing assembly (820) has been analyzed in measurement stage (1300). Once the output of the last mixing assembly (820) has been analyzed in measurement stage (1300), the process may start over with the first mixing assembly (820) and continue through the sequence throughout the duration of operation of process chip (800). In the event that any mixing assemblies (820) have been shut down due to their output failing at measurement stage (1300), such mixing assemblies (820) may be passed over as process chip (800) reiterates the sequence of testing mixing assembly (820) outputs in measurement stage (1300).

In addition to the foregoing teachings provided specifically in the context of measurement stage (1300) and FIGS. 28-29, a version of process chip (800) that includes measurement stage (1300) may be operated in accordance with the other teachings provided above with respect to operation of process chip (800).

As with other calculations and performed algorithms as described herein, the process shown in FIG. 28 may be executed by controller (121). This may include controller (121) activating components that drive valves (1310, 1316, 1328, 1336), pumps (1314, 1332), and the DLS components shown in FIGS. 9-11 and 16-20. This may also include controller (121) processing autocorrelation data from autocorrelator (1024) to generate autocorrelation curves and to perform the calculations associated with blocks (1408, 1410) as described above. Of course, controller (121) may perform various other functions in connection with the process shown in FIG. 28, including but not limited to the other functions explicitly described herein.

### V. EXAMPLE OF PROCESS CHIP WITH FLUID INPUT MANIFOLDS

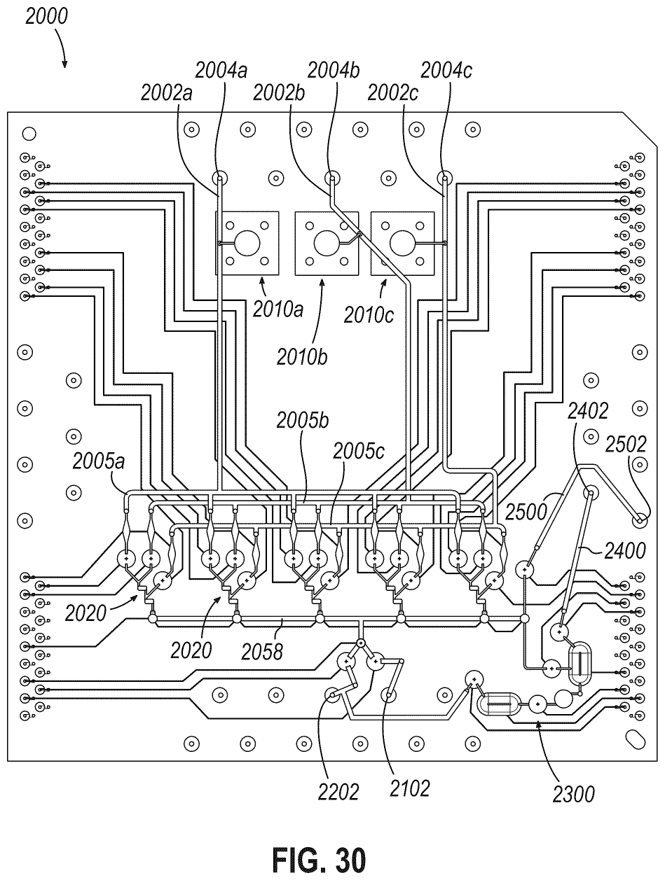

As described above, a process chip (800) may include a set of channels (856, 858, 860) thus cooperate to form an output manifold. This allows the outputs of several mixing assemblies (820) to be communicated to a single location, such as a measurement stage (1300). In some scenarios, it may be desirable to provide an input manifold that allows fluid from a single input source to reach a corresponding input channel of several mixing assemblies (820). This may prevent the need for having a dedicated set of fluid input ports (804a, 804b, 804c) for each and every mixing assembly (820). This may in turn reduce the manufacturing and operational complexity associated with a process chip. FIGS. 30-33 show an example of a process chip (2000) that may provide such benefits.

Process chip (2000) of the present example includes three fluid input ports (2004a, 2004b, 2004c) and three corresponding fluid channels (2002a, 2002b, 2002c). By way of example only, in some implementations, a combination of mRNA and water is communicated through fluid input port (2004a) and fluid channel (2002a), a delivery vehicle molecule or molecules in ethanol is communicated through fluid input port (2004b) and fluid channel (2002b), and a dilution agent or is communicated through fluid input port (2004c) and fluid channel (2002c). Alternatively, any other suitable fluids may be communicated through fluid input ports (2004a, 2004b, 2004c) and fluid channels (2002a, 2002b, 2002c). In the present example, fluid channel (2002a) leads to a fluid input manifold channel (2005a), which further leads to a plurality of mixing assemblies (2020), such that each mixing assembly (2020) may receive fluid from fluid input port (2004a) via channels (2002a, 2005a). Similarly, fluid channel (2002b) leads to a fluid input manifold channel (2005b), which further leads to a plurality of mixing assemblies (2020), such that each mixing assembly (2020) may receive fluid from fluid input port (2004b) via channels (2002b, 2005b). Fluid channel (2002c) leads to a fluid input manifold channel (2005c), which further leads to a plurality of mixing assemblies (2020), such that each mixing assembly (2020) may receive fluid from fluid input port (2004c) via channels (2002c, 2005c).

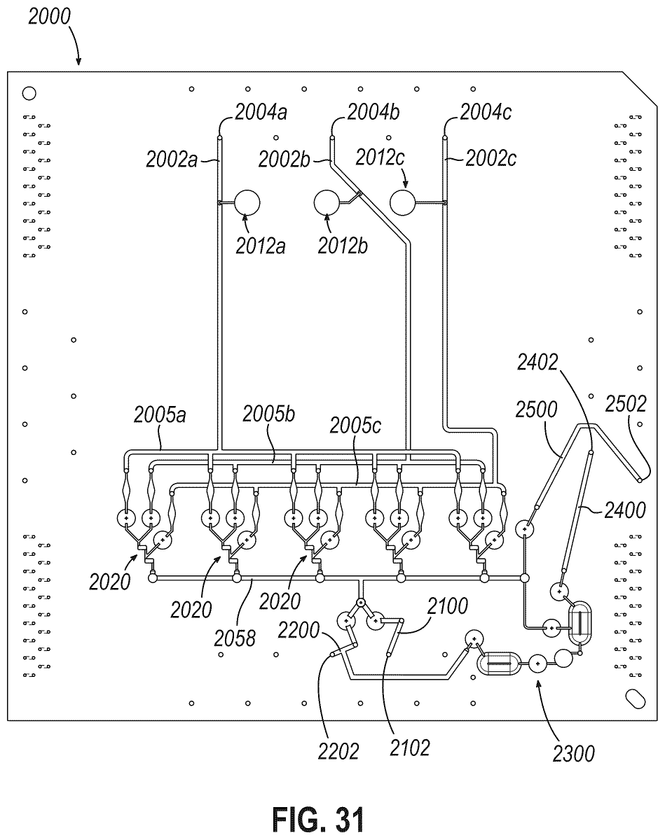

As shown in FIGS. 30-31, process chip (2000) of this example includes three pressure sensing regions (2010). A first pressure sensing region (2010a) is fluidically coupled with first fluid channel (2002a), such that first pressure sensing region (2010a) may detect the pressure of fluid within first fluid channel (2002a). A second pressure sensing region (2010b) is fluidically coupled with second fluid channel (2002b), such that second pressure sensing region (2010b) may detect the pressure of fluid within second fluid channel (2002b). A third pressure sensing region (2010c) is fluidically coupled with third fluid channel (2002c), such that third pressure sensing region (2010c) may detect the pressure of fluid within third fluid channel (2002c). Pressure sensing regions (2010) may be part of pressure sensing stages that are configured and operable like pressure sensing stage (700) described above. Pressure sensing regions (2010) may also be configured and operable like pressure sensing regions (810) described above. With certain features being omitted in FIG. 31, it should be understood that FIG. 31 only shows pressure sensing chambers (2012) of pressure sensing regions (2010).

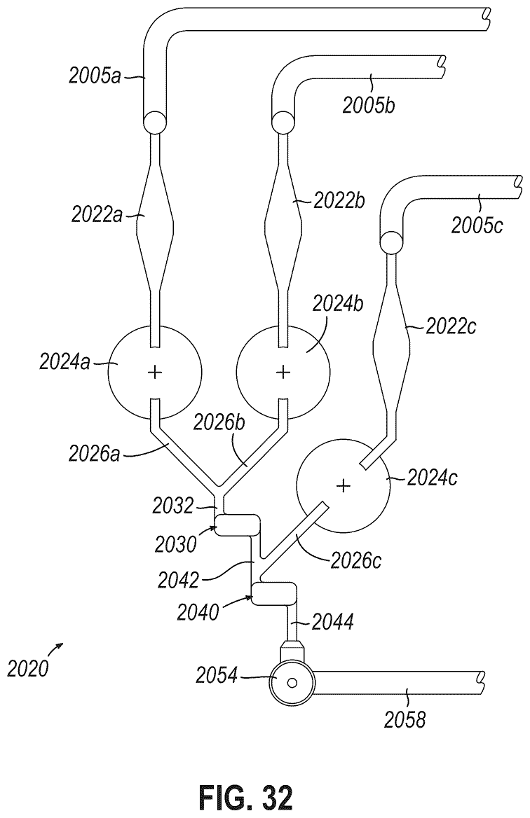

FIG. 32 shows features of mixing assemblies (2020) in greater detail. While only one mixing assembly (2020) is shown in FIG. 32, it should be understood that all the mixing assemblies (2020) in process chip (2000) may be configured and operable like the mixing assembly (2020) shown in FIG. 32. As shown, each mixing assembly (2020) includes a set of vacuum caps (2022), a set of inlet valves (2024), and a set of mixing chambers (2030, 2040). First vacuum cap (2022a) receives fluid from first fluid channel (2002a) via fluid input manifold channel (2005a). Second vacuum cap (2022b) receives fluid from second fluid channel (2002b) via fluid input manifold channel (2005b). Third vacuum cap (2022c) receives fluid from third fluid channel (2002c) via fluid input manifold channel (2005c). A first valve (2024a) meters the flow of fluid from first vacuum cap (2022a) into a first channel (2026a) leading toward first mixing chamber (2030). A second valve (2024b) meters the flow of fluid from second vacuum cap (2022b) into an inlet channel (2026b) leading toward first mixing chamber (2030). Channels (2026a, 2026b) converge to form an inlet channel (2032) leading into first mixing chamber (2030). The fluids from channels (2026a, 2026b) are thus mixed together within first mixing chamber (2030).

A third valve (2024c) meters the flow of fluid from third vacuum cap (2022c) into a third channel (2026c) leading toward second mixing chamber (2040). An outlet channel (2034) from first mixing chamber (2030) converges with third channel (2026c) to form an inlet channel (2042) leading into second mixing chamber (2040). The fluids from channels (2034, 2026c) are thus mixed together within second mixing chamber (2040). The fluid mixed in second mixing chamber (2040) is output through an outlet channel (2044).

In some versions where mixing assemblies are used to provide encapsulated mRNA, a combination of mRNA and water may be communicated through first fluid channel (2002a) and a delivery vehicle molecule or molecules in ethanol may be communicated through second fluid channel (2002b). In such versions, the mRNA and delivery vehicle molecules may thus be combined for encapsulation in first mixing chamber (2030). A dilution agent (e.g., a citrate-based buffer solution, etc.) may be communicated through third fluid channel (2002c). In such versions, second mixing chamber (2040) may thus be used to provide pH adjustment. In some variations, the mRNA and water are combined in another mixing chamber (not shown) that is upstream of first fluid channel (2002a). Similarly, the delivery vehicle molecules and ethanol may be combined in another mixing chamber (not shown) that is upstream of second fluid channel (2002b).

A valve (2054) is positioned downstream of outlet channel (2044). A shared manifold channel (2058) is positioned downstream of valve (2054). All mixing assemblies (2020) are fluidically coupled with shared manifold channel (2058) in this manner, with valves (2054) being interposed between respective mixing assemblies (2020) and shared manifold channel (2058). If a valve (2054) associated with a particular mixing assembly (2020) is in a closed state, then fluid may not be communicated from that mixing assembly (2020) to the shared manifold channel (2058). If a valve associated with a particular mixing assembly (2020) is in an open state, then fluid may be communicated from that mixing assembly (2020) to the shared manifold channel (2058). Valves (2054) may thus be selectively opened and closed to selectively provide fluid communication between a selected mixing assembly (2020) and shared manifold channel (2058).

To the extent that the drawings appear to suggest that valves (2054) are positioned along manifold channel (2058), valves (2054) are not in fact positioned to prevent the flow of fluid along manifold channel (2058) in the present example. Instead, each valve (2054) is only positioned to prevent the flow of fluid from its corresponding mixing assembly (2020) to manifold channel (2058). No valve (2054) will affect the flow of fluid from any other mixing assemblies (2020) in the present example; nor will any valve (2054) prevent fluid output from another mixing assembly (2020) from flowing through manifold channel (2058). Each valve (2054) will thus only prevent the flow of fluid from its corresponding mixing assembly (2020) into manifold channel (2058) without preventing the flow of fluid from any other mixing assemblies (2020) along manifold channel (2058).

In the present example, controller (121) is configured to drive valves (2054) in such a way that only one valve (2054) is in an open state at a given moment of operation. In some stages of operation, all valves (2054) may be in a closed state. In some other stages of operation, two or more valves (2054) may be in an open state. The features of process chip (2000) that are downstream of shared manifold channel (2058) will be described in greater detail below.

As noted above, process chip (2000) may be operated in such a way that the fluid outputs of mixing assemblies (2020) may all be communicated to the same shared manifold channel (2058), based on the operating state of each valve (2054). In other words, the fluid outputs of mixing assemblies (2020) may ultimately reach the same destination-shared manifold channel (2058). As also noted above, mixing assemblies (2020) may all receive fluids from the same input sources-namely, the fluid sources that are coupled with fluid input ports (2004a, 2004b, 2004c). This is due to the presence of respective fluid input manifold channels (2005a, 2005b, 2005c), which are shared by mixing assemblies (2020).

Just as controller (121) may be configured to drive valves (2054) in such a way that the fluid output of only one mixing assembly (2020) may be communicated to same shared manifold channel (2058) at a given moment of operation, controller (121) may be configured to allow only one mixing assembly (2020) to receive fluids from fluid input ports (2004a, 2004b, 2004c) at a given moment of operation. For instance, process chip (200) may be operated in such a way that the inlet valves (2024) of only one mixing assembly (2020) are in in open state, while inlet valves (2024) of all other mixing assemblies (2020) are in a closed state, at a given moment of operation. Valves (2024) may thus be activated to provide fluid communication from fluid input ports (2004a, 2004b, 2004c) to only one selected mixing assembly (2020) at a given moment of operation. In some stages of operation, valves (2024) of all mixing assemblies (2020) may be in a closed state. In some other stages of operation, valves (2024) of two or more mixing assemblies (2020) may be in an open state. Examples of scenarios of when controller (121) may activate valves (2024) to effectively switch from one mixing assembly (2020) to another mixing assembly (2020) will be described in greater detail below. While valves (2024) are described herein as providing structures to selectively turn off fluid communication to mixing assemblies (2020), some other versions may include valves with similar operability that are positioned upstream of vacuum caps (2022) (i.e., between fluid input manifold channels (2005a, 2005b, 2005c) and respective vacuum caps (2022a, 2022b, 2022c)).

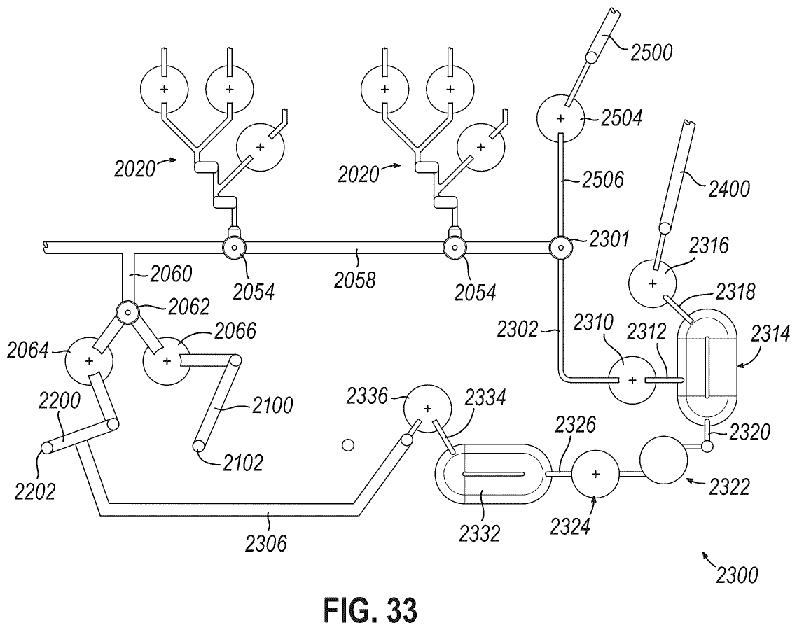

FIG. 33 shows features of process chip (2000) that are downstream of shared manifold channel (2058) (and, hence, downstream of mixing assemblies (2020)) in greater detail. As shown, shared manifold channel (2058) leads to a manifold outlet channel (2060). Manifold outlet channel (2060) is fluidically coupled with a set of valves (2062, 2064, 2066). Valve (2064) is fluidically coupled with a waste channel (2200), which is fluidically coupled with a waste output port (2202). Waste output port (2202) may be used to communicate fluid to a waste storage compartment. Such a waste storage compartment may be located in another process chip (111, 200, 500, 800, 2000), in reagent storage frame (107), or elsewhere. Examples of scenarios where fluid may be communicated through waste output port (2202) will be described in greater detail below. It should be understood that valves (2062, 2064) may be selectively transitioned between a closed state and an open state to allow fluid from manifold outlet channel (2060) to be communicated to waste output port (2202) via waste channel (2200).

Valve (2066) is fluidically coupled with an output channel (2100), which is fluidically coupled with a primary output port (2102). In some versions, fluid from primary output port (2102) constitutes an acceptable therapeutic composition. In some other versions, fluid from primary output port (2102) is further processed to form a therapeutic composition. Such further processing may include communicating the fluid to another process chip (111, 200, 500, 800, 2000), to a vial in reagent storage frame (107), or elsewhere. As another option, fluid from primary output port (2102) may be used in some other quality control testing (e.g., on another process chip (111, 200, 500, 800, 2000) or elsewhere). Alternatively, fluid from primary output port (2102) may be handled in any other suitable fashion. It should be understood that valves (2062, 2066) may be selectively transitioned between a closed state and an open state to allow fluid from manifold outlet channel (2060) to be communicated to primary output port (2102) via output channel (2100).

In addition to being fluidically coupled with manifold outlet channel (2060), manifold channel (2058) is also fluidically coupled with a measurement stage (2300). Measurement stage (2300) of this example is configured and operable similar to measurement stage (1300) described above. Measurement stage (2300) of this example includes a sample inlet channel (2302), a testing fluid inlet channel (2400), and an outlet channel (2306). A valve (2301) is interposed between sample inlet channel (2302) and manifold channel (2058), such that valve (2301) may be selectively opened to provide aliquot (i.e., sample volume) of the solution carrying the encapsulated mRNA particles, as output from a mixing assembly (2020), to sample inlet channel (2302). When valve (2301) is in an open state to provide an aliquot to measurement stage (2300) via sample inlet channel (2302), valve (2062) may be in a closed state.

Sample inlet channel (2302) is also fluidically coupled with a channel (2506) that has an associated valve (2504). Valve (2301) is positioned at a junction between sample inlet channel (2302), channel (2506), and manifold channel (2058). Another channel (2500) is also fluidically coupled with valve (2504). Channel (2500) leads to a port (2502), which is shown in FIGS. 30-31. In the present example, port (2502) is used to communicate a rinse fluid to process chip (2000). By way of example only, the rinse fluid may include a combination of water and ethanol and/or any other suitable kind(s) of rinse fluid. Valve (2504) may be selectively transitioned between closed and opened states to thereby prevent or permit fluid communication from port (2502) and channel (2500) to channel (2506). In some versions, valves (2504, 2301, 2310, 2336) are in an open state while valves (2054, 2316, 2064, 2066) are in a closed state when rinse fluid is communicated through channel (2500) via port (2502), such that the rinse fluid passes through measurement stage (2300) and ultimately exits process chip (2000) via waste output port (2202). Alternatively, the various valves within process chip (2000) may be selectively opened or closed in any other suitable scheme to provide any other desired flow path of the rinse fluid through process chip (2000). By way of example only, at least valves (2066, 2310, 2336) may be closed and valves (2301, 2054, 2064) may be open as rinse fluid is communicated through channel (2500) via port (2502), such that the rinse fluid passes through shared manifold channel (2058) and ultimately exits process chip (2000) via waste output port (2202). In some other variations, channels (2500, 2506), port (2502), and valve (2504) are omitted.

Testing fluid inlet channel (2400) is in fluid communication with a source of a testing fluid (not shown) via a testing fluid port (2402). As described in the context of measurement stage (1300) above the testing fluid may include a fluid with beads, a dilutant (e.g., a buffer fluid, water, etc.) without beads, and/or any other suitable kind(s) of fluid(s). Outlet channel (2306) may be deemed analogous to outlet channel (1306), such that the solution may exit from measurement stage (2300) via outlet channel (2306). As shown in FIG. 33, outlet channel (2306) ultimately leads to waste output port (2202) via waste channel (2200). In stages of operation where fluid is communicated from measurement stage (2300) to waste output port (2202) via waste channel (2200), valve (2064) may be in a closed state to prevent such fluid from reaching manifold outlet channel (2060).

Measurement stage (2300) of the present example also include a first valve (2310), a first channel (2312), a first pump (2314), a second valve (2316), a second channel (2318), a third channel (2320), a mixing chamber (2322), a DLS chamber (2324), a fourth channel (2326), a second pump (2332), a fifth channel (2334), and a third valve (2336). Valves (2310, 2316, 2336) of this example may be configured and operable like valves (824, 854) described above. Thus, valves (2310, 2316, 2336) may be transitioned between opened and closed states by driving an elastic layer (e.g., like elastic layer (302)) of process chip (2000) by selectively applying pressure to elastic layer (or relieving pressure against elastic layer) in regions of process chip (2000) corresponding to valves (2310, 2316, 2336). Valves (2310, 2316, 2336) may thus be used to selectively prevent or permit fluid flow. The other valves (2024, 2054, 2064, 2066, 2301, 2504) of process chip (2000) may be configured and operable in a similar fashion. Pumps (2314, 2332) may also be operated by selectively applying pressure to an elastic layer (e.g., like elastic layer (302)) of process chip (2000) in regions of process chip (2000) corresponding to pumps (2314, 2332), to thereby drive fluid flow through a peristaltic pumping action.

First valve (2310) is interposed between sample inlet channel (2302) and first channel (2312), such that first valve (2310) is operable to selectively prevent or permit flow of fluid between sample inlet channel (2302) and first channel (2312). First channel (2312) is further in fluid communication with first pump (2314). Second valve (2316) is interposed between testing fluid inlet channel (2400) and second channel (2318), such that second valve (2316) is operable to selectively prevent or permit flow of fluid between testing fluid inlet channel (2400) and second channel (2318). Second channel (2318) is further in fluid communication with first pump (2314). First pump (2314) is also in fluid communication with third channel (2320). First pump (2314) is operable to pump fluid from sample inlet channel (2302) and/or testing fluid inlet channel (2400) toward third channel (2320), depending on the state of each respective valve (2310, 2316).

Third channel (2320) is further in fluid communication with mixing chamber (2322). Mixing chamber (2322) is configured to mix fluids from sample inlet channel (2302) and testing fluid inlet channel (2304), as pumped into mixing chamber (2322) via first pump (2314). By way of example only, mixing chamber (2322) may be configured and operable like any mixing chamber described herein. Alternatively, mixing chamber (2322) may be configured and operable in any other suitable fashion.

Mixing chamber (2322) leads directly into DLS chamber (2324). DLS chamber (2324) may be configured and operable like DLS chamber (870) described above. Thus, body (900) may be positioned adjacent to DLS chamber (2324), such that source optical fiber (1010) may emit light into DLS chamber (2324); and such that sensing optical fiber (1020) may receive light scattered from particles in the fluid in DLS chamber (2324) as described above. The scattered light may reach photon counter (1022), and the corresponding data may be processed by autocorrelator (1024) as described above.

DLS chamber (1324) is further in fluid communication with fourth channel (2326), which leads to second pump (2332). Second pump (2332) is also in fluid communication with fifth channel (2334). Second pump (2332) is operable to pump fluid from fourth channel (1326) toward fifth channel (2334); and vice-versa. In some variations, another valve (not shown) may be interposed in the fluid path between fourth channel (2326) and second pump (2332). Such a valve may be configured and operable like third valve (1328) described above in the context of measurement stage (1300). Returning to the present example, fifth channel (2334) is further in fluid communication with third valve (2336). Third valve (2336) is also in fluid communication with outlet channel (2306), such that third valve (2336) is operable to selectively prevent or permit flow of fluid between fifth channel (2334) and outlet channel (2306).

It should be understood from the foregoing that pumps (2314, 2332) may drive fluid from two separate sources toward and away from DLS chamber (2324). In addition, valves (2310, 2316, 2336) may selectively prevent flow of fluids at different respective regions of process chip (2000) in conjunction with operation of pumps (2314, 2332). Measurement stage (2300) may be used in combination with the DLS components shown in FIGS. 9-11 and 16-20 to sense viscosity, particle size, and particle size density in the manner described above in the context of measurement stage (1300) and the disclosure corresponding to FIGS. 25-29.

As described above, valves (204) may be selectively activated to provide fluid communication through only one mixing assembly (2020) at any given stage of operation. In other words, valves (204) may be used to effectively designate one mixing assembly (2020) as being “active” while effectively designating the other mixing assemblies (2020) as being “inactive.” As also noted above, valves (2062, 2064, 2066, 2301) may be selectively activated to determine whether the fluid that is output by the active mixing assembly (2020) will be communicated to measurement stage (2300), primary output port (2102), or waste output port (2202). Regardless of the destination to where the fluid that is output by the active mixing assembly (2020) is being communicated, the valves (204, 2054) of the inactive mixing assemblies (2020) may remain closed.

As also described above, pressure sensing regions (2010) and measurement stage (2300) may be utilized to gather data relating to the performance of biochip (2000), including the performance that is specific to the currently active mixing assembly (2020). To the extent that controller (120) is operable to drive operation of the various valves (2024, 2054, 2062, 2064, 2066, 2301, 2504, 2310, 2316, 2336) of process chip (2000), and to the extent that controller (120) is operable to process data from pressure sensing regions (2010) and measurement stage (2300), controller (120) may be further configured to execute control algorithms based on real-time feedback. In other words, controller (120) may automatically drive valves (2024, 2054, 2062, 2064, 2066, 2301, 2504, 2310, 2316, 2336) and/or other features of system (100) based, at least in part, on real-time data gathered via pressure sensing regions (2010) and measurement stage (2300). In some cases, such automated operation via controller (120) may include automated switching from one mixing assembly (2020) being designated as the active mixing assembly (2020) to another mixing assembly (2020) being designated as the active mixing assembly (2020); with the previously-active mixing assembly (2020) being rendered inactive.

In one example of operation, the first mixing assembly (2020) on process chip (2000) may be deemed active while the other mixing assemblies (2020) on process chip (2000) may be deemed inactive. Valves (2064, 2301) may be kept in a closed state, and valves (2062, 2066) in an open state, to direct fluid that is output from the first mixing assembly (2020) to primary output port (2102). Eventually, the fluid may be temporarily redirected from primary output port (2102) to measurement stage (2300) to test an aliquot of the fluid. This may be accomplished by closing valve (2062) and opening valve (2301), and otherwise performing the operation described above in the context of measurement stage (2300). In some cases, this testing is performed periodically based on passage of time. In some other cases, this testing is performed in response to one or more other conditions (e.g., pressure data from one or more of pressure sensing regions (2010) falling outside of the tolerance, etc.). Regardless of the basis for performing the aliquot testing, the testing process may be initiated automatically by controller (120).

If the aliquot passes the test through measurement stage (2300) (e.g., indicating that the particle size and/or distribution is within tolerance), then controller (120) may transition process chip (2000) back to a non-testing mode where fluid that is output from the first mixing assembly (2020) is directed back to primary output port (2102). Valves (2064, 2301) may thus be automatically returned to the closed state; valves (2062, 2066) to the open state. The aliquot that was processed through measurement stage (2300) may exit process chip (2000) via waste output port (2202).

The above-described process may be repeated until controller (120) automatically determines that one or more conditions are outside of tolerance. In some scenarios, this may occur after a given mixing assembly (2020) has been deemed active for a certain period of time. In addition, or in the alternative, controller (120) may automatically determine that the particle size and/or distribution in the fluid output from the active mixing assembly (2020) is outside of tolerance, based on data from measurement stage (2300). In addition, or in the alternative, controller (120) may automatically determine that the pressure of fluid that is being communicated to the active mixing assembly (2020) is outside of tolerance, based on data from one or more of pressure sensing regions (2010). In addition, or in the alternative, controller (120) may automatically determine that the flow rate of fluid that is being communicated through the active mixing assembly (2020) is outside of tolerance, in accordance with the teachings above. In addition, or in the alternative, controller (120) may automatically determine that any other conditions associated with the active mixing assembly (2020) are outside of tolerance.

Once controller (120) automatically determines that one or more conditions associated with the active mixing assembly (2020) is/are outside of tolerance. Controller (120) may automatically switch from one mixing assembly (2020) to another mixing assembly (2020). For instance, controller (120) may transition valves (2024) of the first mixing assembly (2020) to a closed state to prevent fluid from reaching the first mixing assembly (2020) via input manifold channels (2005); and transition valve (2054) of the first mixing assembly (2020) to a closed state to prevent backflow of fluid into first mixing assembly (2020) via shared manifold channel (2058). Such closure of valves (2024, 2054) may render the first mixing assembly (2020) inactive. Controller (120) may open valves (2024, 2054) of the second mixing assembly (2020) to the open state. Such opening of valves (2024, 2054) of the second mixing assembly (2020) may render the second mixing assembly (2020) active.

At this stage of operation, the above-described routine of communicating fluid output of the second mixing assembly (2020) to primary output port (2102), with aliquot testing via measurement stage (2300), may be carried out until controller (120) automatically determines that one or more conditions associated with the second mixing assembly (2020) is/are outside of tolerance. Controller (120) may thus cycle through the available mixing assemblies (2020) on process chip (2000) until no more mixing assemblies (2020) are left. If controller (120) determines that one or more conditions associated with the last remaining mixing assembly (2020) is/are outside of tolerance, controller (120) may terminate further fluid processing on process chip (2000) and provide an appropriate notification to an operator.

By having just three fluid input ports (2004) and three corresponding fluid channels (2002) to provide fluid communication paths to all mixing assemblies (2020), process chip (2000) may facilitate switching from one mixing assembly (2020) to another mixing assembly (2020) during a fluid mixing process. With mixing assemblies (2020) sharing input channels (2002) via manifold channels (2005), it is not necessary to move and re-couple fluid conduits from reagent storage frame (107) from one set of input ports leading to one mixing assembly to another set of input ports leading to another mixing assembly. Switching between mixing assemblies is simplified through use of valves (2024, 2054) in the present example.

### VI. EXAMPLES OF COMBINATIONS

The following examples relate to various non-exhaustive ways in which the teachings herein may be combined or applied. The following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

An apparatus comprising: a process chip, the process chip including: a first exterior surface, a second exterior surface, a fluid chamber positioned between the first exterior surface and the second exterior surface, the fluid chamber including a fluid chamber inlet and a fluid chamber outlet, an optically transmissive material positioned between the first exterior surface and the fluid chamber, a plurality of mixing assemblies, each mixing assembly of the plurality of mixing assemblies having a plurality of inlets and an outlet, each mixing assembly of the plurality of mixing assemblies being configured to form a mixture of fluids from the plurality of inlets and communicate the mixture through the outlet, and a fluid input manifold channel, at least one inlet of each of the plurality of mixing assemblies being fluidically coupled with the fluid input manifold channel; and a dynamic light scattering assembly, the process chip to be removably positioned in relation to the dynamic light scattering assembly, the dynamic light scattering assembly including: a body, the body including a first port and a second port, the body to be positioned proximate to the first exterior surface, a first optical fiber coupled with the first port of the body, the first optical fiber to emit light, the first port to direct the light emitted by the first optical fiber through the optically transmissive material and into the fluid chamber, and a second optical fiber coupled with the second port of the body, the second optical fiber at the second port being oriented obliquely relative to the first optical fiber at the first port, the second optical fiber to receive light scattered by particles in fluid in the fluid chamber in response to the first optical fiber emitting light into the fluid chamber.

### Example 2

The apparatus of Example 1, the fluid chamber having a cylindraceous shape with a circular upper interior surface, a circular lower interior surface, and an interior sidewall extending from the circular upper interior surface to the circular lower interior surface.

### Example 3

The apparatus of Example 2, the fluid chamber inlet being positioned in a region of the interior sidewall near the circular lower interior surface.

### Example 4

The apparatus of any of Examples 2 through 3, the fluid chamber outlet being positioned in a region of the interior sidewall near the circular upper interior surface.

### Example 5

The apparatus of any of Examples 1 through 4, at least one mixing assembly of the plurality of mixing assemblies comprising a first mixing stage, the first mixing stage to mix a first plurality of fluid components to form a first fluid mixture, the fluid chamber inlet to receive the first fluid mixture.

### Example 6

The apparatus of Example 5, the first mixing stage including a first mixing inlet, a second mixing inlet, and a first mixing outlet, the first mixing inlet to receive a first fluid component, the second mixing inlet to receive a second fluid component, the first mixing outlet to output the first fluid mixture, the first fluid mixture comprising at least the first fluid component and the second fluid component.

### Example 7

The apparatus of Example 6, the process chip further comprising: a first pressure sensor, the first pressure sensor to sense a pressure of the first fluid component entering the first mixing inlet, and a second pressure sensor, the second pressure sensor to sense a pressure of the second fluid component entering the second mixing inlet.

### Example 8

The apparatus of Example 7, further comprising a processor, the processor to receive data from the dynamic light scattering assembly, the first pressure sensor, and the second pressure sensor.

### Example 9

The apparatus of Example 8, the processor to further correlate the data received from the dynamic light scattering assembly, the first pressure sensor, and the second pressure sensor.

### Example 10

The apparatus of any of Examples 6 through 9, the process chip further comprising an additional fluid channel fluidically coupled with the first mixing outlet.

### Example 11

The apparatus of Example 10, the process chip to provide communication of fluid from the first mixing outlet to either the additional fluid channel, the fluid chamber inlet, or a combination of the additional fluid channel and the fluid chamber inlet.

### Example 12

The apparatus of any of Examples 10 through 11, the process chip to provide communication of fluid from the additional fluid channel to the fluid chamber inlet via the first mixing outlet.

### Example 13

The apparatus of any of Examples 5 through 12, the at least one mixing assembly of the plurality of mixing assemblies further comprising a second mixing stage having a second mixing outlet, the second mixing stage to mix a second plurality of fluid components to form a second fluid mixture, the fluid chamber inlet to receive the second fluid mixture from the second mixing outlet.

### Example 14

The apparatus of Example 13, the process chip further comprising at least one valve, the at least one valve to regulate flow of fluid from the first and second mixing outlets to the fluid chamber inlet such that the fluid chamber inlet selectively receives only one of the first fluid mixture or the second fluid mixture at a time.

### Example 15

The apparatus of any of Examples 13 through 14, the process chip further comprising a manifold, the manifold to direct fluid from the first and second mixing outlets to the fluid chamber inlet.

### Example 16

The apparatus of any of Examples 1 through 15, the process chip having a square shape with four corners, the dynamic light scattering assembly being positioned at one of the four corners.

### Example 17

The apparatus of any of Examples 1 through 16, the dynamic light scattering assembly further including a collimator in the first port, the collimator being interposed between an end of the first optical fiber and the first exterior surface.

### Example 18

The apparatus of Example 17, the first port further including a focus volume interposed between the collimator and the first exterior surface.

### Example 19

The apparatus of Example 18, the focus volume defining a conical shape.

### Example 20

The apparatus of any of Examples 18 through 19, the dynamic light scattering assembly further including a focusing lens interposed between the collimator and the focus volume.

### Example 21

The apparatus of any of Examples 1 through 20, the dynamic light scattering assembly further including an optical filter in the second port, the optical filter being interposed between an end of the second optical fiber and the first exterior surface.

### Example 22

The apparatus of Example 21, the body further defining a channel being interposed between the optical filter and the first exterior surface.

### Example 23

The apparatus of any of Examples 1 through 22, the body including a chip-facing surface to face the first exterior surface, the chip-facing surface defining a first opening and a second opening, the first port to direct the light emitted by the first optical fiber through the first opening to reach the optically transmissive material, the second optical fiber to receive scattered light via the second opening.

### Example 24

The apparatus of Example 23, the chip-facing surface being spaced away from the first exterior surface by a gap distance.

### Example 25

The apparatus of any of Examples 1 through 24, further comprising a processor, the processor to determine one or both of sizes of particles in fluid in the fluid chamber using at least data from the dynamic light scattering assembly or size distribution of particles in fluid in the fluid chamber using at least data from the dynamic light scattering assembly.

### Example 26

The apparatus of Example 25, the processor to use autocorrelation to determine one or both of sizes of particles in fluid in the fluid chamber using at least data from the dynamic light scattering assembly or size distribution of particles in fluid in the fluid chamber using at least data from the dynamic light scattering assembly.

### Example 27

The apparatus of any of Examples 1 through 26, the process chip to form particles including encapsulated nucleotides.

### Example 28

The apparatus of Example 27, the encapsulated nucleotides including encapsulated mRNA.

### Example 29

The apparatus of any of Examples 27 through 28, the nucleotides being encapsulated in a surfactant.

### Example 30

An apparatus comprising: a process chip, the process chip including: a first exterior surface, a second exterior surface, a fluid chamber positioned between the first exterior surface and the second exterior surface, the fluid chamber including a fluid chamber inlet and a fluid chamber outlet, an optically transmissive material positioned between the first exterior surface and the fluid chamber, a plurality of mixing assemblies, each including a mixing stage, the mixing stage to mix a plurality of fluid components to form a fluid mixture, the fluid chamber inlet to receive the fluid mixture, the fluid mixture including particles, a fluid input manifold channel, each of the plurality of mixing assemblies being fluidically coupled with the fluid input manifold channel, a plurality of pressure sensors, the plurality of pressure sensors to sense pressure of fluid components entering the mixing stage of each of the plurality of mixing assemblies; and a dynamic light scattering assembly, the process chip to be removably positioned in relation to the dynamic light scattering assembly, the dynamic light scattering assembly to emit light into the fluid chamber via the optically transmissive material and receive light scattered from particles in the fluid mixture in the fluid chamber.

### Example 31

The apparatus of Example 30, further comprising a processor, the processor to receive data from the dynamic light scattering assembly.

### Example 32

The apparatus of Example 31, the processor to determine one or both of sizes of particles in fluid in the fluid chamber using at least data from the dynamic light scattering assembly or size distribution of particles in fluid in the fluid chamber using at least data from the dynamic light scattering assembly.

### Example 33

The apparatus of any of Examples 31 through 32, the processor to further receive data from the plurality of pressure sensors.

### Example 34

The apparatus of Example 33, the processor to determine whether the mixing stage of each of the plurality of mixing assemblies has a flow restriction, using at least data from the plurality of pressure sensors.

### Example 35

The apparatus of any of Examples 33 through 34, the processor to further correlate the data received from the dynamic light scattering assembly and the plurality of pressure sensors.

### Example 36

An apparatus comprising: a process chip, the process chip including: a first exterior surface, a second exterior surface, a plurality of mixing assemblies, each including: a first mixing stage having a first mixing outlet, the first mixing stage to mix a first plurality of fluid components to form a first fluid mixture and communicate the first fluid mixture out through the first mixing outlet, the first fluid mixture including particles, and a second mixing stage having a second mixing outlet, the second mixing stage to mix a second plurality of fluid components to form a second fluid mixture and communicate the second fluid mixture out through the second mixing outlet, the second fluid mixture including particles, and a fluid input manifold channel, each of the plurality of mixing assemblies being fluidically coupled with the fluid input manifold channel; a first dynamic light scattering assembly to be positioned near the first mixing stage, the first dynamic light scattering assembly to emit light into the first fluid mixture and receive light scattered from particles in the first fluid mixture; and a second dynamic light scattering assembly to be positioned near the second mixing stage, the second dynamic light scattering assembly to emit light into the second fluid mixture and receive light scattered from particles in the second fluid mixture; the process chip to be removably positioned in relation to the first and second dynamic light scattering assemblies.

### Example 37

The apparatus of Example 36, the first dynamic light scattering assembly to emit light into the first mixing outlet.

### Example 38

The apparatus of any of Examples 36 through 37, the second dynamic light scattering assembly to emit light into the second mixing outlet.

### Example 39

The apparatus of any of Examples 36 through 38, the process chip further including a manifold, the manifold to direct fluid from the first and second mixing outlets to a shared outlet channel.

### Example 40

The apparatus of Example 39, the process chip further including a fluid chamber positioned between the first exterior surface and the second exterior surface, the fluid chamber to receive a selected one of the first fluid mixture and the second fluid mixture from the shared outlet channel; the apparatus further comprising: a third dynamic light scattering assembly, the third dynamic light scattering assembly to emit light into the fluid chamber and receive light scattered from particles in the first fluid mixture or the second fluid mixture in the fluid chamber.

### Example 41

The apparatus of Example 40, further comprising a processor, the processor to correlate data from the first and second light scattering assemblies with data from the third dynamic light scattering assembly.

### Example 42

The apparatus of any of Examples 39 through 41, the process chip further comprising one or more valves to selectively meter flow of fluid from the first and second mixing outlets to the shared outlet channel.

### Example 43

The apparatus of any of Examples 36 through 42, further comprising a plurality of pressure sensors, the plurality of pressure sensors to sense pressure of the first and second fluid components entering the first and second mixing stages of each of the plurality of mixing assemblies.

### Example 44

The apparatus of Example 43, further comprising a processor, the processor to receive data from the first dynamic light scattering assembly, the second dynamic light scattering assembly, and the plurality of pressure sensors.

### Example 45

The apparatus of Example 44, the processor to further correlate the data from the first and second dynamic light scattering assemblies with the data from the plurality of pressure sensors.

### Example 46

A method comprising: communicating fluid through a process chip to generate encapsulated particles in a fluid; emitting light toward the encapsulated particles via a first optical fiber, the encapsulated particles scattering the emitted light, the emitted light being communicated through an optically transmissive material on a first side of the process chip; receiving the light scattered from the encapsulated particles, the received light being communicated through the optically transmissive material on the first side of the process chip, the received light being received by a second optical fiber obliquely oriented relative to the first optical fiber, the first and second optical fibers being secured to a body positioned near the process chip; performing autocorrelation on the received light; and determining either a size of the encapsulated particles using at least the autocorrelation, a size distribution of the encapsulated particles using at least the autocorrelation, or a size and size distribution of the encapsulated particles using at least the autocorrelation, the communicating fluid through the process chip including communicating fluid from a fluid input manifold channel of the process chip to a plurality of mixing assemblies of the process chip.

### Example 47

The method of Example 46, the encapsulated particles including encapsulated nucleotides.

### Example 48

The method of Example 47, the encapsulated nucleotides including encapsulated mRNA.

### Example 49

The method of Example 48, the encapsulated mRNA including mRNA encapsulated by at least one delivery vehicle molecule.

### Example 50

The method of Example 49, the at least one delivery vehicle molecule including an amino-lipidated peptoid.

### Example 51

The method of any of Examples 46 through 50, the communicating fluid through the process chip to generate encapsulated particles in a fluid including communicating two or more fluid components through at least one mixing assembly of the plurality of mixing assemblies to generate the encapsulated particles.

### Example 52

The method of any of Examples 46 through 51, further comprising monitoring a pressure of fluid communicated through the process chip.

### Example 53

The method of Example 50, further comprising correlating monitored pressure values with one or both of determined encapsulated particle size values or determined encapsulated particle size distribution values.

### Example 54

The method of any of Examples 52 through 53, further comprising: determining that a monitored pressure value falls outside a tolerance range; and ceasing communication of fluid through at least a portion of the process chip in response to determining that a monitored pressure value falls outside a tolerance range.

### Example 55

The method of any of Examples 46 through 54, further comprising: determining that a determined encapsulated particle size or size distribution falls outside a tolerance range; and ceasing communication of fluid through at least a portion of the process chip in response to determining that a determined encapsulated particle size or size distribution falls outside a tolerance range.

### Example 56

The method of any of Examples 46 through 55, the emitted light being emitted along a first axis, the received light being received along a second axis, the first and second axes intersecting at a convergence point, the convergence point being positioned within the process chip.

### Example 57

The method of Example 56, the first and second axes together defining an oblique angle.

### Example 58

The method of Example 57, the oblique angle being in a range from approximately 10 degrees to approximately 45 degrees.

### Example 59

A method comprising: communicating fluids through a mixing assembly of a process chip to generate a mixture including encapsulated particles in a fluid; monitoring a pressure of fluids communicated through the mixing assembly; activating a dynamic light scattering assembly to determine a size or size distribution of the encapsulated particles in the fluid, the dynamic light scattering assembly scattering light off the particles while the fluid is in the process chip; and correlating the monitored pressure of fluids with the determined particle size or size distribution, the communicating fluids through the mixing assembly including communicating a first fluid from a fluid input manifold channel to a first mixing assembly of a plurality of mixing assemblies, the fluid input manifold channel being fluidically coupled with a second mixing assembly of the plurality of mixing assemblies.

### Example 60

The method of Example 59, further comprising adjusting the communication of fluids through the mixing assembly using at least the monitored pressure.

### Example 61

The method of any of Examples 59 through 60, further comprising determining that a monitored pressure falls outside a predetermined range, the activating the dynamic light scattering assembly being performed in response to the determination that a monitored pressure falls outside a predetermined range.

### Example 62

The method of any of Examples 59 through 61, the activating a dynamic light scattering assembly including: emitting light toward the encapsulated particles via a first optical fiber, the encapsulated particles scattering the emitted light, the emitted light being communicated through an optically transmissive material on a first side of the process chip, receiving the light scattered from the encapsulated particles, the received light being communicated through the optically transmissive material on the first side of the process chip, the received light being received by a second optical fiber obliquely oriented relative to the first optical fiber, the first and second optical fibers being secured to a body positioned near the process chip, performing autocorrelation on the received light, and determining a size or size distribution of the encapsulated particles using at least the autocorrelation.

### Example 63

A method comprising: communicating fluid from a fluid input manifold channel of a process chip through a first mixing assembly of the process chip to generate a first mixture including encapsulated particles in a fluid; communicating fluid from the fluid input manifold channel through a second mixing assembly of the process chip to generate a second mixture including encapsulated particles in a fluid; emitting light toward the encapsulated particles in the first mixture, the particles in the first mixture scattering the emitted light; receiving the light scattered from the encapsulated particles in the first mixture; performing autocorrelation on the received light scattered from the encapsulated particles in the first mixture; determining a size or size distribution of the encapsulated particles in the first mixture using at least the autocorrelation on the received light scattered from the encapsulated particles in the first mixture; emitting light toward the encapsulated particles in the second mixture, the particles in the second mixture scattering the emitted light; receiving the light scattered from the encapsulated particles in the second mixture; performing autocorrelation on the received light scattered from the encapsulated particles in the second mixture; and determining a size or size distribution of the encapsulated particles in the second mixture using at least the autocorrelation on the received light scattered from the encapsulated particles in the second mixture.

### Example 64

The method of Example 63, the emitting light toward the encapsulated particles in the first mixture, receiving the light scattered from the encapsulated particles in the first mixture, emitting light toward the encapsulated particles in the second mixture, and receiving the light scattered from the encapsulated particles in the second mixture being performed by a single dynamic light scattering assembly.

### Example 65

The method of Example 64, further comprising: selectively communicating the first mixture to a fluid chamber of the single dynamic light scattering assembly, the emitting light toward the encapsulated particles in the first mixture and receiving the light scattered from the encapsulated particles in the first mixture being performed while the first mixture is in the fluid chamber; and selectively communicating the second mixture to the fluid chamber, the emitting light toward the encapsulated particles in the second mixture and receiving the light scattered from the encapsulated particles in the second mixture being performed while the second mixture is in the fluid chamber.

### Example 66

The method of any of Examples 63 through 64, further comprising: activating a first dynamic light scattering assembly to perform the emitting light toward the encapsulated particles in the first mixture and receiving the light scattered from the encapsulated particles in the first mixture; and activating a second dynamic light scattering assembly to perform the emitting light toward the encapsulated particles in the second mixture and receiving the light scattered from the encapsulated particles in the second mixture, the second dynamic light scattering assembly being separate from the first dynamic light scattering assembly.

### Example 67

The method of Example 66, further comprising: selectively communicating the first mixture to a fluid chamber of a third dynamic light scattering assembly; emitting light toward the encapsulated particles in the first mixture while the first mixture is in the fluid chamber; receiving the light scattered from the encapsulated particles in the first mixture while the first mixture is in the fluid chamber; selectively communicating the second mixture to the fluid chamber; emitting light toward the encapsulated particles in the second mixture while the second mixture is in the fluid chamber; and receiving the light scattered from the encapsulated particles in the second mixture while the second mixture is in the fluid chamber.

### Example 68

The method of Example 67, further comprising communicating the first and second mixtures through a manifold, the first and second mixtures passing through the manifold before reaching the fluid chamber.

### Example 69

An apparatus comprising: a body, the body including a first port and a second port, the body being positionable proximate to a first exterior surface of a process chip; a first optical fiber coupled with the first port of the body, the first optical fiber to emit light, the first port to direct the light emitted by the first optical fiber through an optically transmissive material of the process chip and into a fluid chamber of the process chip; a focusing lens supported by the body, the focusing lens being positioned and configured to focus light emitted by the first optical fiber; a second optical fiber coupled with the second port of the body, the second optical fiber at the second port being oriented obliquely relative to the first optical fiber at the first port, the second optical fiber to receive light scattered by particles in fluid in the fluid chamber in response to the first optical fiber emitting light into the fluid chamber; an optical filter supported by the body, the optical filter being positioned and configured to filter the light scattered by particles in fluid in the fluid chamber; and a process chip to be removably positioned in relation to the body, the process chip including: a first exterior surface, a second exterior surface, a fluid chamber positioned between the first exterior surface and the second exterior surface, the fluid chamber including a fluid chamber inlet and a fluid chamber outlet, an optically transmissive material positioned between the first exterior surface and the fluid chamber, a plurality of mixing assemblies, and a fluid input manifold channel fluidically coupled with each of the plurality of mixing assemblies.

### Example 70

The apparatus of Example 69, further comprising a base having a process chip mount, the process chip mount to removably receive the process chip, the body being positioned adjacent to the process chip mount.

### Example 71

The apparatus of any of Examples 69 through 70, the body to orient the first optical fiber along an axis that perpendicular to the exterior surface of the process chip.

### Example 72

The apparatus of any of Examples 69 through 71, the body to orient the second optical fiber along an axis that is obliquely oriented relative to the exterior surface of the process chip.

### Example 73

The apparatus of any of Examples 69 through 72, further comprising a processor configured to receive data indicative of the light received by the second optical fiber, and to selectively route fluid from the fluid input manifold channel to one of the plurality of mixing assemblies based on the data.

### Example 74

An apparatus comprising: a process chip mount, the process chip mount to removably receive a process chip; a body, the body including a first port and a second port, the body being fixedly secured relative to the process chip mount, the process chip mount to removably receive the process chip between the body and the process chip mount; a first optical fiber coupled with the first port of the body, the first optical fiber to emit light, the first port to direct the light emitted by the first optical fiber through an optically transmissive material of a process chip received by the process chip mount and into a fluid chamber of the process chip; a second optical fiber coupled with the second port of the body, the second optical fiber at the second port being oriented obliquely relative to the first optical fiber at the first port, the second optical fiber to receive light scattered by particles in fluid in the fluid chamber in response to the first optical fiber emitting light into the fluid chamber; and a process chip to be removably received in the process chip mount, the process chip including: a first exterior surface, a second exterior surface, a fluid chamber positioned between the first exterior surface and the second exterior surface, the fluid chamber including a fluid chamber inlet and a fluid chamber outlet, an optically transmissive material positioned between the first exterior surface and the fluid chamber, and a plurality of mixing assemblies, and a fluid input manifold channel fluidically coupled with each of the plurality of mixing assemblies.

### Example 75

The apparatus of Example 74, the process chip being configured to form a therapeutic composition.

### Example 76

The apparatus of Example 75, the therapeutic composition comprising a fluid containing particles.

### Example 77

The apparatus of Example 76, the first port to direct the light emitted by the first optical fiber through the optically transmissive material of the process chip to reach the fluid of the therapeutic composition.

### Example 78

The apparatus of Example 77, the second optical fiber to receive light scattered by the particles of the therapeutic composition.

### Example 79

The apparatus of Example 78, further comprising a processor to determine one or both the size of particles in the therapeutic composition using at least light scattered by the particles of the therapeutic composition or size distribution of particles in the therapeutic composition using at least light scattered by the particles of the therapeutic composition.

### Example 80

The apparatus of Example 79, the processor being configured to selectively route fluid from the fluid input manifold channel to one of the plurality of mixing assemblies based on the determined one or both of the size of particles in the therapeutic composition or size distribution of particles in the therapeutic composition.

### Example 81

An apparatus comprising: a process chip, the process chip including: a fluid chamber, the fluid chamber including a fluid chamber inlet and a fluid chamber outlet, and an optically transmissive material adjacent to the fluid chamber; a dynamic light scattering assembly, the process chip to be removably positioned in relation to the dynamic light scattering assembly, the dynamic light scattering assembly to direct the light through the optically transmissive material and into the fluid chamber, the dynamic light scattering assembly further to receive light scattered by particles in fluid in the fluid chamber in response to the first optical fiber emitting light into the fluid chamber and thereby capture light scattering data; and a processor to determine viscosity of fluid in the fluid chamber based on the captured light scattering data, the processor further to determine one or both of size or size distribution of particles in the fluid based the captured light scattering data, the process chip further including a plurality of mixing assemblies, each mixing assembly of the plurality of mixing assemblies having a plurality of inlets and an outlet, each mixing assembly of the plurality of mixing assemblies being configured to form a mixture of fluids from the plurality of inlets and communicate the mixture through the outlet, the process chip further comprising a fluid input port and a fluid input manifold channel, the plurality of inlets of the plurality of mixing assemblies being fluidically coupled with the fluid input manifold channel.

### Example 82

The apparatus of Example 81, the process chip further including: a first channel, the fluid chamber inlet being configured to receive a first fluid from the first channel, and a second channel, the fluid chamber inlet being further configured to receive a second fluid from the second channel.

### Example 83

The apparatus of Example 82, the first fluid comprising a therapeutic composition.

### Example 84

The apparatus of Example 83, the therapeutic composition including at least some of the particles.

### Example 85

The apparatus of Example 84, the particles of the therapeutic composition comprising mRNA.

### Example 86

The apparatus of any of Examples 82 through 85, the second fluid including at least some of the particles.

### Example 87

The apparatus of Example 86, the particles of the second fluid including beads.

### Example 88

The apparatus of Example 87, the first fluid comprising a therapeutic composition, the therapeutic composition including particles.

### Example 89

The apparatus of Example 88, the particles of the therapeutic composition having a first diameter, the beads having a second diameter different from the first diameter.

### Example 90

The apparatus of Example 89, the second diameter being larger than the first diameter.

### Example 91

The apparatus of any of Examples 82 through 90, the first fluid containing a first kind of particle, the second fluid containing a second kind of particle.

### Example 92

The apparatus of Example 91, the processor to determine one or both of size or size distribution of the first kind of particle within the first fluid based on light scattered by the first and second kinds of particles.

### Example 93

The apparatus of Example 92, the second kind of particle having a known size.

### Example 94

The apparatus of any of Examples 82 through 93, the second fluid comprising a dilutant.

### Example 95

The apparatus of Example 94, the process chip being configured to selectively add discrete amounts of the dilutant to the first fluid in a sequence.

### Example 96

The apparatus of Example 95, the process chip including at least one valve to selectively control delivery of the dilutant to the first fluid.

### Example 97

The apparatus of any of Examples 95 through 96, the process chip further including at least one pump to selectively drive movement of the dilutant.

### Example 98

The apparatus of any of Examples 94 through 97, the processor to: track an autocorrelation of the captured light scattering data during the sequence of adding discrete amounts of the dilutant to the first fluid, and determine one or both of size or size distribution of particles in the fluid based on the tracked autocorrelation.

### Example 99

The apparatus of any of Examples 94 through 98, the process chip further including a mixing chamber to mix the dilutant with the first fluid.

### Example 100

The apparatus of Example 99, the mixing chamber being positioned adjacent to the fluid chamber.

### Example 101

The apparatus of any of Examples 99 through 100, the process chip further comprising a first pump and a second pump, the first pump and the second pump being configured to alternatingly activate to thereby drive a combination of the dilutant and the first fluid back and forth through the mixing chamber.

### Example 102

A method comprising: communicating a fluid mixture through a process chip, the fluid mixture including particles; emitting light toward the fluid mixture via a first optical fiber, the particles in the fluid mixture scattering the emitted light; receiving the light scattered from the particles in the fluid mixture, the received light being received by a second optical fiber obliquely oriented relative to the first optical fiber, the first and second optical fibers being secured to a body positioned near the process chip; performing autocorrelation on the received light; determining viscosity of the fluid mixture using at least the autocorrelation; and determining either a size of the particles in the fluid mixture using at least the autocorrelation, a size distribution of the particles in the fluid mixture using at least the autocorrelation, or a size and size distribution of the particles in the fluid mixture using at least the autocorrelation; communicating fluid through the process chip including: communicating a first fluid component from a fluid input manifold channel to a first mixing assembly, the fluid input manifold channel being fluidically coupled to a second mixing assembly, the first fluid component including at least some of the particles, communicating a second fluid component to the first mixing assembly, and mixing the first and second fluid components together to form the fluid mixture.

### Example 103

The method of Example 102, the particles of the first fluid component including therapeutic particles.

### Example 104

The method of Example 103, the therapeutic particles including mRNA.

### Example 105

The method of Example 104, the mRNA being encapsulated in a delivery vehicle.

### Example 106

The method of any of Examples 102 through 105, the second fluid component including at least some of the particles.

### Example 107

The method of Example 106, the particles of the second fluid component including beads.

### Example 108

The method of any of Examples 106 through 107, the particles of the first fluid component having a first diameter, the particles of the second fluid component having a second diameter different from the first diameter.

### Example 109

The method of any of Example 108, the second diameter being larger than the first diameter.

### Example 110

The method of any of Examples 106 through 109, the particles of the first fluid component including a first kind of particle, the particles of the second fluid component including a second kind of particle different from the first kind of particle.

### Example 111

The method of any of Examples 106 through 110, receiving the light scattered from the particles in the fluid mixture including: receiving light scattered by particles of the first fluid component, and receiving light scattered by particles of the second fluid component.

### Example 112

The method of Example 111, determining either a size of the particles in the fluid mixture using at least the autocorrelation, a size distribution of the particles in the fluid mixture using at least the autocorrelation, or a size and size distribution of the particles in the fluid mixture using at least the autocorrelation including determining either a size of the particles of the first fluid component using at least the autocorrelation, a size distribution of the particles of the first fluid component using at least the autocorrelation, or a size and size distribution of the particles of the first fluid component using at least the autocorrelation.

### Example 113

The method of any of Examples 102 through 112, the second fluid component including a dilutant.

### Example 114

The method of Example 113, communicating the fluid mixture through the process chip further comprising adding discrete amounts of the dilutant to the first fluid component in a sequence.

### Example 115

The method of Example 114, further comprising repeating the emitting light, the receiving the light, and the performing autocorrelation, each time a discrete amount of the dilutant is added to the first fluid component in the sequence.

### Example 116

The method of Example 115, further comprising tracking the autocorrelation throughout each repetition of the emitting light, the receiving the light, and the performing autocorrelation, each time a discrete amount of the dilutant is added to the first fluid component in the sequence.

### Example 117

The method of Example 116, determining viscosity of the fluid mixture using at least the autocorrelation including determining viscosity of the fluid mixture using the tracked autocorrelation.

### Example 118

The method of any of Examples 116 through 117, determining either a size of the particles in the fluid mixture using at least the autocorrelation, a size distribution of the particles in the fluid mixture using at least the autocorrelation, or a size and size distribution of the particles in the fluid mixture using at least the autocorrelation including determining either a size of the particles in the fluid mixture using the tracked autocorrelation, a size distribution of the particles in the fluid mixture using the tracked autocorrelation, or a size and size distribution of the particles in the fluid mixture using the tracked autocorrelation.

### Example 119

The method of any of Examples 114 through 118, the discrete amount of dilutant added to the first fluid component being the same amount of dilutant each time the discrete amount of dilutant is added to the first fluid component in the sequence.

### Example 120

The method of any of Examples 102 through 119, mixing the first and second fluid components together to form the fluid mixture including alternatingly activating at least two pumps to drive the first and second fluid components back and forth through a mixing chamber of the process chip.

### Example 121

An apparatus comprising: a process chip, the process chip including: a first fluid input port, a first fluid input manifold fluidically coupled with the first fluid input port, a second fluid input port, a second fluid input manifold fluidically coupled with the second fluid input port, a plurality of mixing assemblies, each mixing assembly including: a first valve fluidically coupled with the first input manifold, a first inlet fluidically coupled with the first valve, a second valve fluidically coupled with the second input manifold, and a second inlet fluidically coupled with the second valve, an outlet, the mixing assembly being configured to form a mixture of fluids from the first and second inlets and communicate the mixture out through the outlet; one or more measurement features, the one or more measurement features being operable to detect one or more characteristics of the mixture; and a processor, the processor being configured to activate the first and second valves of the plurality of mixing assemblies based on data from the one or more measurement features.

### VII. MISCELLANEOUS

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

When a feature or element is herein referred to as being “on” another feature or element, it may be directly on the other feature or element or intervening features and/or elements may also be present. In contrast, when a feature or element is referred to as being “directly on” another feature or element, there are no intervening features or elements present. When a feature or element is referred to as being “connected,” “attached,” or “coupled” to another feature or element, it may be directly connected, attached, or coupled to the other feature or element or intervening features or elements may be present. In contrast, when a feature or element is referred to as being “directly connected,” “directly attached,” or “directly coupled” to another feature or element, there are no intervening features or elements present. Although described or shown with respect to one embodiment, the features and elements so described or shown may apply to other embodiments. It will also be appreciated by those skilled in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a,” “an,” and “the” are intended to include the plural forms as well, unless the context clearly indicates otherwise. As used herein, the term “and/or” includes any and all combinations of one or more of the associated listed items and may be abbreviated as “/”.

Spatially relative terms, such as “under,” “below,” “lower,” “over,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the term “under” may encompass both an orientation of over and under. The device may be otherwise oriented (rotated 90 degrees or at other orientations) and the spatially relative descriptors used herein interpreted accordingly. Similarly, the terms “upwardly,” “downwardly,” “vertical,” “horizontal,” and the like are used herein for the purpose of explanation only unless specifically indicated otherwise.

The term “perpendicular” as used herein should be understood to include arrangements where two objects, axes, planes, surfaces, or other things are oriented such that the two objects, axes, planes, surfaces, or other things together define an angle of 90 degrees. The term “perpendicular” as used herein should also be understood to include arrangements where two objects, axes, planes, surfaces, or other things are oriented such that the two objects, axes, planes, surfaces, or other things together define an angle that is approximately 90 degrees (e.g., an angle ranging from 85 degrees to 90 degrees). Thus, the term “perpendicular” as used herein should not be read as necessarily requiring two objects, axes, planes, surfaces, or other things to be oriented such that the two objects, axes, planes, surfaces, or other things together define an angle of exactly 90 degrees.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components may be co-jointly employed in the methods and articles (e.g., compositions and apparatuses including device and methods). For example, the term “comprising” will be understood to imply the inclusion of any stated elements or steps but not the exclusion of any other elements or steps. In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components, or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value unless the context indicates otherwise. For example, if the value “10” is disclosed, then “about 10” is also disclosed. Any numerical range recited herein is intended to include all sub-ranges subsumed therein.

It is also understood that when a value is disclosed that “less than or equal to” the value, “greater than or equal to the value,” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

As used herein, the terms “system,” “apparatus,” and “device” may be read as being interchangeable with each other. A system, apparatus, and device may each include a plurality of components having various kinds of structural and/or functional relationships with each other.

Some versions of the examples described herein may be implemented using a computer system, which may include at least one processor that communicates with a number of peripheral devices via bus subsystem. Versions of the examples described herein that are implemented using a computer system may be implemented using a general-purpose computer that is programmed to perform the methods described herein. Alternatively, versions of the examples described herein that are implemented using a computer system may be implemented using a specific-purpose computer that is constructed with hardware arranged to perform the methods described herein. Versions of the examples described herein may also be implemented using a combination of at least one general-purpose computer and at least one specific-purpose computer.

In versions implemented using a computer system, each processor may include a central processing unit (CPU) of a computer system, a microprocessor, an application-specific integrated circuit (ASIC), other kinds of hardware components, and combinations thereof. A computer system may include more than one type of processor. The peripheral devices of a computer system may include a storage subsystem including, for example, memory devices and a file storage subsystem, user interface input devices, user interface output devices, and a network interface subsystem. The input and output devices may allow user interaction with the computer system. The network interface subsystem may provide an interface to outside networks, including an interface to corresponding interface devices in other computer systems. User interface input devices may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system.

In versions implemented using a computer system, a user interface output devices may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide a non-visual display such as audio output devices. In general, use of the term “output device” is intended to include all possible types of devices and ways to output information from computer system to the user or to another machine or computer system.

In versions implemented using a computer system, a storage subsystem may store programming and data constructs that provide the functionality of some or all of the modules and methods described herein. These software modules may be generally executed by the processor of the computer system alone or in combination with other processors. Memory used in the storage subsystem may include a number of memories including a main random-access memory (RAM) for storage of instructions and data during program execution and a read only memory (ROM) in which fixed instructions are stored. A file storage subsystem may provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem in the storage subsystem, or in other machines accessible by the processor.

In versions implemented using a computer system, the computer system itself may be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the example of the computer system described herein is intended only as a specific example for purposes of illustrating the technology disclosed. Many other configurations of a computer system are possible having more or fewer components than the computer system described herein.

As an article of manufacture, rather than a method, a non-transitory computer readable medium (CRM) may be loaded with program instructions executable by a processor. The program instructions when executed, implement one or more of the computer-implemented methods described above. Alternatively, the program instructions may be loaded on a non-transitory CRM and, when combined with appropriate hardware, become a component of one or more of the computer-implemented systems that practice the methods disclosed.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1-80. (canceled)

81. An apparatus comprising:
a process chip, the process chip including:
a fluid chamber, the fluid chamber including a fluid chamber inlet and a fluid chamber outlet, and
an optically transmissive material adjacent to the fluid chamber;
a dynamic light scattering assembly, the process chip to be removably positioned in relation to the dynamic light scattering assembly, the dynamic light scattering assembly to direct the light through the optically transmissive material and into the fluid chamber, the dynamic light scattering assembly further to receive light scattered by particles in fluid in the fluid chamber in response to the first optical fiber emitting light into the fluid chamber and thereby capture light scattering data; and
a processor to determine viscosity of fluid in the fluid chamber based on the captured light scattering data, the processor further to determine one or both of size or size distribution of particles in the fluid based the captured light scattering data,
the process chip further including a plurality of mixing assemblies, each mixing assembly of the plurality of mixing assemblies having a plurality of inlets and an outlet, each mixing assembly of the plurality of mixing assemblies being configured to form a mixture of fluids from the plurality of inlets and communicate the mixture through the outlet,
the process chip further comprising a fluid input port and a fluid input manifold channel, the plurality of inlets of the plurality of mixing assemblies being fluidically coupled with the fluid input manifold channel.

82. The apparatus of claim 81, the process chip further including:
a first channel, the fluid chamber inlet being configured to receive a first fluid from the first channel, and
a second channel, the fluid chamber inlet being further configured to receive a second fluid from the second channel.

83. The apparatus of claim 82, the first fluid comprising a therapeutic composition.

84. The apparatus of claim 83, the therapeutic composition including at least some of the particles.

85. The apparatus of claim 84, the particles of the therapeutic composition comprising mRNA.

86. The apparatus of claim 82, the second fluid including at least some of the particles.

87. The apparatus of claim 86, the particles of the second fluid including beads.

88. The apparatus of claim 87, the first fluid comprising a therapeutic composition, the therapeutic composition including particles.

89. The apparatus of claim 88, the particles of the therapeutic composition having a first diameter, the beads having a second diameter different from the first diameter.

90. The apparatus of claim 89, the second diameter being larger than the first diameter.

91-101. (canceled)

102. A method comprising:
communicating a fluid mixture through a process chip, the fluid mixture including particles;
emitting light toward the fluid mixture via a first optical fiber, the particles in the fluid mixture scattering the emitted light;
receiving the light scattered from the particles in the fluid mixture, the received light being received by a second optical fiber obliquely oriented relative to the first optical fiber, the first and second optical fibers being secured to a body positioned near the process chip;
performing autocorrelation on the received light;
determining viscosity of the fluid mixture using at least the autocorrelation; and
determining either a size of the particles in the fluid mixture using at least the autocorrelation, a size distribution of the particles in the fluid mixture using at least the autocorrelation, or a size and size distribution of the particles in the fluid mixture using at least the autocorrelation,
communicating fluid through the process chip including:
communicating a first fluid component from a fluid input manifold channel to a first mixing assembly, the fluid input manifold channel being fluidically coupled to a second mixing assembly, the first fluid component including at least some of the particles,
communicating a second fluid component to the first mixing assembly, and
mixing the first and second fluid components together to form the fluid mixture.

103. The method of claim 102, the particles of the first fluid component including therapeutic particles.

104. The method of claim 103, the therapeutic particles including mRNA.

105. The method of claim 104, the mRNA being encapsulated in a delivery vehicle.

106. The method of claim 102, the second fluid component including at least some of the particles.

107. The method of claim 106, the particles of the second fluid component including beads.

108-121. (canceled)
